(19) United States
(12) Patent Application Publication
(10) Pub. No.: US 2014/0296137 A1
(43) Pub. Date: Oct. 2, 2014

(54) METHODS AND COMPOSITIONS FOR CONTROLLING ROTIFERS

(71) Applicant: Los Alamos National Security, LLC, Los Alamos, NM (US)

(72) Inventors: Sathish Rajamani, Los Alamos, NM (US); Richard T. Sayre, Los Alamos, NM (US)

(21) Appl. No.: 14/231,139

(22) Filed: Mar. 31, 2014

Related U.S. Application Data
(60) Provisional application No. 61/807,126, filed on Apr. 1, 2013.

(51) Int. Cl. A01N 43/50; A01N 43/36; A01N 43/38

(52) U.S. Cl. CPC A01N 43/50; A01N 43/38; A01N 43/36
USPC 514/4.5; 514/4.6; 435/257.2; 435/320.1

(57) ABSTRACT

Described herein are compositions and methods for controlling, inhibiting, reducing and/or preventing rotifer growth with antimicrobial peptides. Methods for removing and/or preventing rotifer infestations in algae cultivations by controlling, inhibiting, reducing and/or preventing rotifer growth with an antimicrobial peptide (AMP) are further provided. Also described are transgenic algae comprising an expression vector comprising a nucleic acid sequence encoding an AMP. In some instances, the nucleic acid sequence encoding the AMP is codon-optimized for expression in algae.

### CROSS REFERENCE TO RELATED APPLICATION

This application claims the benefit of U.S. Provisional Application No. 61/807,126, filed Apr. 1, 2013, which is herein incorporated by reference in its entirety.

### ACKNOWLEDGMENT OF GOVERNMENT SUPPORT

This invention was made with government support under Contract No. DE-AC52-06NA25396 awarded by the U.S. Department of Energy. The government has certain rights in the invention.

### FIELD

The present disclosure relates generally to compositions and methods for controlling, inhibiting, reducing and/or preventing rotifer growth using peptides. The disclosure further relates to compositions and methods for removing and/or preventing rotifer infestations in algae cultivations by controlling, inhibiting, reducing and/or preventing rotifer growth with an antimicrobial peptide (AMP).

### BACKGROUND

The booming global population, combined with rising industrialization and modernization generates increasing demands for energy, most of which comes from fossil fuels. Increasing greenhouse gas (GHG) emissions are accelerating climate change at a pace that has global environmental and security implications. To mitigate domestic energy demands and their environmental impacts, it is necessary to seek alternative energy sources that reduce or ameliorate carbon emissions. The potential for reductions in GHG emissions (environment), reduced fuel prices (economics), and reduction in dependency on foreign oil (national security) have driven increased scientific, public, political and commercial interests in biofuels. However, a number of limitations impede the advancement and scale-up of current biomass/biofuel production systems, including biocontamination, which has a major impact on algal crop yields, particularly in open pond systems.

Beyond bacteria, virus, fungi and protozoans that potentially cause harm to algal crops, there are other biocontaminants or ‘predators’ that effect algal crop yield in open ponds. One such organism is a small multicellular invertebrate organism called a rotifer. Rotifers are microscopic aquatic organisms found largely in freshwater ponds and in some marine environments. They can also be found in moist soil, on mosses and lichens growing on tree trunks and rocks, in rain gutters and puddles, in soil or leaf litter, on mushrooms growing near dead trees, in tanks of sewage treatment plants, and even on freshwater crustaceans and aquatic insect larvae. Their ubiquitous existence provides them easy access to algal cultivation ponds through rainwater runoff or even by wind gusts that can carry them to the ponds. They are highly adapted, hardy organisms that can withstand seasonal variations in ponds ranging from cold winters to hot summers (Sahuquillo and Miracle, Limnetica 29(1): 75-92, 2010). They have the ability to acquire genetic materials from their environment through horizontal gene transfer. Indeed, the genetic heterogeneity and complexity of these organisms was well established in a sequencing study (Gladyshev et al., Science, 320(5880):1210-1213, 2008).

Generally omnivorous, rotifers feed on dead and decaying matter and on unicellular green algae. Given the abundance of algae in open algal ponds, once rotifers enter these ponds, they seem to readily thrive by feeding upon algae and multiplying in great numbers, causing large algal biomass loss. To alleviate rotifer infestation, ponds must be drained and decontaminated with abrasive agents such as hypochlorite or other caustic agents before reestablishing open pond algal cultivation. This procedure results in large and crippling economic losses and could greatly jeopardize the reliable yields of algal crop for fuel production.

Therefore, there continues to be a need for compositions and methods to control and/or prevent rotifer contaminations in algae cultivations in order to improve biomass production systems, particularly large-scale systems.

### SUMMARY

The present disclosure meets such needs by identifying and utilizing peptides to control, inhibit, reduce and/or prevent rotifer infestations without causing harm to the algae.

The present disclosure describes compositions and methods for removing and/or inhibiting and/or preventing rotifer infestations in algae cultivations by controlling, inhibiting, reducing and/or preventing rotifer growth with an antimicrobial peptide (AMP).

In one aspect, the disclosure provides a method for inhibiting the growth or inhibiting the growth rate of one or more rotifers comprising contacting one or more rotifers with an isolated antimicrobial peptide (AMP), wherein the growth or growth rate of the one or more rotifers is inhibited by the AMP compared to the growth or growth rate of the one or more rotifers absent the AMP.

In another aspect, the AMP is from about 5 to about 200 amino acids in length. In another aspect, the AMP is from about 5 to about 600 amino acids in length. In a related aspect, the AMP is an insecticidal AMP or a non-insecticidal AMP. In a related aspect, the concentration of the AMP is from about 0.5 μM to about 500 μM (or from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 μM) or from about 75 μM to about 370 μM (or from about 75, 85, 95, 105, 115, 125, 135, 145, 155, 165, 175, 185, 195, 205, 215, 225, 235, 245, 255, 265, 275, 285, 295, 305, 315, 325, 335, 345, 355, 365 or 370 μM).

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the one or more rotifers are Bdelloid rotifers, Monogononta rotifers or a combination thereof. In a related aspect, the one or more rotifers are of the species Adineta vaga, Philodina acuticornis, Brachionus or any combination thereof.

In another aspect, the disclosure provides for a method for inhibiting or preventing a rotifer infestation of an algae culture comprising contacting an algae culture with an isolated antimicrobial peptide (AMP), wherein the concentration of the AMP in the algae culture is sufficient to inhibit the growth of and/or reduce the rate of growth of the rotifer in the algae culture.

In a related aspect, the AMP does not substantially inhibit the growth of the algae. In the context of the present disclosure, “does not substantially inhibit” means inhibits less than 10%, such as less than 9%, less than 8%, less than 7%, less than 6% or less than 5%.

In another aspect, the AMP is from about 5 to about 200 amino acids in length. In another aspect, the AMP is from about 5 to about 600 amino acids in length. In a related aspect, the AMP is an insecticidal AMP or a non-insecticidal AMP. In a related aspect, the concentration of the AMP in the algae culture is from about 0.5 μM to about 500 μM or from about 75 μM to about 370 μM.

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the rotifers are Bdelloid rotifers, Monogononta rotifers or a combination thereof. In a related aspect, the rotifers are of the species Adineta vaga, Philodina acuticornis, Brachionus or any combination thereof.

In another aspect, the disclosure provides for a composition comprising a rotifer and an antimicrobial peptide (AMP). In a related aspect, the growth of the rotifer is inhibited by the AMP compared to the growth of the rotifer absent the AMP. In yet another related aspect, the growth rate of the rotifer is reduced by the presence of the AMP compared to the growth rate of the rotifer absent the AMP.

In another aspect, the composition further comprises algae. In a related aspect, the AMP does not substantially inhibit the growth of the algae. In another aspect, the AMP is from about 5 to about 200 amino acids in length. In another aspect, the AMP is from about 5 to about 600 amino acids in length. In a related aspect, the AMP is an insecticidal AMP or a non-insecticidal AMP. In a related aspect, the concentration of the AMP is from about 0.5 μM to about 500 μM or from about 75 μM to about 370 μM.

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the rotifer is a Bdelloid rotifers or a Monogononta rotifer. In a related aspect, the rotifer is of the species Adineta vaga, Philodina acuticornis, or Brachionus.

In another aspect, the disclosure provides for a composition comprising a transgenic algae and a rotifer, wherein the transgenic algae comprises an expression vector comprising a promoter (such as a heterologous promoter) operatively linked to a nucleotide sequence encoding an antimicrobial peptide (AMP).

In another aspect, the growth of the rotifer is inhibited by the AMP compared to the growth of the rotifer absent the AMP. In a related aspect, the growth rate of the rotifer is reduced by the presence of the AMP compared to the growth rate of the rotifer absent the AMP.

In another aspect, the AMP does not substantially inhibit the growth of the algae.

In another aspect, the AMP is from about 5 to about 200 amino acids in length. In another aspect, the AMP is from about 5 to about 600 amino acids in length. In a related aspect, the AMP is an insecticidal AMP or a non-insecticidal AMP. In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the rotifer is a Bdelloid rotifer or a Monogononta rotifer. In a related aspect, the rotifer is of the species Adineta vaga, Philodina acuticornis, or Brachionus.

In another aspect, the nucleotide sequence encoding the antimicrobial peptide (AMP) comprises any one of SEQ ID NOs: 1648-1651.

In another aspect, the disclosure provides a transgenic algae comprising an expression vector, wherein the expression vector comprises a promoter, such as a heterologous promoter, operatively linked to a nucleotide sequence encoding an antimicrobial peptide (AMP). In some aspects, the nucleotide sequence encoding the AMP is codon-optimized for expression in algae. In some aspects, the AMP does not substantially inhibit the growth of the algae.

In another aspect, the AMP is from about 5 to about 200 amino acids in length. In another aspect, the AMP is from about 5 to about 600 amino acids in length. In a related aspect, the AMP is an insecticidal AMP or a non-insecticidal AMP.

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the nucleotide sequence encoding the AMP comprises any one of SEQ ID NOs: 1648-1651.

In another aspect, the present disclosure provides an expression vector comprising a promoter, such as a heterologous promoter, operatively linked to a nucleotide sequence encoding an antimicrobial peptide (AMP), wherein the nucleotide sequence is codon-optimized for expression in algae. In a related aspect, the nucleotide sequence encoding the AMP comprises any one of SEQ ID NOs: 1648-1651.

The foregoing and other objects, features, and advantages of the invention will become more apparent from the following detailed description, which proceeds with reference to the accompanying figures.

### BRIEF DESCRIPTION OF THE DRAWINGS

FIGS. 1A-1F show microscopic images of side-by-side comparison of AMP treated and AMP untreated Adineta vaga, Philodina acuticornis and Brachionus rotifers. FIGS. 1A, 1C and 1E show a 20× magnification of Adineta vaga, Philodina acuticornis and Brachionus (untreated), respectively. FIGS. 1B, 1D and 1F show a 20× magnification of Adineta vaga, Philodina acuticornis and Brachionus (AMP treated), respectively. The rotifers in FIGS. 1B, 1D and 1F had limited to no mobility; the morphology of the rotifers treated with AMPs compared to the untreated rotifers (FIGS. 1A, 1C and 1E) indicates that the rotifers are unhealthy and/or dead.

FIG. 2 shows a schematic diagram of the pCPSR24 plasmid suitable for engineering algae with codon-optimized AMP nucleotide sequences. The nucleotide sequences of several exemplary AMPs that may be expressed with the expression vector are set forth herein as SEQ ID NOs: 1648-1651.

### SEQUENCE LISTING

The nucleic and amino acid sequences listed in the accompanying sequence listing are shown using standard letter abbreviations for nucleotide bases, and three letter code for amino acids, as defined in 37 C.F.R. 1.822. Only one strand of each nucleic acid sequence is shown, but the complementary strand is understood as included by any reference to the displayed strand. The Sequence Listing is submitted as an ASCII text file, created on Mar. 12, 2014, 716 KB, which is incorporated by reference herein. In the accompanying sequence listing:

SEQ ID NOs: 1-1647 are amino acid sequences of antimicrobial peptides (AMPs).

SEQ ID NOs: 1648-1651 are nucleotide sequences encoding AMPs, codon optimized for expression in C. protothecoides.

### DETAILED DESCRIPTION

### I. Terms and Methods

Unless otherwise noted, technical terms are used according to conventional usage. Definitions of common terms in molecular biology may be found in Benjamin Lewin, Genes V, published by Oxford University Press, 1994 (ISBN 0-19-854287-9); Kendrew et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8).

In order to facilitate review of the various embodiments of the disclosure, the following explanations of specific terms are provided:

Algae: Refers to algae species that can be used with the compositions and methods described herein and include for example, Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima. Amphora delicatissima var. capitata, Amphora sp., Anabaena, Ankistrodesmus, Ankistrodesmus falcatus, Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomas perigranulata, Chlore lla anitrata, Chlorella antarctica, Chlorella aureoviridis, Chlorella Candida, Chlorella capsulate, Chlorella desiccate, Chlorella ellipsoidea, Chlorella emersonii, Chlorella fusca, Chlorella fusca var. vacuolata, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella salina, Chlorella simplex, Chlorella sorokiniana, Chlorella sp., Chlorella sphaerica, Chlorella stigmatophora, Chlorella vanniellii, Chlorella vulgaris, Chlorella vulgaris fo. tenia, Chlorella vulgaris var. autotrophica, Chlorella vulgaris var. viridis, Chlorella vulgaris var. vulgaris, Chlorella vulgaris var. vulgaris fo. tenia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Chlamydomonas moewusii Chlamydomonas reinhardtii Chlamydomonas sp. Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Gleocapsa sp., Gloeothamnion sp., Haematococcus pluvialis, Hymenomonas sp., Isochrysis aff. galbana, Isochrysis galbana, Lepocinclis, Micractinium, Micractinium, Monoraphidium minutum, Monoraphidium sp., Nannochloris sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrina, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Platymonas sp., Pleurochrysis carterae, Pleurochrysis dentate, Pleurochrysis sp., Prototheca wickerhamii, Prototheca stagnora, Prototheca portoricensis, Prototheca moriformis, Prototheca zopfii, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf, Tagetes erecta, Tagetes patula, Tetraedron, Tetraselmis sp., Tetraselmis suecica, Thalassiosira weissflogii, and Viridiella fridericiana.

Antimicrobial peptide (AMP): A naturally occurring or synthetic linear, branched or cyclic peptide, or a peptide having a linear, branched and/or cyclic structure that generally kills, prevents and/or inhibits the growth of a microorganism.

Biocompatible: Synthetic and/or natural material that does not have a substantial negative impact on organisms, tissues, cells, biological systems or pathways and/or protein function.

Biomass: Any algal-based organic matter that may be used for carbon storage and/or as a source of energy (e.g., biofuels).

Codon-optimized: A “codon-optimized” nucleic acid refers to a nucleic acid sequence that has been altered such that the codons are optimal for expression in a particular system (such as a particular species or group of species). For example, a nucleic acid sequence can be optimized for expression in plant cells, for example, in algae. Codon optimization does not alter the amino acid sequence of the encoded protein.

Contacting: Placement in direct physical association; includes both in solid and liquid form.

Growth rate reduction (or reducing rate of growth): Reducing the rate of growth of an individual organism or a population of organisms. Growth rate reduction may include reducing or decreasing, directly or indirectly, the rate at which an organism acquires mass or the rate at which a population of organisms acquires mass (e.g., by stopping (directly or indirectly) ingestion, digestion and/or assimilation of food by the organism) and/or the reproduction of an organism. In the case of rotifers, measuring growth rate reduction may include, but is not limited to, one or more of the following and as compared to rotifers in normal growth conditions: a decrease in motility (e.g., swimming or cilia movement) of the rotifer(s), a decrease in ingestion of algae by rotifer(s), a decrease in the rate of egg production and/or reproduction, a decrease in the rate of feeding, and a decrease in the rate of growth (e.g., size and/or mass) of rotifer(s).

Inhibiting growth (or growth inhibition): Preventing growth of an individual organism or a population of organisms. Growth inhibition may be as extreme as death or killing of the organism or population of organisms, or may include preventing, directly or indirectly, an increase in the mass of an organism or population of organisms (e.g., by stopping, directly or indirectly, ingestion, digestion and/or assimilation of food by the organism) and/or the reproduction of an organism. In the case of rotifers, measuring growth inhibition may include, but is not limited to, one or more of the following and as compared to rotifers in normal growth conditions: an inhibition of movement (e.g., swimming or cilia movement) of the rotifer(s), an inhibition of ingestion of algae by rotifer(s), an inhibition of the rate of egg production and/or reproduction of rotifer(s), and an inhibition of feeding by rotifer(s).

Insecticidal: Capable of killing and/or controlling insects. In the context of the present disclosure, an “insecticidal AMP” is an AMP belonging to a class of AMPs that have activity against insects (i.e. are capable of killing and/or controlling insects). As used herein, a “non-insecticidal AMP” is any AMP belonging to a recognized class of AMPs other than the insecticidal class. For example, non-insecticidal AMPs include anticancer/tumor AMPs, anti-protist AMPs, antiparasitic AMPs, spermicidal AMPs, anti-HIV-1 AMPs and chemotactic AMPs.

Microorganism: Microscopic single cell or multicellular organism. Non-limiting examples of microorganisms include bacteria, protozoa, fungi, rotifers, planarians and viruses.

Minimal inhibitory concentration (MIC): The lowest concentration of an antimicrobial peptide (e.g., AMP) that will inhibit the visible growth of an organism (e.g., algae).

Operably linked: A first nucleic acid sequence is operably linked with a second nucleic acid sequence when the first nucleic acid sequence is placed in a functional relationship with the second nucleic acid sequence. For instance, a promoter is operably linked to a coding sequence if the promoter affects the transcription or expression of the coding sequence. Generally, operably linked DNA sequences are contiguous and, where necessary to join two protein-coding regions, in the same reading frame.

Percent identity: In the context of two or more nucleic acids or peptide sequences, refers to two or more sequences or subsequences that are the same or have a specified percentage of amino acid residues or nucleotides that are the same (i.e., about 60%, 65%, 70%, 75%, 80%, 85%, 90%, 91%, 92%, 93%, 94%, 95%, 96%, 97%, 98%, 99%, or higher identity over a specified region, when compared and aligned for maximum correspondence over a comparison window or designated region) as measured, for example, using a BLAST or BLAST 2.0 sequence comparison algorithm with default parameters described below, or by manual alignment and visual inspection.

Promoter: A region of DNA that directs/initiates transcription of a nucleic acid (e.g. a gene). A promoter includes necessary nucleic acid sequences near the start site of transcription. Typically, promoters are located near the genes they transcribe. A promoter also optionally includes distal enhancer or repressor elements which can be located as much as several thousand base pairs from the start site of transcription.

Rotifers: Microscopic, multicellular, pseudocoelomate animals of the phylum Rotifera. Rotifers can be found in many freshwater environments and in moist soil. Some rotifer species can be found in saltwater.

Transgenic algae: Algae whose genetic material has been altered using genetic engineering techniques so that it is no longer a “wild type” organism. An example of genetically modified algae is transgenic algae that possess one or more genes that have been transferred to the algae from a different species. Another example is an alga wherein endogenous genes have been rearranged such that they are in a different and advantageous arrangement or amplified so that specific sequences are increased. In this example, no foreign DNA remains in the modified cell.

Vector: A vector is a nucleic acid molecule allowing insertion of foreign nucleic acid without disrupting the ability of the vector to replicate and/or integrate in a host cell. A vector can include nucleic acid sequences that permit it to replicate in a host cell, such as an origin of replication. A vector can also include one or more selectable marker genes and other genetic elements. An expression vector is a vector that contains the necessary regulatory sequences to allow transcription and translation of inserted gene or genes.

Wild-type: The phenotype of the typical form of a species as it occurs in nature.

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. “Comprising A or B” means including A, or B, or A and B. It is further to be understood that all base sizes or amino acid sizes, and all molecular weight or molecular mass values, given for nucleic acids or polypeptides are approximate, and are provided for description.

Further, ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 and 50 (as well as fractions thereof unless the context clearly dictates otherwise). Any concentration range, percentage range, ratio range, or integer range is to be understood to include the value of any integer within the recited range and, when appropriate, fractions thereof (such as one tenth and one hundredth of an integer), unless otherwise indicated. Also, any number range recited herein relating to any physical feature, such as polymer subunits, size or thickness, are to be understood to include any integer within the recited range, unless otherwise indicated. As used herein, “about” or “consisting essentially of” mean±20% of the indicated range, value, or structure, unless otherwise indicated. As used herein, the terms “include” and “comprise” are open ended and are used synonymously. It should be understood that the terms “a” and “an” as used herein refer to “one or more” of the enumerated components. The use of the alternative (e.g., “or”) should be understood to mean either one, both, or any combination thereof of the alternatives

Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including explanations of terms, will control. In addition, the materials, methods, and examples are illustrative only and not intended to be limiting.

### II. Overview of Several Embodiments

The present disclosure relates generally to compositions and methods for controlling, inhibiting, reducing and/or preventing rotifer growth using peptides. More specifically the disclosure relates to removing and/or preventing rotifer infestations in algae cultivations by the expression of one or more antimicrobial peptides (AMPs) by transgenic algae and/or the introduction of one or more AMPs in an algae cultivation (e.g., open-pond system). The present disclosure also provides expression vectors comprising a heterologous promoter operably linked to a nucleotide sequence encoding an AMP, as well as transgenic algae comprising the expression vectors.

Novel aspects of the present disclosure include the use of biomolecules (e.g., AMPs) to control, reduce and/or prevent the growth of metazoan organisms such as rotifers. This disclosure provides the utility of AMPs in controlling rotifer populations (e.g., controlling, inhibiting, reducing, prevent and/or killing) by engineering algae to express one or more of these peptides in the algae of choice to confer innate defense capabilities against these indiscriminate algae grazers. There are thousands of natural AMPs that have been identified thus far (see e.g., the Antimicrobial Peptide Database, which is available online).

Additional embodiments include a method for inhibiting the growth of one or more rotifers comprising contacting one or more rotifers with an isolated antimicrobial peptide (AMP), wherein the growth of the one or more rotifers is inhibited by the AMP compared to the growth of the one or more rotifers absent the AMP.

In another aspect, the AMP is from about 5 to about 200 amino acids in length. In another aspect, the AMP is from about 5 to about 600 amino acids in length. In a related aspect, the AMP is an insecticidal AMP or a non-insecticidal AMP. In a related aspect, the concentration of the AMP is from about 0.5 μM to about 1000 μM (or from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 or 1000 μM).

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the one or more rotifers are Bdelloid rotifers, Monogononta rotifers or a combination thereof. In a related aspect, the one or more rotifers are of the species Adineta vaga, Philodina acuticornis, Brachionus or any combination thereof.

In another aspect, the disclosure provides for a method for reducing the growth rate of one or more rotifers comprising contacting one or more rotifers with an isolated antimicrobial peptide (AMP), wherein the growth rate of the one or more rotifers is reduced by the presence of the AMP compared to the growth rate of the one or more rotifers absent the AMP.

In another aspect, the AMP is from about 5 to about 200 amino acids in length. In another aspect, the AMP is from about 5 to about 600 amino acids in length. In a related aspect, the AMP is an insecticidal AMP or a non-insecticidal AMP. In a related aspect, the concentration of the AMP is from about 0.5 μM to about 1000 μM (or from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 or 1000 μM).

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the one or more rotifers are Bdelloid rotifers, Monogononta rotifers or a combination thereof. In a related aspect, the one or more rotifers are of the species Adineta vaga, Philodina acuticornis, Brachionus or any combination thereof.

In another aspect, the disclosure provides for a composition comprising a rotifer and an antimicrobial peptide (AMP). In a related aspect, the growth of the rotifer is inhibited by the AMP compared to the growth of the rotifer absent the AMP. In yet another related aspect, the growth rate of the rotifer is reduced by the presence of the AMP compared to the growth rate of the rotifer absent the AMP.

In another aspect, the composition further comprises algae. In a related aspect, the AMP does not substantially inhibit the growth of the algae. In the context of the present disclosure, “does not substantially inhibit” means inhibits less than 10%, such as less than 9%, less than 8%, less than 7%, less than 6% or less than 5%. In another aspect, the AMP is from about 5 to about 200 amino acids in length. In another aspect, the AMP is from about 5 to about 600 amino acids in length. In a related aspect, the AMP is an insecticidal AMP or a non-insecticidal AMP. In a related aspect, the concentration of the AMP is from about 0.5 μM to about 1000 μM (or from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 or 1000 μM).

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the rotifers are Bdelloid rotifers, Monogononta rotifers or a combination thereof. In a related aspect, the rotifers are of the species Adineta vaga, Philodina acuticornis, Brachionus or any combination thereof.

In another aspect, the disclosure provides for a method for preventing a rotifer infestation of an algae culture comprising contacting an algae culture with an isolated antimicrobial peptide (AMP), wherein the concentration of the AMP in the algae culture is sufficient to inhibit the growth of and/or reduce the rate of growth of a rotifer in the algae culture.

In a related aspect, the AMP does not substantially inhibit the growth of the algae.

In another aspect, the AMP is from about 5 to about 200 amino acids in length. In another aspect, the AMP is from about 5 to about 600 amino acids in length. In a related aspect, the AMP is an insecticidal AMP or a non-insecticidal AMP. In a related aspect, the concentration of the AMPin the algae culture is from about 0.5 μM to about 1000 μM (or from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 or 1000 μM).

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the rotifers are Bdelloid rotifers, Monogononta rotifers or a combination thereof. In a related aspect, the rotifers are of the species Adineta vaga, Philodina acuticornis, Brachionus or any combination thereof.

In another aspect, the disclosure provides a transgenic algae comprising an expression vector, wherein the expression vector comprises a promoter, such as as heterologous promoter, operatively linked to a nucleotide sequence encoding an antimicrobial peptide (AMP). In some aspects, the nucleotide sequence encoding the AMP is codon-optimized for expression in algae. In some aspects, the AMP does not substantially inhibit the growth of the algae.

In another aspect, the AMP is from about 5 to about 200 amino acids in length. In another aspect, the AMP is from about 5 to about 600 amino acids in length. In a related aspect, the AMP is an insecticidal AMP or a non-insecticidal AMP.

In another aspect, the AMP comprises the amino acid sequence of any one of SEQ ID NOs: 1-1647. In a related aspect, the AMP comprises the amino acid sequence of any one of SEQ ID NOs: 32, 36, 62, 64, 122, 144, 232, 234, 235, 240, 241, 243-246, 248, 802, 803 and 1638-1647. In yet another related aspect, the AMP comprises the amino acid sequence of any one of SEQ ID NOs: 32, 36, 62, 64, 122, 232, 235, 246, 803 and 1637.

In another aspect, the nucleotide sequence encoding the AMP comprises any one of SEQ ID NOs: 1648-1651.

In another aspect, the present disclosure provides an expression vector comprising a promoter, such as as heterologous promoter, operatively linked to a nucleotide sequence encoding an antimicrobial peptide (AMP), wherein the nucleotide sequence is codon-optimized for expression in algae. In a related aspect, the nucleotide sequence encoding the AMP comprises any one of SEQ ID NOs: 1648-1651.

A. Antimicrobial Peptides (AMPs)

AMPs are a class of peptides that demonstrate antimicrobial activity against microorganisms. Generally, these peptides may be naturally occurring or synthetic and range in size from about 5 amino acids to about 200 amino acids in length (or 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199 or 200 amino acids in length). In most cases, the peptides range in size from about 12 amino acids to about 75 amino acids in length (or 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74 or 75 amino acids in length). In other cases, the AMP is from about 5 to about 600 amino acids in length. These peptides typically comprise two or more positively charged amino acids. Non-limiting examples of amino acid residues that may provide a positive charge include arginine, lysine and histidine. Further, these peptides may be amphipathic. The peptides may comprise a hydrophobic domain, resulting from the presence of hydrophobic amino acid residues. The peptides may comprise at least about 30% hydrophobic residues, 40% hydrophobic residues, 50% hydrophobic residues, 60% hydrophobic residues, 70% hydrophobic residues, 80% hydrophobic residues or 90% hydrophobic residues. The peptides may comprise a linear chain of amino acids, a region of branched amino acids and/or cyclic region of amino acids. An example cyclic peptide includes, but is not limited to, peptides produced by non-ribosomal peptide synthetase (NRPS) (e.g., cyanobacteria derived peptides) or mixed system of NRPS and polyketide synthetases.

In certain aspects, the concentration of the AMP (such as the concentratin of the AMP in an algae culture) is from about 0.5 μM to about 50 μM (or from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50). In a related aspect, the concentration of the AMP is from about 0.5 μM to about 500 μM (or from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 μM).

The mechanisms by which AMPs act varies and may include disrupting membranes, interfering with metabolism and targeting cytoplasmic components. The initial contact between the peptide and the target organism is electrostatic, as most bacterial surfaces are anionic, or hydrophobic, such as in the antimicrobial peptide Piscidin. Their amino acid composition, amphipathicity, cationic charge and size allow them to attach to and insert into membrane bilayers to form pores by ‘barrel-stave,’ ‘carpet’ or ‘toroidal-pore’ mechanisms. Alternately, they may penetrate into the cell to bind intracellular molecules which are crucial to cell living. Intracellular binding models include inhibition of cell wall synthesis, alteration of the cytoplasmic membrane, activation of autolysin, inhibition of DNA, RNA, and protein synthesis, and inhibition of certain enzymes. However, in many cases, the exact mechanism of killing is not known. In contrast to many conventional antibiotics, the activity of these peptides appears to be bactericidal (bacteria killer) instead of bacteriostatic (bacteria growth inhibitor). In general, the antimicrobial activity of these peptides is determined by measuring the minimal inhibitory concentration (MIC), which is the lowest concentration of drug that inhibits bacterial growth.

In addition to exhibiting antimicrobial activity, these peptides have shown to have a number of immunomodulatory functions that may be involved in the clearance of infection, including the ability to alter host gene expression, act as chemokines and/or induce chemokine production, inhibiting lipopolysaccharide induced pro-inflammatory cytokine production, promoting wound healing, and modulating the responses of dendritic cells and cells of the adaptive immune response. Animal models indicate that host defense peptides are crucial for both prevention and clearance of infection. It appears as though many peptides initially isolated as and termed “antimicrobial peptides” have been shown to have more significant alternative functions in vivo (e.g., hepcidin).

The amino acid sequences of exemplary AMPs are provided below in Table 1. An “X” in an amino acid sequence indicates that the amino acid residue at that position of the peptide may be any amino acid residue.

TABLE 1

| SEQ ID NO: | AMINO ACID SEQUENCE |
|---|---|
| 1 | SIGTAVKKAVPIAKKVGKVAIPIAKAVLSVVGQLVG |
| 2 | ELDRICGYGTARCRKKCRSQEYRIGRCPNTYACCLRKWDESLLNRTKP |
| 3 | GLKDKFKSMGEKLKQYIQTWKAKF |
| 5 | RFRPPIRRPPIRPPFYPPFRPPIRPPIFPPIRPPFRPPLRFP |
| 6 | ICIFCCGCCHRSKCGMCCKT |
| 7 | FLSLLPSIVSGAVSLAKKLG |
| 8 | VRPYLVAF |
| 9 | KTCENLADTY |
| 10 | GPLSCRRNGGVCIPIRCPGPMRQIGTCFGRPVKCCRSW |
| 11 | FLPIIAKLLGGLL |
| 12 | FLPIPRPILLGLL |
| 13 | FLIIRRPIVLGLL |
| 14 | GLHKVMREVLGYERNSYKKFFLR |
| 15 | INWKKIAEVGGKILSSL |
| 16 | INWKGIAAMAKKLL |
| 17 | INWKKIAEIGKQVLSAL |
| 18 | INWKGIAAMKKLL |
| 19 | SNDIYFNFQR |
| 20 | FLPMLAGLAANFLPKLFCKITKKC |
| 21 | FLPLAVSLAANFLPKLFCKITKKC |
| 22 | FLPMLAGLAANLLPKLFCKITKKC |
| 23 | FLPMLAGLAANFLPELFCKITKKC |
| 24 | FLPIVGKLLSGLSGLL |
| 25 | FLPIVGKLLSGLL |
| 26 | LLPIVGKLLSGLL |
| 27 | IDWKKLLDAAKQIL |
| 28 | ILGTILGLLKSL |
| 29 | KQATVGDINTERPGILDLKGKAKWDAWNGLKGTSKEDAMKAYINKVEELK |
| | KKYGI |
| 30 | RPRPNYRPRPIYRP |
| 31 | GLLSVLGSVAKHVLPHVVPVIAEKL |
| 32 | FLPLIGRVLSGIL |
| 33 | LLPILGNLLNGLL |
| 34 | LLPIVGNLLNSLL |
| 35 | VLPIIGNLLNSLL |
| 36 | FLPLIGKVLSGIL |
| 37 | RNIICLMQHGTCRLFFCRSGEKKSEICSDPWNRCCI |
| 38 | GLWSTIKNVGKEAAIAAGKAALGAL |
| 39 | NLYQFKNMIQCAGTQLCVAYVKYGCYCGPGGTGTPLDQLDRCCQTHDHCY |
| | DNAKKFGNCIPYFKTYEYTCNKPDLTCTDAKGSCARNVCDCDRAAAICFAA |
| | APYNLANFGINKETHCQ |
| 41 | GIGASILSAGKSALKGLAKGLAEHFAN |
| 42 | GIGSAILSAGKSALKGLAKGLAEHFAN |
| 43 | GIGAAILSAGKSALKGLAKGLAEHF |
| 45 | GIGGALLSAAKVGLKGLAKGLAEHFAN |
| 46 | SMWSGMWRRKLKKLRNALKKKLKGE |
| 47 | GLFGKLIKKFGRKAISYAVKKARGKH |
| 48 | GLFGKLIKKFGRKAISYAVKKARGKN |
| 49 | SWKSMAKKLKEYMEKLKQRA |
| 50 | SWASMAKKLKEYMEKLKQRA |
| 51 | GLKDKFKSMGEKLKQYIQTWKAKF |
| 52 | SLKDKVKSMGEKLKQYIQTWKAKF |
| 53 | GFFGKMKEYFKKFGASFKRRFANLKKRL |
| 54 | TKYYGNGVYCNSKKCWVDWGTAQGCIDVVIGQLGGGIPGKGKC |
| 55 | AGETHTVMINHAGRGAPKLVVGGKKLS |
| 56 | SDEKASPDRHHRFSLSRYAKLANRLSKWIGNRGNRLANPKLLETFKSV |
| 57 | SWLSKTAKKLENSAKKRISEGIAIAIQGGPR |
| 58 | WNPFKELERAGQRVRDAVISAAPAVATVGQAAAIARG |
| 59 | WNPFKELERAGQRVRDAIISAGPAVATVGQAAAIARG |
| 60 | WNPFKELERAGQRVRDAIISAAPAVATVGQAAAIARG |
| 61 | WNPFKELERAGQRVRDAVISAAAVATVGQAAAIARGG |
| 62 | KWKLFKKIEKVGQNIRDGIIKAGPAVAVVGQATQIAK |
| 63 | KWKIFKKIEKVGRNIRNGIIKAGPAVAVLGEAKAL |
| 64 | KWKVFKKIEKMGRNIRNGIVKAGPAIAVLGEAKAL |
| 65 | WNPFKELERAGQRVRDAIISAGPAVATVAQATALAK |
| 66 | WNPFKELEKVGQRVRDAVISAGPAVATVAQATALAK |
| 67 | LSCKRGTCHFGRCPSHLIKGSCSGG |
| 68 | RRIRPRPPRLPRPRPRPLPFPRPGPRPIPRPLPFPRPGPRPIPRPLPFPRPGPRP |
| 69 | VRNHVTCRINRGFCVPIRCPGRTRQIGTCFGPRIKCCRSW |
| 70 | VRNFVTCRINRGFCVPIRCPGHRRQIGTCLGPQIKCCR |
| 71 | GPLSCGRNGGVCIPIRCPVPMRQIGTCFGRPVKCCRSW |
| 72 | SGISGPLSCGRNGGVCIPIRCPVPMRQIGTCFGRPVKCCRSW |
| 73 | SLQGGAPNFPQPSQQNGGWQVSPDLGRDDKGNTRGQIEIQNKGKDHDFNAG |
| | WGKVIRGPNKAKPTWHVGGTYRR |
| 75 | DCLSGRYKGPCAVWDNETCRRVCKEEGRSSGHCSPSLKCWCEGC |
| 76 | SLFSLIKAGAKFLGKNLLKQGACYAACKASKQC |
| 77 | GIMSIVKDVAKNAAKEAAKGALSTLSCKLAKTC |
| 78 | GIMSIVKDVAKTAAKEAAKGALSTLSCKLAKTC |
| 79 | FLPLLAGLAANFLPTIICKISYKC |
| 81 | GLRKRLRKFRNKIKEKLKKI |
| 82 | FLPLILRKIVTAL |
| 83 | LRDLVCYCRSRGCKGRERMNGTCRKGHLLYTLCCR |
| 84 | VVCACRRALCLPRERRAGFCRIRGRIHPLCCRR |
| 85 | VVCACRRALCLPLERRAGFCRIRGRIHPLCCRR |
| 86 | GFGCPLDQMQCHRHCQTITGRSGGYCSGPLKLTCTCYR |
| 87 | ACAAHCLLRGNRGGYCNGKG |
| 89 | FLPLLASLFSRLL |
| 90 | FLPLIGKILGTILGK |
| 91 | FLPLLASLFSRLF |
| 92 | FLPVILPVIGKLLNGILGK |
| 94 | ISDYSIAMDKIRQQDFVNWLLAQKGKKSDWKHNITQ |
| 95 | KAVAAKKSPKKAKKPATPKKAAKSPKKVKKPAAAAKKAAKSPKKATKAAK |
| | PKAAKPKAAKAKKAAPKKK |
| 96 | FLPLLFGAISHLL |
| 97 | AERVGAGAPVYL |
| 98 | FLPLVRGAAKLIPSVVCAISKRC |
| 99 | GFSSLFKAGAKYLLKSVGKAGAQQLACKAANNCA |
| 100 | GVITDALKGAAKTVAAELLRKAHCKLTNSC |
| 101 | SIWEGIKNAGKGFLVSILDKVRCKVAGGCNP |
| 102 | GLFSVLGSVAKHLLPHVAPIIAEKL |
| 103 | GLFSVLGSVAKHLLPHVVPVIAEKL |
| 104 | GLFKVLGSVAKHLLPHVAPIIAEKL |
| 105 | GLWEKVKEKANELVSGIVEGVK |
| 106 | GLFSKFNKKKIKSGLIKIIKTAGKEAGLEALRTGIDVIGCKIKGEC |
| 107 | GLFSKFNKKKIKSGLFKIIKTAGKEAGLEALRTGIDVIGCKIKGEC |
| 108 | GFFSLIKGVAKIATKGLAKNLGKMGLDLVGCKISKEC |
| 109 | VIDDLKKVAKKVRRELLCKKHHKKLN |
| 110 | GFISTVKNLATNVAGTVIDTIKCKVTGGC |
| 111 | AIMDTIKDTAKTVAVGLLNKLKCKITGC |
| 112 | GIMDTIKDTAKTVAVGLLNKLKCKITGC |
| 113 | DSHAKRHHGYKRKFHEKHHSHRGYRSNYLYDN |
| 114 | ALLHHGLNCAKGVLA |
| 115 | WLNALLHHGLNCAKGVLA |
| 116 | GILDTIKSIASKVWNSKTVQDLKRKGINWVANKLGVSPQAA |
| 117 | ITSISLCTPGCKTGALMGCNMKTATCHCSIHVSK |
| 120 | QVVRNPQSCRWNMGVCIPISCPGNMRQIGTCFGPRVPCCR |
| 121 | GIGKFLHSAGKFGKAFVGEIMKS |
| 122 | GIGKFLHSAKKFGKAFVGEIMNS |
| 123 | RSGRGECRRQCLRRHEGQPWETQECMRRCRRRG |
| 124 | ACHAHCQSVGRRGGYCGNFRMTCYCY |
| 125 | NCIQQCVSKGAQGGYCTNEKCTCY |
| 126 | GRFKRFRKKFKKLFKKLS |
| 127 | GGLRSLGRKILRAWKKYG |
| 128 | FAEPTBSEEEGESYSKEVPEMEKRYGGFM |
| 129 | AELRCMCIKTTSGIHPKNIQSLEVIGKGTHCNQVEVIATLKDGRKICLDPDAPR |
| | IKKIVQKKLAGD |
| 130 | RRWCFRVCYRGFCYRKCR |
| 131 | RRWCFRVCYKGFCYRKCR |
| 132 | FCTMIPIPRCY |
| 133 | RVCFAIPLPICH |
| 134 | RVCYAIPLPICY |
| 135 | RVCYAIPLPIC |
| 136 | SIGSALKKALPVAKKIGKIALPIAKAALP |
| 137 | GWLKKIGKKIERVGQHTRDATIQGLGIAQQAANVAATAR |
| 138 | GWLKKIGKKIERVGQHTRDATIQVIGVAQQAANVAATAR |
| 139 | GWLRKIGKKIERVGQHTRDATIQVLGIAQQAANVAATAR |
| 140 | GWIRDFGKRIERVGQHTRDATIQTIAVAQQAANVAATLKG |
| 141 | QGVRNHVTCRIYGGFCVPIRCPGRTRQIGTCFGRPVKCCRRW |
| 142 | QGVRNFVTCRINRGFCVPIRCPGHRRQIGTCLGPRIKCCR |
| 143 | RRCICTTRTCRFPYRRLGTCLFQNRVYTFCC |
| 144 | KWCFRVCYRGICYRRCR |
| 145 | RWCFRVCYRGICYRKCR |
| 146 | KWCFRVCYRGICYRKCR |
| 147 | NPVSCVRNKGICVPIRCPGSMKQIGTCVGRAVKCCRKK |
| 148 | AGFAAQAAASLAPVAAQQL |
| 149 | KSCCRNTWARNCYNVCRLPGTISREICAKKCDCKIISGTTCPSDYPK |
| 150 | SLGSFLKGVGTTLASVGKVVSDQFGKLLQAGQ |
| 151 | ALWKNMLKGIGKLAGQAALGAVKTLVGA |
| 152 | ALWKDILKNVGKAAGKAVLNTVTDMVNQ |
| 153 | GWMSKIASGIGTFLSGMQQ |
| 154 | ACNFQSCWATCQAQHSIYFRRAFCDRSQCKCVFVRG |
| 155 | EWEPVQNGGSSYYMVPRIWA |
| 157 | GKLQAFLAKMKEIAAQTL |
| 158 | GRLQAFLAKMKEIAAQTL |
| 159 | KVNVNAIKKGGKAIGKGFKVISAASTAHDVYEHIKNRRH |
| 160 | GKIPVKAIKKGGQIIGKALRGINIASTAHDIISQFKPKKKKNH |
| 161 | KVPIGAIKKGGKIIKKGLGVIGAAGTAHEVYSHVKNRH |
| 162 | KVPIGAIKKGGKIIKKGLGVLGAAGTAHEVYNHVRNRQ |
| 163 | KVPIGAIKKGGKIIKKGLGVIGAAGTAHEVYSHVKNRQ |
| 164 | KVPVGAIKKGGKAIKTGLGVVGAAGTAHEVYSHIRNRH |
| 165 | KGIGSALKKGGKIIKGGLGALGAIGTGQQVYEHVQNRQ |
| 166 | GWASKIGQTLGKIAKVGLKELIQPK |
| 168 | FLSLIPHAINAVSAIAKHFG |
| 169 | VIGSILGALASGLPTLISWIKNR |
| 170 | AIGSILGALAKGLPTLISWIKNR |
| 171 | YYGNGVYCTKNKCTVDWAKATTCIAGMSIGGFLGG |
| 172 | NFVTCRINRGFCVPIRCPGHRRQIGTCLGPRIKCCR |
| 173 | SIITMTKEAKLPQLWKQIACRLYNTC |
| 174 | ETESTPDYLKNIQQQLEEYTKNFNTQVQNAFDSDKIKSEVNNFIESLGKILNTE |
| | KKEAPK |
| 175 | ENFFKEIERAGQRIRDAIISAAPAVETLAQAQKIIKGGD |
| 176 | DTLIGSCVWGATNYTSDCNAECKRRGYKGGHCGSFLNVNCWCEE |
| 177 | DKLIGSCVWGATNYTSDCNAECKRRGYKGGHCGSFWNVNCWCEE |
| 178 | EADEPLWLYKGDNIERAPTTADHPILPSIIDDVKLDPNRRYA |
| 179 | DIQIPGIKKPTHRDIIIPNWNPNVRTQPWQRFGGNKS |
| 180 | EIRLPEPFRFPSPTVPKPIDIDPILPHPWSPRQTYPIIARRS |
| 181 | GLLRASSVWGRKYYVDLAGCAKA |
| 182 | SIITMTKEAKLPQSWKQIACRLYNTC |
| 183 | AALRGALRAVARVGKAILPHVAIANPYVRTPYVHNNP |
| 184 | VRRFPWWWPFLRR |
| 185 | RRRFPWVCWPFLRRR |
| 186 | RFPWWWPFLR |
| 187 | FPWWWPF |
| 188 | KWKLFKKIGIGKFLHSAKKF |
| 189 | KWKLFKKIPKFLHSAKKF |
| 190 | KLKLFKKIGIGKFLHSAKKF |
| 191 | KAKLFKKIGIGKFLHSAKKF |
| 192 | INLKAIAALAKKLLG |
| 193 | INLKAIAAMAKKLL |
| 194 | APIIRRIPYYPEVESDLRIVDCKRSEGFCQEYCNYLETQVGYCSKKKDACCLH |
| 196 | RSVCRQIKICRRRGGCYYKCTNRPY |
| 197 | XNLRRIIRKIIHIIKKYG |
| 198 | XNLRRIIRKGIHIIKKYG |
| 199 | XNLRRITRKIIHIIKKYG |
| 200 | FIGPIISALASLFG |
| 201 | FLSLALAALPKFLCLVFKKC |
| 202 | FLSLALAALPKLFCLIFKKC |
| 203 | FLPLLLAGLPKLLCLFFKKC |
| 204 | GLFDVVKGVLKGAGKNVAGSLLEQLKCKLSGGC |
| 205 | GIFDVVKGVLKGVGKNVAGSLLEQLKCKLSGGC |
| 206 | GLFSVVTGVLKAVGKNVAKNVGGSLLEQLKCKISGGC |
| 207 | YVPLPNVPQPGRRPFPTFPGQGPFNPKIKWPQGY |
| 208 | QCIGNGGRCNENVGPPYCCSGFCLRQPGQGYGYCKNR |
| 209 | CIGNGGRCNENVGPPYCCSGFCLRQPNQGYGVCRNR |
| 210 | VGECVRGRCPSGMCCSQFGYCGKGPKYCGR |
| 211 | FALALKALKKALKKLKKALKKAL |
| 212 | LRDLVCYCRTRGCKRRERMNGTCRKGHLMYTLCCR |
| 213 | LRDLVCYCRKRGCKRRERMNGTCRKGHLMYTLCCR |
| 214 | VTCDLLSFKGQVNDSACAANCLSLGKAGGHCEKVGCICRKTSFKDLWDKYF |
| 215 | AMWKDVLKKIGTVALHAGKAALGAVADTISQ |
| 216 | LLGDFFRKSKEKIGKEFKRIVQRIKDFLRNLVPRTES |
| 217 | GRFKRFRKKFKKLFKKLSPVIPLLHLG |
| 218 | RIIDLLWRVRRPQKPKFVTVWVR |
| 219 | GRFRRLRKKTRKRLKKIGKVLKWIPPIVGSIPLGCG |
| 220 | GLLSRLRDFLSDRGRRLGEKIERIGQKIKDLSEFFQS |
| 221 | RRRPRPPYLPRPRPPPFFPPRLPPRIPPGFPPRFPPRFP |
| 222 | DLRFLYPRGKLPVPTPPPFNPKPIYIDMGNRY |
| 223 | VCGETCVGGTCNTPGCTCSWPVCTRNGLP |
| 224 | GIPCGESCVWIPCISAALGCSCKNKVCYRN |
| 225 | SIPCGESCVFIPCTVTALLGCSCKSKVCYKN |
| 226 | GVIPCGESCVFIPCISTLLGCSCKNKVCYRN |
| 227 | FFHHIFRGIVHVGKTIHKLVTGG |
| 228 | FFHHIFRGIVHVGKTIHRLVTGG |
| 229 | FFHHIFRGIVHVGRTIHKLVTGG |
| 230 | FFHHIFRGIVHVGRTIHRLVTGG |
| 232 | GWKDWAKKAGGWLKKKGPGMAKAALKAAMQ |
| 233 | GWKDWLKKGKEWLKAKGPGIVKAALQAATQ |
| 234 | GWKDWLNKGKEWLKKKGPGIMKAALKAATQ |
| 235 | DFKDWMKTAGEWLKKKGPGILKAAMAAAT |
| 236 | GLKDWVKIAGGWLKKKGPGILKAAMAAATQ |
| 237 | GLVDVLGKVGGLIKKLLP |
| 238 | GLVDVLGKVGGLIKKLLPG |
| 239 | LLKELWTKMKGAGKAVLGKIKGLL |
| 240 | LLKELWTKIKGAGKAVLGKIKGLL |
| 241 | WLGSALKIGAKLLPSVVGLFKKKKQ |
| 242 | WLGSALKIGAKLLPSVVGLFQKKKK |
| 243 | GIWGTLAKIGIKAVPRVISMLKKKKQ |
| 244 | GIWGTALKWGVKLLPKLVGMAQTKKQ |
| 245 | FWGALIKGAAKLIPSVVGLFKKKQ |
| 246 | FIGTALGIASAIPAIVKLFK |
| 247 | LLPNLLKSLL |
| 248 | FVQWFSKFLGRIL |
| 249 | GLFDIIKKIAESI |
| 250 | GLFDIIKKIAESF |
| 251 | FDIVKKVVGALGSL |
| 252 | GLFDIVKKVVGAIGSL |
| 253 | FDIVKKVVGTIAGL |
| 254 | GLFDIAKKVIGVIGSL |
| 255 | GLFDIVKKIAGHIVSSI |
| 256 | GLFGVLAKVAAHVVPAIAEHF |
| 257 | GLFGVLAKVASHVVPAIAEHFQA |
| 258 | KTCEHLADTYRGVCFTNASCDDHCKNKAHLISGTCHNWKCFCTQNC |
| 259 | KTCENLSGTFKGPCIPDGNCNKHCRNNEHLLSGRCRDDFRCWCTNRC |
| 260 | SSLLEKGLDGAKKAVGGLGKLGKDAVEDLESVGKGAVHDVKDVLDSV |
| 261 | ZCRRLCYKQRCVTYCRGR |
| 262 | GCRFCCNCCPNMSGCGVCCRF |
| 263 | SKGKKANKDVELARG |
| 264 | GLNTLKKVFQGLHEAIKLINNHVQ |
| 265 | GLNALKKVFQGIHEAIKLINNHVQ |
| 266 | GINTLKKVIQGLHEVIKLVSNHE |
| 267 | GINTLKKVIQGLHEVIKLVSNHA |
| 269 | FRGLAKLLKIGLKSFARVLKKVLPKAAKAGKALAKSMADENAIRQQNQ |
| 270 | GKFSVFGKILRSIAKVFKGVGKVRKQFKTASDLDKNQ |
| 271 | GKFSGFAKILKSIAKFFKGVGKVRKQFKEASDLDKNQ |
| 272 | GKLSGISKVLRAIAKFFKGVGKARKQFKEASDLDKNQ |
| 273 | GKFSVFSKILRSIAKVFKGVGKVRKQFKTASDLDKNQ |
| 274 | RWKLFKKIEKVGRNVRDGLIKAGPAIAVIGQAKSL |
| 275 | RWKIFKKIEKMGRNIRDGIVKAGPAIEVLGSAKAI |
| 276 | GVLSNVIGYLKKLGTGALNAVLKQ |
| 277 | ILPWKWPWWPWRR |
| 278 | SHQDCYEALHKCMASHSKPFSCSMKFHMCLQQQ |
| 279 | GIGTKILGGVKTALKGALKELASTYAN |
| 280 | ILGPVISTIGGVLGGLLKNL |
| 281 | GIGTKILGGVKTALKGALKELASTYVN |
| 282 | GIGGKILSGLKTALKGAAKELASTYLH |
| 283 | ILGPVLSMVGSALGGLIKKI |
| 284 | GIGGVLLSAGKAALKGLAKVLAEKYAN |
| 285 | ILGPVLGLVGNALGGLIKKI |
| 286 | SIGAKILGGVKTLLKGALKELASTYLQ |
| 287 | GLLNTFKDWAISIAKGAGKGVLTTLSCKLDKSC |
| 288 | SLFSLIKAGAKFLGKNLLKQGAQYAACKVSKEC |
| 289 | GILDSFKQFAKGVGKDLIKGAAQGVLSTMSCKLAKTC |
| 290 | LLPIVGNLLKSLL |
| 291 | VTCDILSVEAKGVKLNDAACAAHCLFRGRSGGYCNGKRVCVCR |
| 292 | SLGGVISGAKKVAKVAIPIGKAVLPVVAKLVG |
| 293 | HRHQGPIFDTRPSPFNPNQPRPGPIY |
| 294 | GSKKPVPIIYCNRRTGKCQRM |
| 295 | VTCYCRSTRCGFRERLSGACGYRGRIYRLCCR |
| 296 | GICRCICGRRICRCICGR |
| 297 | RYICRCICGRGICRCICG |
| 298 | GICRCICGRYICRCICGR |
| 299 | GICYCICGKGICRCICGR |
| 300 | RXICGXXIC |
| 301 | GVCRCICGRGVCRCICGR |
| 302 | GVCRCICGRGVCRCICRR |
| 303 | GICRCICGRRICRCICGK |
| 304 | GICKCICGRRICRCICGR |
| 305 | GICRCICGRRICKCICGR |
| 306 | GICRCICGRKICRCICGR |
| 307 | GICRCICGKKICRCICGR |
| 308 | GICRCICGKRICRCICGR |
| 309 | GICKCICGKGICKCICGR |
| 310 | GICRCICGKGICRCYCGR |
| 311 | VTPAMRTFALLTAMLLLVALAQAEPLQARADEAAAQEQPGADDQEMAHAFT |
| | WHESAALPLSSDSARGLRCICGRGICRLLRRFGSCAFRGTLHRICCRACRIKKH |
| | KLRIYFESKKFLLLLYLVLHFLFSSKINTLLQDFSL |
| 312 | VTPAMRTFALLTAMLLLVALAQAEPLQARADEAAAQEQPGADDQEMAHAFT |
| | WHESAALPLSSDSARGLRCICGRRICRLLRRFGSCAFRGTLHRICCRACRIKKH |
| | KLRIYFESKKFLLLLYLVLHFLFSSKINTLLQDFS |
| 313 | VTPAMRTFALLTAMLLLVALAQAEPLQARADEAAAQEQSDSARGLRCICGRG |
| | ICRLLRRFGSCAFRGTLHRVCCRTCRIKKNKLRIYFESKKFLLLLYLVLHFLFSS |
| | KINTLLQDFSL |
| 314 | RCLCVLRIC |
| 315 | RCLCVLRVC |
| 316 | RCLCTLRIC |
| 317 | RCLCTLRVC |
| 318 | RCLCGLRIC |
| 319 | RCLCGLRVC |
| 320 | RCICVLRFC |
| 321 | RCICVLRVC |
| 322 | RCICTLRFC |
| 323 | RCICTLRVC |
| 324 | RCICRLRFC |
| 325 | RCICRLRVC |
| 326 | RCICGRRIC |
| 327 | RCLCVRRVC |
| 328 | RCLCTRRFC |
| 329 | RCLCGRRVC |
| 330 | RCLCRRRFC |
| 331 | RCLCRRRVC |
| 332 | RCLCRLRIC |
| 333 | RCICGLRVC |
| 334 | RCICGLRFC |
| 335 | RCICGRRFC |
| 336 | RCICVRRVC |
| 337 | RCICRLRIC |
| 338 | RCICTLRIC |
| 339 | RCICTRRFC |
| 340 | RCICTRRVC |
| 341 | RCICRRRFC |
| 342 | RCICRRRVC |
| 343 | RCLCGRRFC |
| 344 | RCLCVRRIC |
| 345 | RCLCTRRIC |
| 346 | RCICGRRVC |
| 347 | RCICGLRIC |
| 348 | RCICVRRIC |
| 349 | RCICTRRIC |
| 350 | RCICRRRIC |
| 351 | RCLCGRRIC |
| 352 | VTPAMRTFALLTAMLLLVALHAQAEARQARADEAAAQQQPGADDQGMAHS |
| | FTRPENAALPLSESARGLRCICRRGVCQLLRRLGSCAFRGLCRICCRASRIKKN |
| | TLRSYFESXKKFLLLLYLVLNFLFSSQINTFSQDFCL |
| 353 | VTPAMRTFALLTAMLLLVALHAQAEARQARADEAAAQQQPGADDQGMAHS |
| | FTRPENAALPLSESARGLRCLCRRGVCQLLRRLGSCAFRGLCRICCRASRIKKN |
| | TLRSYFESXKKFLLLLYLVLNFLFSSQINTFSQDFCL |
| 354 | VTPAMRTFALLTAMLLLVALAQAEPLQARADEAAAQEQPGADDQEMAHAFT |
| | WDESAALPLSDSARGLRCIGGRGICGLLQRRVGSCAFRGTLHRICCRACRIKK |
| | NKLRIYSESKKFLLLLYLVLHFLFSSKINTSLQDFSL |
| 355 | VTPAMRTFALLTAMLLLVALAQAEPLQARADEAAAQEQPGADDQEMAHAFT |
| | WDESAALPLSDSARGLRCIGGRGICGLLQRRFGSCAFRGTLHRICCRACRIKKN |
| | KLRIYSESKKFLLLLYLVLHFLFSSKINTLLQDFSL |
| 356 | VTPAMRTFALLTAMLLLVDLAQAEPLQARADEAAAQEQPGADDQEMAHAFT |
| | WDESAALPLSDSARGLRCICGRGICRLLRRFGSCAFRGTLHRICCRACRIKKNK |
| | LRIYFETKKFLLLLYLVLHFLFSSKINTLLQDFCL |
| 357 | VTPAMRTFTVLAAMLLVVALQAQAEPLRARADETAAQEQPGADDQEMAHAF |
| | TWDESAALPLSDSARGLRCICRRGVCRLLRHFGSCAFRGTLHRICCRACRIKK |
| | NKLRIYFESKKFLFLLYLALHFLFSSKINTLLQDFCL |
| 358 | VTPAMRTFTVLAAMLLVVALQAQAEPLRARADETAAQEQPGADDQEMAHAF |
| | TWDESAALPLSDSARGLRCICRRGVCRFLRHLGSCAFRGTLHRICCRACRIKK |
| | NKLRIYFESKKFVFLLYLALHFLFSSKINTLLQDFCL |
| 359 | VTPAMRTFALLAAMLLLVALAEAEPLQARADETAAQEQPGADDQEMAHAFT |
| | WDESATLPLSDSARGLRCICRRGVCRFLRHLGSCAFRGTLHRICCRACRIKKN |
| | KLRIYFESKKFVFLLYLALHFLFSSKINTLLQDFCL |
| 360 | VTPAMRTFALLTAMLLLVALAQAEPLQARADEAAAQEQPGADDQEMAHAFT |
| | WHESAALPLSDSARGLRCICGRGICRLLRRFGSCAFRGTLHRICCRACRIKKHK |
| | LRIYFESKKFLLLLYLVLHFLFSSKINTLLQDFSL |
| 361 | RCLCVLGIC |
| 362 | RCLCVLGVC |
| 363 | RCLCTLGIC |
| 364 | RCLCTLGVC |
| 365 | RCLCGLGIC |
| 366 | RCLCGLGVC |
| 367 | RCICVLGFC |
| 368 | RCICVLGVC |
| 369 | RCICTLGFC |
| 370 | RCICTLGVC |
| 371 | RCICRLGFC |
| 372 | RCICRLGVC |
| 373 | RCICGRGIC |
| 374 | RCLCVRGVC |
| 375 | RCLCTRGFC |
| 376 | RCLCTRGVC |
| 377 | RCLCRRGFC |
| 378 | RCLCRRGVC |
| 379 | RCLCRLGIC |
| 380 | RCICGLGVC |
| 381 | RCICGLGFC |
| 382 | RCICGRGFC |
| 383 | RCICVRGVC |
| 384 | RCICRLGIC |
| 385 | RCICTLGIC |
| 386 | RCICTRGFC |
| 387 | RCICTRGVC |
| 388 | RCICRRGFC |
| 389 | RCICRRGVC |
| 390 | RCLCGRGFC |
| 391 | RCLCGRGVC |
| 392 | RCLCVRGIC |
| 393 | RCLCTRGIC |
| 394 | RCICGRGVC |
| 395 | RCICGLGIC |
| 396 | RCICVRGIC |
| 397 | RCICTRGIC |
| 398 | RCICRRGIC |
| 399 | RCLCGRGIC |
| 400 | MRTFALLTAMLLLVALHAQAEARQARADEAAAQQQPGADDQGMAHSFTRP |
| | ENAALPLSESARGLRCLCRRGVCQLL |
| 401 | MRTFALLTAMLLLVALHAQAEARQARADEAAAQQQPGTDDQGMAHSFTWP |
| | ENAALPLSESAKGLRCICTRGFCRLL |
| 402 | MRIIALLAAILLVALQVRAGPLQARGDEAPGQEQRGPEDQDISISFAWDKSSAL |
| | QVSGSTRGMVCSCRLVFCRRTELRVGNCLIGGVSFTYCCTRVD |
| 403 | AQAEPLQARADEAAAQEQPGADDQEMAHAFTWHESAALPLSDSARGLRCIC |
| | GRGICRLL |
| 404 | RGCICRCIGRGCICRCIG |
| 405 | GICICICGRGICYCICGR |
| 406 | GICICICGYGICRCICGR |
| 407 | GICYCICGRGICRCICGR |
| 408 | GICRCICGRGYCRCICGR |
| 409 | GYCRCICGRGICRCICGR |
| 410 | GICRCICGRGICRCYCGR |
| 411 | GICRCYCGRGICRCICGR |
| 412 | GICRCICGKGICRCICGR |
| 413 | GICRCICGRGICRCICGR |
| 414 | VPKCCKPV |
| 415 | CKPV |
| 416 | SYSMEHFRWGKPV |
| 417 | HFRWGKPV |
| 418 | MEHFRWG |
| 419 | MAKSYGAIFLLTLIVLFMLQTMYMASSGSNVKWRQKRVGPGSLKRTQCPSEC |
| | DRRCKKTQYHKACITFCNKCCRKCLCVPPGYYGNKQVCSCYNNWKTQEGGP |
| | KCP |
| 420 | CDGKCKVRCSKASRHDDCLKYCGVCCASCNCVPSGTAGNKDECPCYRDMTT |
| | GHGARKRP |
| 421 | ADVENSQKKNGYAKKIDCGSACVARCRLSRRPRLCHRACGTCCYRCNCVPPG |
| | TYGNYDKCQCYASLTTHGGRRKCP |
| 422 | MVRCSLSSRPNLCHRACGTCCARCNCVAPGTSGNYDKCPCYGSLTTHGGRRK |
| | EV |
| 423 | QSKDGPALEKWCGQKCEGRCKEAGMKDRCLKYCGICCKDCQCVPSGTYGNK |
| | HECACYRDKLSSKGTPKCP |
| 424 | EQKQGQYGEGSLRPSECGQRCSYRCSATSHKKPCMFFCQKCCAKCLCVPPGT |
| | FGNKQVCPCYNNWKTQQGGPKCP |
| 425 | CGGKCNVRCSKAGQHEECLKYCNICCQKCNCVPSGTFGHKDECPCYRDMKN |
| | SKGGSKCP |
| 426 | YEFREIKFFFLCVYVQGDELESQAQAPAIHKNGGEGSLKPEECPKACEYRCSAT |
| | SHRKPCLFFCNKCCNKCLCVPSGTYGHKEECPCYNNWTTKEGGPKCP |
| 427 | LVTSASKGSSFPKKIDCGGACAARCQLSSRPHLCKRACGTCCARSRCVPPGTA |
| | GNQEMCPCYASLTTHGGKRKCP |
| 428 | MMISLLVFNPVEADGVVVNYGQHASLLAKIDCGGACKARCRLSSRPHLCKRA |
| | CGTCCQRCSCVPPGTAGNYDVCPCYATLTTHGGKRKCP |
| 429 | LVTSAGKGNSSPKKIDCGGACAARCQLSSRPHLCKRACGTCCARCACVPPGT |
| | AGNQEMCPKCYASLTTHGGKRKCP |
| 430 | GSLHPQDCQPKCTYRCSKTSFKKPCMFFCQKCCAKCLCVPAGTYGNKQTCPC |
| | YNNWKTKEGGPKCP |
| 431 | ADVESSQKKNGYAKKIDCGSACVARCRLSRRPRLCHRACGTCCYRCNCVPPG |
| | TYGNYDKCQCYASLTTHGGRRKCP |
| 432 | YELHVHAADGAKVGEGVVKIDCGGRCKDRCSKSSRTKLCLRACNSCCSRCNC |
| | VPPGTSGNTHLCPCYASITTHGGRLKCP |
| 433 | AAEDSQVGEGVVKIDCGGRCKGRCSKSSRPNLCLRACNSCCYRCNCVPPGTA |
| | GNHHLCPCYASITTRGGRLKCP |
| 434 | GRLHPQDCQPKCTYRCSKTSYKKPCMFFCQKCCAKCLCVPAGTYGNKQSCPC |
| | YNNWKTKRGGPKCP |
| 435 | SVSNLVQAARGGGKLKPQQCNSKCSYRCSATSHKKPCMFFCLKCCKKCLCVP |
| | PGTFGNKQTCPCYNNWKTKEGRPKCP |
| 436 | IFLLTLIVLFMLQTMVMASSGSNVKWRQKRYGPGSLKRTQCPSECDRRCKKT |
| | QYHKACITFCNKCCRKCLCVPPGYYGNKQVCSCYNNWKTQEGGPKCP |
| 437 | IFLLTLIVLFMLQTMVMASSGSNVKWSQKRYGPGSLKRTQCPSECDRRCKKT |
| | QYHKACITFCNKCCRKCLCVPPGYYGNKQVCSCYNNWKTQEGGPKCP |
| 438 | LRPTDCKPRCTYRCSATSHKKPCMFFCQKCCATCLCVPKGVYGNKQSCPCYN |
| | NWKTQEGKPKCP |
| 439 | KSYQCGGQCTRRCSNTKYHKPCMFFCQKCCAKCLCVPPGTYGNKQVCPCYN |
| | NWKTQQGGPKCP |
| 440 | SKINCGAACKARCRLSSRPNLCHRACGTCCARCRCVPPGTSGNQKVCPCYYN |
| | MTTHGGRRKCP |
| 441 | MKLFLLTLLLVTLVITPSLIQTTMAGSNFCDSKCKLRCSKAGLADRCLKYCGV |
| | CCEECKCVPSGTYGNKHECPCYRDKKNSKGKSKCP |
| 442 | HEVQHIDCNAACAARCRLASRQRMCHRACGTCCRRCNCVPPGTSGNQEVCP |
| | CYASLATHGGRRKCP |
| 443 | MAARSYSPIMVALSLLLLVTFSNVAEAYTRSGTLRPSDCKPKCTYRCSATSHK |
| | KPCMFFCQKCCAKCLCVPPGTYGNKQICPCYNSWKTKEGGPKCP |
| 444 | MAMAKVFCVLLLALLGISMITTQVMATDSAYHLDGRNYGPGSLKSSQCPSEC |
| | TRRCSQTQYHKPCMVFCKQCCKRCLCVPPGYYGNKSVCPCYNNWKTKRGGP |
| | KCP |
| 445 | MAVANKLLSVLIIALIAISMLQTVVMASHGHGGHHYNDKKKYGPGSLKSFQC |
| | PSQCSRRCGKTQYHKPCMFFCQKCCRKCLCVPPGYYGNKAVCPCYNNWKTK |
| | EGGPKCP |
| 446 | MAKFFAAMILALIAISMLQTVVMAANEQGGHLYDNKSKYGSGSVKRYQCPS |
| | QCSRRCSQTQYHKPCMFFCQKCCRKCLCVPPGYYGNKAVCPCYNNWKTKEG |
| | GPKCP |
| 447 | MAKFFAAMILALFAISILQTVVMAANEQGGHLYDNKSKYGSGSVKSYQCPSQ |
| | CSRRCSQTQYHKPCMFFCQKCCRTCLCVPPGYYGNKAVCPCYNNWKTKEGG |
| | PKCP |
| 448 | MASNSILLLCIFLVVATKVFSYDEDLKTVVPAPAPPVKAPTLAPPVKSPSYPPG |
| | PVTTPTVPTPTVKVPPPPQSPVVKPPTPTVPPPTVKVPPPPQSPVVKPPTPTPTSP |
| | VVYPPPVAPSPPAPVVKSNKDCIPLCDYRCSLHSRKKLCMRACITCCDRCKCV |
| | PPGTYGNREKCGKCYTDMLTHGNKFKCP |
| 449 | MEKKRKTLLLLLLMAATLFCMPIVSYAVSSVNIQGHLTHSELVKGPNRRLLPF |
| | VDCGARCRVRCSLHSRPKICSRACGTCCFRCRCVPPGTYGNREMCGKCYTDM |
| | ITHGNKPKCP |
| 450 | MALSKLIIASLLASLLLLHFVDADQSAHAQTQGSLLQQIDCNGACAARCRLSS |
| | RPRLCQRACGTCCRRCNCVPPGTAGNQEVCPCYASLTTHGGKRKCP |
| 451 | MALRVLLVLGMLLMLCLVKVSSDPKIEEEILEAEEELQFPDNEPLIVRDANRRL |
| | MQDMDCGGLCKTRCSAHSRPNLCTRACGTCCVRCKCVPPGTSGNRELCGTC |
| | YTDMTTHGNKTKCP |
| 452 | MAPRVFLVLGMLLMVCLVKVSSDPKREEEILEEELHFPDNEPLIVRDGNRRLM |
| | QDIDCGGLCKTRCSAHSRPNLCTRACGTCCVRCKCVPPGTSGNRELCGTCYTD |
| | MTTHGNKTKCP |
| 453 | MMGILLLVCLAKVSSDVNMQKEEDEELRFPNHPLIVRDGNRRLMQDIDCGGL |
| | CKTRCSAHSRPNVCNRACGTCCVRCKCVPPGTSGNRELCGTCYTDMITHGNK |
| | TKCP |
| 454 | MKLVFATLLLCSLLLSSSFLEPVIAYEDSSYCSNKCSDRCSSAGVKDRCLRYCG |
| | ICCAECKCVPSGTYGNKHQCPCYRDKLNKKGKPKCP |
| 455 | MKLEFANVLLLCLVLSSSFLEISMAGSPFCDSKCAQRCAKAGVQDRCLRFCGI |
| | CCEKCNCVPSGTYGNKDECPCYRDMKNSKGKDKCP |
| 456 | MAPGKLAVFALLASLLLLNTIKAADYPPAPPLGPPPHKIVDPGKDCVGACDAR |
| | CSEHSHKKRCSRSCLTCCSACRCVPAGTAGNRETCGRCYTDWVSHNNMTKCP |
| 457 | MLLLALAAHHQAASDPPATHGGMRASGTRSLLQQQPPPPRLDCPKVCAGRCA |
| | NNWRKEMCNDKCNVCCQRCNCVPPGTGQDTRHICPCYATMTNPHNGKLKCP |
| 458 | MVTKVICFLVLASVLLAVAFPVSALRQQVKKGGGGEGGGGGSVSGSGGGNL |
| | NPWECSPKCGSRCSKTQYRKACLTLCNKCCAKCLCVPPGFYGNKGACPCYNN |
| | WKTREGGPKCP |
| 459 | MSKPSRCRAVQTQVALLLLLLVAASLLQAGDAASGFCAGKCAVRCGRSRAK |
| | RGACMKYCGLCCXECACVPTGRSGSRDECPCYRDMLTAGPRKRPKCP |
| 460 | MKPLPVTLALLALFLVASYQDLTVAADADADAAGAGDVGAVPVPDSVCEGK |
| | CKNRCSQKVAGRCMGLCMMCCGKCAGCVPSGPLAPKDECPCYRDMKSPKS |
| | GRPKCP |
| 461 | MKKLRTTTATTTLALILLLVLIAATSLRVAMAGSAFCDSKCGVRCSKAGRHD |
| | DCLKYCGICCAECNCVPSGTAGNKDECPCYRDKTTGHGARTRPKCP |
| 462 | MKKLRTTTLALLLLLVFLAASSLRAAMAGSAFCDGKCGVRCSKASRHDDCLK |
| | YCGICCAECNCVPSGTAGNKDECPCYRDKTTGHGARKRPKCP |
| 463 | MGGGNGGAGGGGKLKPWECSSKCSSRCSGTQYKKACLTYCNKCCATCLCVP |
| | PGTYGNKGACPCYNNWKTKEGGPKCP |
| 464 | MESKSPWSLRLLICCAAMVAIALLPQQGGQAACFVPTPGPAPAPPGSSATNTN |
| | ASSAAPRPAKPSAFPPPMYGGVTPGTGSLQPHECGGRCAERCSATAYQKPCLF |
| | FCRKCCAACLCVPPGTYGNKNTCPCYNNWKTKRGMYGGVTPGTGSLQPHEC |
| | GGRCAERCSATAYQKPCLFFCRKCCAACLCVPPGTYGNKNTCPCYNNWKTK |
| | RGGPKCP |
| 465 | MAKASSRLLFSLSLVVLLLLVETTTSPHGQADAIDCGASCSYRCSKSGRPKMC |
| | LRACGTCCQRCGCVPPGTSGNEDVCPCYANMKTHDGQHKCP |
| 466 | MKAIPVALLLLVLVAAASSFKHLAEAADGGAVPDGVCDGKCRSRCSLKKAG |
| | RCMGLCMMCCGKCQGCVPSGPYASKDECPCYRDMKSPKNQRPKCP |
| 467 | MMTTMKKKKQQQQLLLLSLMFLVAVTAAAVAADPHPQQVQVQQQQQAQM |
| | RINRATRSLLPQPPPKLDCPSTCSVRCGNNWKNQMCNKMCNVCCNKCSCVPP |
| | GTGQDTRHLCPCYDTMLNPHTGKLKCP |
| 468 | MAVAKPPLQTAAVLLLLLLVVAAASWLQTVDAASGFCSSKCSVRCGRAASA |
| | RARGACMRSCGLCCEECNCVPTRPPRDVNECPCYRDMLTAGPRKRPKCP |
| 469 | MAPSKLAVVVALVASLLLLTTSNTKLGLFVLGQAAPGAYPPRAPPPHQIVDLA |
| | KDCGGACDVRCGAHSRKNICTRACLKCCGVCRCVPAGTAGNQQTCGKCYTD |
| | WTTHGNKTKCP |
| 470 | MKLQATARVAGLLFLVLLLALPSLRVSMAGSGFCDGKCAVRCSKASRHDDCL |
| | KYCGICCATCNCVPSGTAGNKDECPCYRDMTTGHGNRTRPKCP |
| 471 | MVTKVICFLVLASVLLAVAFPVSALRQQVKKGGGGEGGGGGSVSGSGGGNL |
| | NPWECSPKCGSRCSKTQYRKACLTLCNKCCAKCLCVPPGFYGNKGACPCYNN |
| | WKTKEGGPKCP |
| 472 | MNNLHRELAPIASAAWEQIEEEVARTFKRSVAGRRVVDVEGPKGPALSAVGT |
| | GHLRDVDAPREQVSARLREVRAIVELTVPFELSRDAIDSVERGARDADWQPA |
| | KDAAQRLAFAEDHAIFDGYAAAGIIGIREGSSNRRLTLPDDVGAYPDAISDALE |
| | ALRLAGVDGPYSVLLGADAYTALSEARDQGYPVIDHIKRIVSGEIIWAPAISGG |
| | CVLSTRGGDYELHLGEDVSIGYTSHTDKVVRLYLRETFTFLML |
| 473 | MNNLHRELAPISSAAWEQIEEEVARTFKRSVAGRRVVDVEGPAGPELSAVGT |
| | GHLLDVAAPRELVNARLREVRTIVELTVPFELSRDAIDSVERGARDADWQPAK |
| | EAAQRLAFAEDNAIFDGYPAAGIVGIREGTSNRRLTLPADVGAYPDAISDALE |
| | ALRLAGVDGPYSVVLGSDAYTALSEARDQGYPVLGHIKRIVSGEIIWAPAISGG |
| | CVLSTRGGDYELHLGEDVSIGYTSHTDKGVRLYLRETFTFLML |
| 474 | KFAKKAAKKFAKKAAK |
| 475 | KFAKKFAKKAAKKAAK |
| 476 | KFAKKFAKKFAKKAAK |
| 477 | FKLRAKIKVRLRAKIKL |
| 478 | FAKKFAKKFKKFAKKFAKFAFAF |
| 479 | KGKKGKKGKKGKKGKKGKKGK |
| 480 | KFKKFKKFKKFK |
| 481 | KFKKFKKFK |
| 482 | KFAKKFAKKFAKKFAKKFAKKFAKKFAKKFAKKFAKKFAKKFAKKFAKKFA |
| | KKFAKKFAKKFAKKFAKKFAKKFAKKFAK |
| 483 | LKLKLKLKLKLKLK |
| 484 | KFAKKFAKKFAK |
| 485 | KFAKKFAK |
| 486 | KFAK |
| 487 | KTKKTKKTKKTKKTKKTKKTK |
| 488 | KGKKGKKGKKGKKGKKGKKGKKGKKGKKGKKGKKGKKGKKGKKGK |
| 489 | KGKKGKKGKKGKKGKKGKKGKKGKKGKKGKKGK |
| 490 | LRLRLRLRLRLRLRLRLRLRLR |
| 491 | LRLRLRLRLRLRLRLRLR |
| 492 | LRLRLRLRLRLRLR |
| 493 | LKLKLKLKLKLKLKLKLKLKLKLKLKLKLKLKLKLKLKLKLKLKLKLK |
| 494 | LKLKLKLKLKLKLKLKLKLKLKLKLKLKLKLKLKLK |
| 495 | LKLKLKLKLKLKLKLKLKLKLKLK |
| 496 | LKLKLKLKLKLKLKLKLKLKLK |
| 497 | LKLKLKLKLKLKLKLKLKLK |
| 498 | LKLKLKLKLKLKLKLKLK |
| 499 | LKLKLKLKLKLKLKLK |
| 500 | LKLKLKLKLK |
| 501 | LKLK |
| 502 | FKAFKAFKAFKAFKAFKAFKAFKAFKAFKAFKAFKAFKAFKAFKAFKAFKAF |
| | KAFKAFKAFKA |
| 503 | FKAFKAFKAFKAFKAFKAFKAFKAFKAFKAFKAFKAFKAFKAFKAFKAFKA |
| 504 | FKAFKAFKAFKAFKAFKAFKAFKAFKAFKA |
| 505 | FKAFKAFKAFKAFKAFKAFKAFKAFKA |
| 506 | FKAFKAFKAFKAFKAFKAFKAFKA |
| 507 | FKAFKAFKAFKAFKAFKAFKA |
| 508 | FKAFKAFKAFKAFKAFKA |
| 509 | FKAFKAFKAFKA |
| 510 | FKAFKA |
| 511 | KFKKFKKFKKFKKFKKFKKFKKFKKFKKFKKFKKFKKFKKFKKFKKFKKFKK |
| | FKKFKKFKKFK |
| 512 | KFKKFKKFKKFKKFKKFKKFKKFKKFKKFKKFKKFKKFKKFKKFKKFK |
| 513 | KFKKFKKFKKFKKFKKFKKFKKFKKFKKFKKFKKFK |
| 514 | KFKKFKKFKKFKKFKKFKKFKKFKKFKKFK |
| 515 | KFKKFKKFKKFKKFKKFKKFKKFKKFK |
| 516 | KFKKFKKFKKFKKFKKFKKFKKFK |
| 517 | KFKKFKKFKKFKKFKKFKKFK |
| 518 | KFKKFKKFKKFKKFKKFK |
| 519 | KFKKFKKFKKFKKFK |
| 520 | KKAKKKAKKKAKKKAKKKAKKKAKKKAK |
| 521 | KAAKKAAKKAAKKAAKKAAKKAAKKAAK |
| 522 | KFAKKFAKKFAKKFAKKFAKKFAKKFAK |
| 523 | KFFKKFFKKFFKKFFKKFFKKFFKKFFK |
| 524 | KFAFKFAFKFAFKFAFKFAFKFAFKFAF |
| 525 | LKKLLKKLLKKLLKKLLKKLLKKLLKKLLKKL |
| 526 | LKKLLKKLLKKLLKKLLKKLLKKLLKKL |
| 527 | LKKLLKKLLKKLLKKLLKKLLKKL |
| 528 | LKKLLKKLLKKLLKKLLKKL |
| 529 | KKFAKKFAKKFAKKFAKKFAKKFA |
| 530 | AKKFAKKFAKKFAKKFAKKFAKKF |
| 531 | FAKKFAKKFAKKFAKKFAKKFAKK |
| 532 | RFARRFARRFARRFARRFARRFARRFARRFAR |
| 533 | RFARRFARRFARRFARRFARRFARRFAR |
| 534 | RFARRFARRFARRFARRFARRFAR |
| 535 | KFAKKFAKKFAKKFAKKFAKKFAKKFAKKFAKKFAKKFAKKFAKKFAKKFA |
| | KKFAKKFAKKFAKKFAKKFAKKFAKKFAKKFAK |
| 536 | KFAKKFAKKFAKKFAKKFAKKFAKKFAKKFAKKFAKKFAKKFAKKFAKKFA |
| | KKFAKKFAKKFAKKFAK |
| 537 | KFAKKFAKKFAKKFAKKFAKKFAKKFAKKFAKKFAKKFAKKFAKKFAK |
| 538 | KFAKKFAKKFAKKFAKKFAKKFAKKFAKKFAK |
| 539 | KFAKKFAKKFAKKFAKKFAKKFAK |
| 540 | KFAKKFAKKFAKKFAKKFAK |
| 541 | KFAKKFAKKFAKKFAK |
| 542 | RIIRKIIHII |
| 543 | RIIRKIIHIIK |
| 544 | RRIIRKIIHII |
| 545 | NIRRIIRKIIHIIKKY |
| 546 | NLRRIIRKIIHIIKKY |
| 547 | RGLRALGRKIAHGVKAYG |
| 548 | KNLRRIIRKIIHIIKKYGPTILRIIRIIG |
| 549 | RGLRRLGRKIAHGVKKYGPTVLRIIRIA |
| 550 | KIKEKLKKIGQKIQGLL |
| 551 | KIKEKLKKIGQKIQG |
| 552 | RKFRNKIKEKLKKIG |
| 553 | LRKFRNKIKEKLKKIGQKIQG |
| 554 | LRKFRNKIKEKLKKIGQKI |
| 555 | RKRLRKFRNKIKEKLKKIGQKI |
| 556 | KRLRKFRNKIKEKLKKIG |
| 557 | GLRKRLRKFRNKIKEKLKKIG |
| 558 | GLRKRLRKFRNKIKEKLKKIGQKIQGLLPKLAPRTDY |
| 559 | RRIIRKIIHIIK |
| 560 | RRIIRKIIHIIKK |
| 561 | LRRIIRKIIHIIK |
| 562 | IRRIIRKIIHIIKK |
| 563 | LRRIIRKIIHIIKK |
| 564 | KNLRRIIRKIIHIIKKYG |
| 565 | KNIRRIIRKIIHIIKKYG |
| 566 | RGLRRLGRKIAHGVKKYG |
| 567 | LGRKIAHGVKKYGPTVLRII |
| 568 | KIAHGVKKYGPTVLRIIRIAG |
| 569 | RGLRRLGRKIAHGVKKYGPTVLRIIRIAG |
| 570 | HPHVCTSYYCSKFCGTAGCTRYGCRNLHRGKLCFCLHCSR |
| 571 | HSHACTSYWCGKFCGTASCTHYLCRVLHPGKMCACVHCSR |
| 572 | HXHXCTSYXCXKFCGTAXCTXYXCRXLHXGKXCXCXHCSR |
| 573 | MKATMLLAVVVAVFVAGTEAHPHVCTSYYCSKFCGTAGCTRYGCRNLHRGK |
| | LCFCLHCSRVKFPFGATQDAKSMNELEYTPIMKSMENLDNGMDML |
| 574 | MKATILLAVLVAVFVAGTEAHSHACTSYWCGKFCGTASCTHYLCRVLHPGK |
| | MCACVHCSRVNNPFRVNQVAKSINDLDYTPIMKSMENLDNGMDML |
| 575 | KWKLFKKIGIGAVLKVLTTGLPALKKTK |
| 576 | KWKLFKKIGIGAVLKVLTTGLPALIS |
| 577 | KKWWRRXXXGLKTAGPAIQSVLNK |
| 578 | KWKSFIKK |
| 579 | KKWWKX |
| 580 | KKWWRRX |
| 581 | KKWRKSFFKQVGSFDNSV |
| 582 | WKVFKSFIKKASSFAQSVLD |
| 583 | KKSFFKKLTSVASSVLS |
| 584 | KKWWKFIKKAVNSGTTGLQTLAS |
| 585 | KKWWKAKKFANSGPNALQTLAQ |
| 586 | KKWWKAQKAVNSGPNALQTLAQ |
| 587 | KKWWRRALQGLKTAGPAIQSVLNK |
| 588 | KKWWRRVLSGLKTAGPAIQSVLNK |
| 589 | KKWWRRALQALKNGPALSNV |
| 590 | KKWWRRVLKGLSSGPALSNV |
| 591 | KKWWRRVLSGLKTGPALSNV |
| 592 | KWKKFIKELQKVLKPGGLLSNIVTSL |
| 593 | KKKSFIKLLTSAKVSVLTTAKPLISS |
| 594 | KWKSFIKKLTSVLKKVVTTAKPLISS |
| 595 | KWKLFKKKGTGAVLTVLTTGLPALIS |
| 596 | KWKSFIKNLTKVLKKVVTTALPALIS |
| 597 | KWKSFIKKLTSVLKKVVTTALPALIS |
| 598 | KWKKFIKELQKVLAPGGLLSNIVTSL |
| 599 | KWKEFIKKLTTAVKKVLTTGLPALIS |
| 600 | KWKSFIKNLEKVLKKGPILANLVSIV |
| 601 | KWKSFIKNLEKVLKPGGLLSNIVTSL |
| 602 | KWKKFIKNLTKGGSKILTTGLPALIS |
| 603 | KWKSFIKNLTKGGSKILTTGLPALIS |
| 604 | KWKSFIKKLTSAAKKVVTTAKPLISS |
| 605 | KWKSFIKKLTTAVKKVLTTGLPALIS |
| 606 | RVVRVVRRWVRRVRRVWRRVVRVVRRWVRRVRRVWRRVVRVVRRWRVV |
| 607 | VRRVWRRVVRVVRRWVRRVRRVWRRVVRVVRRWVRR |
| 608 | RRWVRRVRRVWRRVVRVVRRWVRR |
| 609 | RVVRVVRRWVRR |
| 610 | RVVRVVRRVVRRVRRVVRRVVRVVRRVVRRVRRVVRRVVRVVRRVVRR |
| 611 | RRVVRRVRRVVRRVVRVVRRVVRRVRRVVRRVVRVVRRVVRR |
| 612 | VRRVVRRVVRVVRRVVRRVRRVVRRVVRVVRRVVRR |
| 613 | RRVVRRVRRVVRRVVRVVRRVVRR |
| 614 | RVVRVVRRVVRR |
| 615 | RWIRVVQRWCRAIRHIWRRIRQGLRRWLRVV |
| 616 | RVIRVVQRACRAIRHIVRRIRQGLRRILRVV |
| 617 | RVIRVVQRACRAIRHIVRRIRQGLRRIL |
| 618 | MQYNRR |
| 619 | FVNVVPTFGKKKGPNANS |
| 620 | TGRAKRR |
| 621 | AKVAKQEKKKKKTGRAKRRA |
| 622 | KVAKQEKKKKKTGRAKRR |
| 623 | KVAKQEKKKKKT |
| 624 | TGRAKRRMQYNRR |
| 625 | KVHGSLARAGKVRGQTPK |
| 626 | KVHGSLARAGKVRGQTPKVAKQEKKKKKTGRAKRRMQYNRRFVNVVPTFG |
| | KKKGPNANS |
| 627 | MKLNTTTTLALLLLLLLASSSLQVSMAGSDFCDGKCKVRCSKASRHDDCLKY |
| | CGVCCASCNCVPSGTAGNKDECPCYRDMTTGHGARKRPKCP |
| 628 | QSKDGPALEKWCGQKCEGRCKEAGMKDRCLKYCGICCKDCQCVPSGTYGNK |
| | HECACYRDKLSSKGTPKCP |
| 629 | SVSNLVQAARGGGKLKPQQCNSKCSYRCSATSHKKPCMFFCLKCCKKCLCVP |
| | PGTFGNKQTCPCYNNWKTKEGRPKCP |
| 630 | MAARSYSPIMVALSLLLLVTFSNVAEAYTRSGTLRPSDCKPKCTYRCSATSHK |
| | KPCMFFCQKCCAKCLCVPPGTYGNKQICPCYNSWKTKEGGPKCP |
| 631 | MAKEFFAAMILALIAISMLQTVVMAANEQGGHLYDNKSKYGSGSVKRYQCPS |
| | QCSRRCSQTQYHKPCMFFCQKCCRKCLCVPPGYYGNKAVCPCYNNWKTKEG |
| | GPKCP |
| 632 | MAKEFFAAMILALFAISLILQTVVMAANEQGGHLYDNKSKYGSGSVKSYQCPSQ |
| | CSRRCSQTQYHKPCMFFCQKCCRTCLCVPPGYYGNKAVCPCYNNWKTKEGG |
| | PKCP |
| 633 | MASNSILLLCIFLVVATKVFSYDEDLKTVVPAPAPPVKAPTLAPPVKSPSYPPG |
| | PVTTPTVPTPTVKVPPPPQSPVVKPPTPTVPPPTVKVPPPPQSPVVKPPTPTPTSP |
| | VVYPPPVAPSPPAPVVKSNKDCIPLCDYRCSLHSRKKLCMRACITCCDRCKCV |
| | PPGTYGNREKCGKCYTDMLTHGNKFKCP |
| 634 | MEKKRKTLLLLLLMAATLFCMPIVSYAVSSVNIQGHLTHSELVKGPNRRLLPF |
| | VDCGARCRVRCSLHSRPKICSRACGTCCFRCRCVPPGTYGNREMCGKCYTDM |
| | ITHGNKPKCP |
| 635 | MALSKLIIASLLASLLLLHFVDADQSAHAQTQGSLLQQIDCNGACAARCRLSS |
| | RPRLCQRACGTCCRRCNCVPPGTAGNQEVCPCYASLTTHGGKRKCP |
| 636 | MALRVLLVLGMLLMLCLVKVSSDPKIEEEILEAEEELQFPDNEPLIVRDANRRL |
| | MQDMDCGGLCKTRCSAHSRPNLCTRACGTCCVRCKCVPPGTSGNRELCGTC |
| | YTDMTTHGNKTKCP |
| 637 | MAPRVFLVLGMLLMVCLVKVSSDPKREEEILEEELHFPDNEPLIVRDGNRRLM |
| | QDIDCGGLCKTRCSAHSRPNLCTRACGTCCVRCKCVPPGTSGNRELCGTCYTD |
| | MTTHGNKTKCP |
| 638 | MMGILLLVCLAKVSSDVNMQKEEDEELRFPNHPLIVRDGNRRLMQDIDCGGL |
| | CKTRCSAHSRPNVCNRACGTCCVRCKCVPPGTSGNRELCGTCYTDMITHGNK |
| | TKCP |
| 639 | MAISKSTVVVVILCFILIQELGIYGEDPHMDAAKKIDCGGKCNSRCSKARRQK |
| | MCIRACNSCCKKCRCVPPGTSGNRDLCPCYARLTTHGGKLKCP |
| 640 | MKLVFGTLLLCSLLLSFSFLEPVIAYEDSSYCSNKCADRCSSAGVKDRCVKYC |
| | GICCAECKCVPSGTYGNKHECPCYRDKLNKKGKPKCP |
| 641 | MKLVFATLLLCSLLLSSSFLEPVIAYEDSSYCSNKCSDRCSSAGVKDRCLRYCG |
| | ICCAECKCVPSGTYGNKHQCPCYRDKLNKKGKPKCP |
| 642 | MKLEFANVLLLCLVLSSSFLEISMAGSPFCDSKCAQRCAKAGVQDRCLRFCGI |
| | CCEKCNCVPSGTYGNKDECPCYRDMKNSKGKDKCP |
| 643 | MKVAFAAVLLICLVLSSSLFEVSMAGSAFCSSKCSKRCSRAGMKDRCMKFCGI |
| | CCSKCNCVPSGTYGNKHECPCYRDMKNSKGKAKCP |
| 644 | MKVAFVAVLLICLVLSSSLFEVSMAGSAFCSSKCAKRCSRAGMKDRCTRFCGI |
| | CCSKCRCVPSGTYGNKHECPCYRDMKNSKGKPKCP |
| 645 | LRPWECSPKCAGRCSNTQYKKACLTFCNKCCAKCLCVPPGTYGNKGACPCY |
| | NNWKTKEGGPKCP |
| 646 | KDCVGACDARCSEHSHKKRCSRSCLTCCSACRCVPAGTAGNRETCGRCYTD |
| | WVSHNNMTKCP |
| 647 | MLLLALAAHHQAASDPPATHGGMRASGTRSLLQQQPPPPRLDCPKVCAGRCA |
| | NNWRKEMCNDKCNVCCQRCNCVPPGTGQDTRHICPCYATMTNPHNGKLKCP |
| 648 | MVTKVICFLVLASVLLAVAFPVSALRQQVKKGGGGEGGGGGSVSGSGGGNL |
| | NPWECSPKCGSRCSKTQYRKACLTLCNKCCAKCLCVPPGFYGNKGACPCYNN |
| | WKTREGGPKCP |
| 649 | MSKPSRCRAVQTQVALLLLLLVAASLLQAGDAASGFCAGKCAVRCGRSRAK |
| | RGACMKYCGLCCXECACVPTGRSGSRDECPCYRDMLTAGPRKRPKCP |
| 650 | MKPLPVTLALLALFLVASYQDLTVAADADADAAGAGDVGAVPVPDSVCEGK |
| | CKNRCSQKVAGRCMGLCMMCCGKCAGCVPSGPLAPKDECPCYRDMKSPKS |
| | GRPKCP |
| 651 | MKKLRTTTATTTLALILLLVLIAATSLRVAMAGSAFCDSKCGVRCSKAGRHD |
| | DCLKYCGICCAECNCVPSGTAGNKDECPCYRDKTTGHGARTRPKCP |
| 652 | MKKLRTTTLALLLLLVFLAASSLRAAMAGSAFCDGKCGVRCSKASRHDDCLK |
| | YCGICCAECNCVPSGTAGNKDECPCYRDKTTGHGARKRPKCP |
| 653 | MESKSPWSLRLLICCAAMVAIALLPQQGGQAACFVPTPGPAPAPPGSSATNTN |
| | ASSAAPRPAKPSAFPPPMYGGVTPGTGSLQPHECGGRCAERCSATAYQKPCLF |
| | FCRKCCAACLCVPPGTYGNKNTCPCYNNWKTKRGGPKCP |
| 654 | MAKASSRLLFSLSLVVLLLLVETTTSPHGQADAIDCGASCSYRCSKSGRPKMC |
| | LRACGTCCQRCGCVPPGTSGNEDVCPCYANMKTHDGQHKCP |
| 655 | MKAIPVALLLLVLVAAASSFKHLAEAADGGAVPDGVCDGKCRSRCSLKKAG |
| | RCMGLCMMCCGKCQGCVPSGPYASKDECPCYRDMKSPKNQRPKCP |
| 656 | MMTTMKKKKQQQQLLLLSLMFLVAVTAAAVAADPHPQQVQVQQQQQAQM |
| | RINRATRSLLPQPPPKLDCPSTCSVRCGNNWKNQMCNKMCNVCCNKCSCVPP |
| | GTGQDTRHLCPCYDTMLNPHTGKLKCP |
| 657 | MAVAKPPLQTAAVLLLLLLVVAAASWLQTVDAASGFCSSKCSVRCGRAASA |
| | RARGACMRSCGLCCEECNCVPTRPPRDVNECPCYRDMLTAGPRKRPKCP |
| 658 | MAPSKLAVVVALVASLLLLTTSNTKLGLFVLGQAAPGAYPPRAPPPHQIVDLA |
| | KDCGGACDVRCGAHSRKNICTRACLKCCGVCRCVPAGTAGNQQTCGKCYTD |
| | WTTHGNKTKCP |
| 659 | MKLQATARVAGLLFLVLLLALPSLRVSMAGSGFCDGKCAVRCSKASRHDDCL |
| | KYCGICCATCNCVPSGTAGNKDECPCYRDMTTGHGNRTRPKCP |
| 660 | MVTKVICFLVLASVLLAVAFPVSALRQQVKKGGGGEGGGGGSVSGSGGGNL |
| | NPWECSPKCGSRCSKTQYRKACLTLCNKCCAKCLCVPPGFYGNKGACPCYNN |
| | WKTKEGGPKCP |
| 661 | KWKGIGAVLKVLTTGX |
| 662 | KWKLFKKIGIGAVLKVLTTGLPALIX |
| 663 | RLCRVVIRVCR |
| 664 | CYCRIPACIAGERRYGTCIYQGRLWAFCC |
| 665 | MPRWRLFRRIDRVGKQIKQGILRAGPAIALVGDARAVG |
| 666 | KWKVFKKIEKMGRNIRNGIVKAGPAIAVLGEAKALG |
| 667 | KWKLFKKIEKVGQNIRDGIIKAGPAVAVVGQATQIAK |
| 668 | GIGKFLKKAKKFGKAFVKILKK |
| 669 | GIGKFLKKAKKFGKAFVKILKX |
| 670 | MNLAKGKEESLDSDLYAELRCMCIKTTSGIHPKNIQSLEVIGKGTHCNQVEVIA |
| | TLKDGRKICLDPDAPRIKKIVQKKLAGDESAD |
| 671 | MGHHHHHHHHHHSSGHIEGRHMYAELRCMCIKTTSGIHPKNIQSLEVIGKGTH |
| | CNQVEVIATLKDGRKICLDPDAPRIKKIVQKKLAGDESAI |
| 672 | MGHHHHHHHHHHSSGHIEGRHMYLRCMCIKTTSGIHPKNIQSLEVIGKGTHC |
| | NQVEVIATLKDGRKICLDPDAPRIKKIVQKKLAGDESAD |
| 673 | MNLAKGKEESLDSDLYAELRCMCIKTTSGIHPKNIQSLEVIGKGTHCNQVEVIA |
| | TLKDGRKICLDPDAPRIKKIVQKKLAGDES |
| 674 | MAELRCMCIKTTSGIHPKNIQSLEVIGKGTHCNQVEVIATLKDGRKICLDPDAP |
| | RIKKIVQKKLAGDES |
| 675 | AELRCMCIKTTSGIHPKNIQSLEVIGKGTHCNQVEVIATLKDGRKICLDPDAPRI |
| | KKIVQKKLAGDESAD |
| 676 | LRCMCIKTTSGIHPKNIQSLEVIGKGTHCNQVEVIATLKDGRKICLDPDAPRIKK |
| | IVQKKLAGDESAD |
| 677 | NLAKGKEESLDSDLYAELRCMCIKTTSGIHPKNIQSLEVIGKGTHCNQVEVIAT |
| | LKDGRKICLDPDAPRIKKIVQKKLAGDES |
| 678 | AGDES |
| 679 | YAELR |
| 680 | AELRCMCIKTTSGIHPKNIQSLEVIGKGTHCNQVEVIATLKDGRKICLDPDAPRI |
| | KKIVQKKLAGDES |
| 681 | AELR |
| 682 | NLAKGKEESLDSDLYAELRCMCIKTTSGIHPKNIQSLEVIGKGTHCNQVEVIAT |
| | LKDGRKICLDPDAPRIKKIVQKKLAGDESAD |
| 683 | RVIEVVQGACRAIRHIPRRIRQGLERIL |
| 684 | RVVRVVRRWVRRVRRVWRRVVRVVRRWVRRVRRVWRRVVRVVRRWVRR |
| 685 | WRWWKVVWRWVKW |
| 686 | WRWWKVWRWVKW |
| 687 | ILRWPWWPWRRK |
| 688 | RLARIVVIRVAR |
| 689 | GKPRPYSPIPTSPRPIRY |
| 690 | KWKLFIKKLTPAVKKVLLTGLPALIS |
| 691 | KWKSFIKKLTSAAKKVLTTGLPALIS |
| 692 | KWKLFKKIGIGAVLKVLTTGLPALKLTK |
| 693 | KKWWRRALQALKNGLPALIS |
| 694 | WRWWKVAWRWVKW |
| 695 | WRWWKPKWRWPKW |
| 696 | RRIWKPKWRLPKR |
| 697 | ILRWPWWPWRRA |
| 698 | ILRWPWWPWRAK |
| 699 | ILRWPWWPWARK |
| 700 | ILRWPWWPARRK |
| 701 | ILRWPWWAWRRK |
| 702 | ILRWPWAPWRRK |
| 703 | ILRWPAWPWRRK |
| 704 | ILRWAWWPWRRK |
| 705 | ILRAPWWPWRRK |
| 706 | ILAWPWWPWRRK |
| 707 | IARWPWWPWRRK |
| 708 | ALRWPWWPWRRK |
| 709 | RWWWPWRRK |
| 710 | WPWWPWRRK |
| 711 | LRWPWWPW |
| 712 | LRWWWPWRRK |
| 713 | LWPWWPWRRK |
| 714 | ILKKWPWWPWR |
| 715 | ILKKWPWWPWK |
| 716 | ILKKWPWWPWRR |
| 717 | ILKKWPWWPRRK |
| 718 | ILKKWPWWWRRK |
| 719 | ILKKWWWPWRRK |
| 720 | ILKKPWWPWRRK |
| 721 | IKKWPWWPWRRK |
| 722 | WVRLWWRRVW |
| 723 | RLWVWWVWRR |
| 724 | RLVVWVVWRR |
| 725 | RLFVWWVFRR |
| 726 | RLVVWWVVRR |
| 727 | RLWWVVWWRR |
| 728 | RLGGGWVWWVWRR |
| 729 | RLWVWWVWRRK |
| 730 | ILRWWVWWVWWRRK |
| 731 | ILRRWVWWVWRRK |
| 732 | KRRWVWWVWRLI |
| 733 | ILRWVWWVWRRK |
| 734 | ILKKWVWWPWRRK |
| 735 | ILKKWPWWVWRRK |
| 736 | ILKKWVWWVWRRK |
| 737 | ILKKWPWWPWRRK |
| 738 | CLRWPWWPWRRK |
| 739 | WRIWKPKWRLPKW |
| 740 | ILKKWPWWWRK |
| 741 | ILKKWWWPWRK |
| 742 | ILKKWPWWPWRRIM |
| 743 | ILKKWPWWPWRRKM |
| 744 | ILKKWPW |
| 745 | WWPWRRK |
| 746 | ILKKWPWWPWRRIMILKKAGS |
| 747 | ILKKWPWWPWRRMILKKAGS |
| 748 | ILKKWPWWPWRRKMILKKAGS |
| 749 | PWWPWRRK |
| 750 | LKKWPWWPWRRK |
| 751 | WWKKWPWWPWRRK |
| 752 | ILKKWPWWAWRRK |
| 753 | ILKKWAWWPWRRK |
| 754 | ILKWVWWVWRRK |
| 755 | KRKWPWWPWRLI |
| 756 | ILRWPWWPWRRKILMRWPWWPWRRKMAA |
| 757 | ILRWPWRRWPWRRK |
| 758 | ILRWPWWPWRRKDMILKKAGS |
| 759 | ILRWPWWPWRRKMILKKAGS |
| 760 | ILRWPWWPWRRKIMILKKAGS |
| 761 | ILKKWPWWPWKKK |
| 762 | ILRRWPWWPWRRR |
| 763 | ILWPWWPWRRK |
| 764 | KRRWPWWPWRLI |
| 765 | ILKWPWWPWRK |
| 766 | ILKKWPWWPWRK |
| 767 | ILKWPWWPWRRK |
| 768 | ILRRWPWWPWRK |
| 769 | ILRRWPWWPWRRK |
| 770 | WWRWPWWPWRRK |
| 771 | ILRWPWWPWWPWRRK |
| 772 | ILRYVYYVYRRK |
| 773 | ILKKFPFWPWRRK |
| 774 | ILKKFPWFPWRRK |
| 775 | ILKKYPWYPWRRK |
| 776 | ILKKWPWPWRRK |
| 777 | ILKKYPYYPYRRK |
| 778 | ILKKIPIIPIRRK |
| 779 | ILKKFPFLPFRRK |
| 780 | KRRWPWWPWKKLI |
| 781 | KKAAAKAAAAAKAAWAAKAAAKKKK |
| 782 | DPVTCLKSGAICHPVFCPRRYKQIGTCGLPGTKCCK |
| 783 | ALWKTMLKKLGTMALHAGKAALGAAADTISQTQ |
| 784 | SIGSAFKKAAHVGKHVGKAALGAAARRRK |
| 785 | ALWKTMLKKAAHVGKHVGKAALGAAARRRK |
| 786 | GWGSFFKKAAHVGKHVGKAALGAAARRRK |
| 787 | SIGSAFKKAAHVGKHVGKAALTHYL |
| 788 | ALWKTMLKKAAHVGKHVGKAALTHYL |
| 789 | KGWGSFFKKAAHVGKHVGKAALTHYL |
| 790 | KKWKKFIKKIGIGAVLTTPGAKK |
| 791 | KWKKFIKKIGIGAVLKVLTTGLPALKLTKK |
| 792 | KWKSFIKKLTSAAKKVTTAAKPLTK |
| 793 | KLWKLFKKIGIGAVLKVLKVLTTGLPALKLTLK |
| 794 | KWKFKKIGIGAVLKVLKVLTTGLPALKLTLK |
| 795 | KLFKKIGIGAVLKVLKVLTTGLPALKLTLK |
| 796 | KWKLFKKIGIGAVLKVLKVLTTGLPALKLTLK |
| 797 | KWKKFIKSLTKSAAKTVVKTAKKPLIV |
| 798 | KWKSFIKKLTKAAKKVVTTAKKPLIV |
| 799 | KWKSFIKKLTSAAKKVVTTAKPLALIS |
| 800 | HIFR |
| 801 | FFRHLFRGAKAIFRGARQGXRAHKVVSRYRNRDVPETDNNQEEP |
| 802 | FFHHIFRGIVHVGKTIHRLVTG |
| 803 | FIHHIFRGIVHAGRSIGRFLTG |
| 804 | RRWCFRVCYRGXFCYRKCR |
| 805 | RRWCXRVCYXGFCYRKCR |
| 806 | RXWCXXXCYRGFCXXXCR |
| 807 | RRWCFXVCXRGXCYXXCRX |
| 808 | XRWCFRVCYXGXCXXXCR |
| 809 | WCFXVCXRGXCRXKCRR |
| 810 | RRWCFRVCYRGRFCYRKCR |
| 811 | RRWCRRVCYAGFCYRKCR |
| 812 | RVWCRYRCYRGFCRRFCR |
| 813 | RVWCRRRCYRGFCRYFCR |
| 814 | RRWCFIVCRRGRCYVACRR |
| 815 | RRWCFIVCRRGACYRRCR |
| 816 | RRWCFRVCYRGFCRYFCR |
| 817 | RRWCFRVCYKGFCRYKCR |
| 818 | FRWCFRVCYKGRCRYKCR |
| 819 | WCFAVCYRGRCRRKCRR |
| 820 | WCFAVCRRGRCRYKCRR |
| 821 | ALYKKKIIKKLLES |
| 822 | YAERLCXCSIKAEV |
| 823 | ANLIATKKNGRKLCL |
| 824 | KFDKSKLKKTETQEKNPL |
| 825 | EGVNDNEEGFFSA |
| 826 | ADSGEGDFLAEGGGVRKLIK |
| 827 | ADSGEGDFLAEGGGVR |
| 828 | SWVQEYVYDLEL |
| 829 | EWVQKYVSDLELSAWKKILK |
| 830 | KWVREYINSLEMSKKGLAG |
| 831 | PRIKKIVQKKLAG |
| 832 | KWKWWWWWKWK |
| 833 | KGYFYFLFKFK |
| 834 | KFKHYFFWKYK |
| 835 | YAERLCTCSIKAEV |
| 836 | SAIHPSSILKLEVICIGVLQ |
| 837 | RFEKSKIK |
| 838 | ATKKNGRKLCLDLQAAL |
| 839 | ALYKRLFKKLKKF |
| 840 | GLYKRLFKKLLKS |
| 841 | ALYKKLFKKLLKR |
| 842 | KLYKKWKNKLKRSLKRLG |
| 843 | ALYKKWKNKLLKS |
| 844 | KLYKKWKKKLLKLK |
| 845 | ARYRKFRNKILRS |
| 846 | ARYRKFKNKILKS |
| 847 | KLYRKFKNKLLKLK |
| 848 | ARYKKFKKKLLKS |
| 849 | ALYKKFKKKLLKSLKRLG |
| 850 | SDDPKESEGDLHCVCVKTTSLVRPGHITNLELIKAGGHCPTANLIATKKNGRK |
| | LCLDLQAALYKKKIIKKLLES |
| 851 | SDDPKESEGDLHCVCVKTTSLVRPRHITNLELIKAGGHCPTANLIATKKNGRK |
| | LCLDLQAALYKKKIIKKLLES |
| 852 | RHFCGGALIHARYVMTAASS |
| 853 | RHYCGGALIHARFVMTAASS |
| 854 | RHFCGGALIHARFAMTAASS |
| 855 | RHFCGGALIHARFIMTAASS |
| 856 | RHFCGGALIHARFLMTAASS |
| 857 | RHFCAAALIHARFVMTAASS |
| 858 | RHFCGAALIHARFVMTAASS |
| 859 | RHFCAGALIHARFVMTAASS |
| 860 | RHFSGGALIHARYVMTAASC |
| 861 | RHYSGGALIHARFVMTAASC |
| 862 | RHFSGGALIHARFAMTAASC |
| 863 | RHFSGGALIHARFIMTAASC |
| 864 | RHFSGGALIHARFLMTAASC |
| 865 | RHFSAAALIHARFVMTAASC |
| 866 | RHFSGAALIHARFVMTAASC |
| 867 | RHFSAGALIHARFVMTAASC |
| 868 | NQGRHFCGGALIHARFVMTAASCYQ |
| 869 | NQGRHYCGGALIHARFVMTAASCFQ |
| 870 | NQGRHFCGGALIHARFAMTAASCFQ |
| 871 | NQGRHFCGGALIHARFIMTAASCFQ |
| 872 | NQGRHFCGGALIHARFLMTAASCFQ |
| 873 | NQGRHFCGGALIHARFVMTAATCFQ |
| 874 | NQGRHFCAAALIHARFVMTAASSFQ |
| 875 | NQGRHFCGAALIHARFVMTAASSFQ |
| 876 | NQGRHFCAGALIHARFVMTAASSFQ |
| 877 | NQGRHFSAAALIHARFVMTAASCFQ |
| 878 | NQGRHFSGAALIHARFVMTAASCFQ |
| 879 | NQGRHFSAGALIHARFVMTAASCFQ |
| 880 | NQGRHFCAAALIHARFVMTAASCFQ |
| 881 | NQGRHFCGAALIHARFVMTAASCFQ |
| 882 | NQGRHFCAGALIHARFVMTAASCFQ |
| 883 | RHFCGGALIHARFVMTAAKS |
| 884 | RHFCGGALIHARFVMTAARS |
| 885 | RHFCGGALIHARFVMTAAHS |
| 886 | RHFSGGALIHARFVMTAAKC |
| 887 | RHFSGGALIHARFVMTAARC |
| 888 | RHFSGGALIHARFVMTAAHC |
| 889 | NQGRHFCGGALIHARFVMTAAKSFQ |
| 890 | NQGRHFCGGALIHARFVMTAARSFQ |
| 891 | NQGRHFCGGALIHARFVMTAAHSFQ |
| 892 | NQGRHFSGGALIHARFVMTAAKCFQ |
| 893 | NQGRHFSGGALIHARFVMTAARCFQ |
| 894 | NQGRHFSGGALIHARFVMTAAHCFQ |
| 895 | RHFCGGALIHARFVMTAAKC |
| 896 | RHFCGGALIHARFVMTAARC |
| 897 | RHFCGGALIHARFVMTAAHC |
| 898 | NQGRHFCGGALIHARFVMTAAKCFQ |
| 899 | NQGRHFCGGALIHARFVMTAARCFQ |
| 900 | RHFSGGALIHARFVMTAASS |
| 901 | NQGRHFSGGALIHARFVMTAASSFQ |
| 902 | RHFCGGALIHARFVMTAASS |
| 903 | NQGRHFCGGALIHARFVMTAASSFQ |
| 904 | RHFSGGALIHARFVMTAASC |
| 905 | NQGRHFSGGALIHARFVMTAASCFQ |
| 906 | RHFCGGALIHARFVMTAASC |
| 907 | NQGRHFCGGALIHARFVMTAASCFQ |
| 908 | MRTSYLLLFTLCLLLSEMASGGNFLTGLGHRSDHYNCVSSGGQCLYSACPIFT |
| | KIQGTCYRGKAKCCK |
| 909 | YQVIQSWEHWRE |
| 910 | YKIIQQWFHWRRV |
| 911 | MKFACALLALLGLATSCSFIVFRSEWRALPSECSSRLGHPVRYVVISHTRGSFC |
| | NSFDSCEQQARNVQHYHKNELEWCDVAYNIKEDHTEPIYNPMSIGITFMGNF |
| | MDRVRKAALRAALNLLESGVSRGFLRSNYEVKGH |
| 912 | MSRRYTPLAWVLLALLGLGAAQDCGSIVSRGKWGALASKCSQRLRQPVRYV |
| | VVSHTAGSVCNTPASCQRQAQNVQYYHVRERGWCDVGYNFKIGEDGKVYE |
| | GRGWNTKGDHSGPTWNPIAIGISFMGNYMHRVFFASALRAAQSLLACGAARG |
| | YLTPNYEVKGHRDVQQTLSPGDELYKIIQQWPHYRRV |
| 913 | NHRSCYRNKGVCAPARCPRNMRQIGTCHGPPVKCCR |
| 914 | SRRSCHRNKGVCALTRCPRNMRQIGTCFGPPVKCCR |
| 915 | MRVLYLLFSFLFIFLMPLPGVFGGIGDPVTCLKSGAICHPVFCPRRYKQIGTCGL |
| | PGTKCCKKP |
| 916 | MRVLYLLFSFLFIFLMPLPGVFGGISDPVTCLKSGAICHPVFCPRRYKQIGTCGL |
| | PGTKCCKKP |
| 917 | MRLHHLLLALLFLVLSAGSGFTQGVRNSQSCRRNKGICVPIRCPGSMRQIGTCL |
| | GAQVKCCRRK |
| 918 | MRLVVCLVFLASFALVCQGQVYKGGYTRPIPRPPFVRPVPGGPIGPYNGCPVS |
| | CRGISFSQARSCCSRLGRCCHVGKGYSG |
| 919 | MRLVVCLVFLASFALVCQGQVYKGGYTRPVPRPPPFVRPLPGGPIGPYNGCPV |
| | SCRGISFSQARSCCSRLGRCCHVGKGYSG |
| 920 | EVYKGGYTRPIPRPPPFVRPLPGGPIGPYNGCPVSCRGISFSQARSCCSRLGRCC |
| | HVGKGYS |
| 921 | YRGGYTGPIPRPPPIGRPPLRLVVCACYRLSVSDARNCCIKFGSCCHLVK |
| 922 | MRLVVCLVFLASFALVCQGQVYKGGYTRPIPRPPPFVRPLPGGPIGPYNGCPVS |
| | CRGISFSQARSCCSRLGRCCHVGKG |
| 923 | MRLVVCLVFLASFALVCQGEAYRGGYTGPIPRPPPIGRPPFRPVCNACYRLSVS |
| | DARNCCIKFGSCCHLVKG |
| 924 | LLASDEEIQDVSGTWYLKA |
| 925 | SSSKEENRIIPGGI |
| 926 | GMASKGAIAGKIAKVALKAL |
| 927 | KRKFHEKHHSHRGY |
| 928 | DSHAKRHHGYKRKFHEKHHSHRGY |
| 929 | KRLFKKLKFSLRKY |
| 930 | KRLFKELKFSLRKY |
| 931 | YGRHSHHKEHFKRKC |
| 932 | KRKFHEKHHSHRGYC |
| 933 | KRLFKELLFSLRKY |
| 934 | KRLFKELKFSLRKY |
| 935 | LLLFLLKKRKKRKY |
| 936 | KRLFKKLLFSLRKY |
| 937 | KRLFKELLKSLRKY |
| 938 | KRLFKELKKSLRKY |
| 939 | IKISGKWKAQKRFLKMSGC |
| 940 | GKWKAFKKAAKKFAKKCS |
| 941 | GKWKLFKKAAKKFLKKCS |
| 942 | GKLKKKWKAAKKFLKKCS |
| 943 | CGGGGGGGGGKWKAFKKAFKKFAKILACG |
| 944 | GKWKLFKKAFKKFLKILAG |
| 945 | GKWKAFKKAFKKFAKILAG |
| 946 | GKWKLFKKAFKKFLKILAC |
| 947 | GRLRKKWKAFKKFLKILAC |
| 948 | IGKFLHSAKKFAKAFAFVAEIMNS |
| 949 | GIGKFLHSAKKFAKAFVAEIMNS |
| 950 | GIGKFLHAAKKFAKAFVAEIMNS |
| 951 | IGKFLHAAKKFAKAFVAEIMNS |
| 952 | GIGKFLHSAKKFGKAFVGEIMNSK |
| 953 | QKYYCRVRGGRCAVLSCLPKEEQIGKCSTRGRKCCR |
| 954 | NQGRHFCGGALIHARYVMTAASCFQ |
| 955 | RRLRRIIRKGIRIIKKYG |
| 956 | KRLRRIIRKGIHIIKKYG |
| 957 | KNLRRIIRKGIRIIKKYG |
| 958 | KNLRRIIRKGIHIIKKYG |
| 959 | KNLRRIIRKIAHIIKKYG |
| 960 | KNLRRIIRKIDHIIKKYG |
| 961 | KNLRRIIRKIEHIIKKYG |
| 962 | KNLRRIIRKISHIIKKYG |
| 963 | KNLRRIIRKITHIIKKYG |
| 964 | KNLRRIIRKIGHIIKKYG |
| 965 | KNLRRIIRKAIHIIKKYG |
| 966 | KNLRRIIRKDIHIIKKYG |
| 967 | KNLRRIIRKEIHIIKKYG |
| 968 | KNLRRIIRKSIHIIKKYG |
| 969 | KNLRRIIRKTIHIIKKYG |
| 970 | KNLRRIARKIIHIIKKYG |
| 971 | KNLRRIDRKIIHIIKKYG |
| 972 | KNLRRIERKIIHIIKKYG |
| 973 | KNLRRISRKIIHIIKKYG |
| 974 | KNLRRITRKIIHIIKKYG |
| 975 | KNLRRIGRKIIHIIKKYG |
| 976 | KNLRRAIRKIIHIIKKYG |
| 977 | KNLRRDIRKIIHIIKKYG |
| 978 | KNLRREIRKIIHIIKKYG |
| 979 | KNLRRSIRKIIHIIKKYG |
| 980 | KNLRRTIRKIIHIIKKYG |
| 981 | KNLRRGIRKIIHIIKKYG |
| 982 | MRLHHLLLALLFLVLSAWSGFTQGVGNPVSCVRNKGICVPIRCPGSMKQIGTC |
| | VGRAVKCCRKK |
| 983 | NSQSCRRNKGICVPIRCPGSMRQIGTCLGAQVKCCR |
| 984 | MKTHYFLLVMICFLFSQMEPGVGILTSLGRRTDQYKCLQHGGFCLRSSCPSNT |
| | KLQGTCKPDKPNCCKS |
| 985 | DHYNCVSSGGQCLYSACPIFTKIQGTCYRGKAKCCK |
| 986 | MLLLLVENHAEIVVSTVEASAPQPHKNTTHTLSHAPAPQPHKNTKSPVPNLQH |
| | GITEGSLKPQECGPRCTARCSNTQYKKPCLFFCQKCCAKCLCVPPGTYGNKQV |
| | CPCYNNWKTKRGGPKCP |
| 987 | MALRELLMMGILLLVCLAKVSSDVNMQKEEDEELRFPNHPLIVRDGNRRLMQ |
| | DIDCGGLCKTRCSAHSRPNVCNRACGTCCVRCKCVPPGTSGNRELCGTCYTD |
| | MITHGNKTKCP |
| 988 | MAISKSTVVVVILCFILIQELGIYGEDPHMDAAKKIDCGGKCNSRCSKARRQK |
| | MCIRACNSCCKKCRCVPPGTSGNRDLCPCYARLTTHGGKLKCP |
| 989 | MKLVFGTLLLCSLLLSFSFLEPVIAYEDSSYCSNKCADRCSSAGVKDRCVKYC |
| | GICCAECKCVPSGTYGNKHECPCYRDKLNKKGKPKCP |
| 990 | MKVAFAAVLLICLVLSSSLELVSMAGSAFCSSKCSKRCSRAGMKDRCMKFCGI |
| | CCSKCNCVPSGTYGNKHECPCYRDMKNSKGKAKCP |
| 991 | MKVAFVAVLLICLVLSSSLELVSMAGSAFCSSKCAKRCSRAGMKDRCTRFCGI |
| | CCSKCRCVPSGTYGNKHECPCYRDMKNSKGKPKCP |
| 992 | MAGGRGRGGGGGGGVAGGGNLRPWECSPKCAGRCSNTQYKKACLTFCNKC |
| | CAKCLCVPPGTYGNKGACPCYNNWKTKEGGPKCP |
| 993 | MESKSPWSLRLLICCAAMVAIALLPQQGGQAACFVPTPGPAPAPPGSSATNTN |
| | ASSAAPRPAKPSAFPPPMYGGVTPGTGSLQPHECGGRCAERCSATAYQKPCLF |
| | FCRKCCAACLCVPPGTYGNKNTCPCYNNWKTKRGGPKCP |
| 994 | MASRNKAAALLLCFLFLAAVAASAAEMIAGSGIGDGEGEELDKGGGGGGGH |
| | HKHEGYKNKDGKGNLKPSQCGGECRRRCSKTHHKKPCLFFCNKCCAKCLCV |
| | PPGTYGNKETCPCYNNWKTKKGGPKCP |
| 995 | PTHG |
| 996 | PVPMR |
| 997 | NGGVCIPIR |
| 998 | QIGTCFGRPVL |
| 999 | EGVRSYLSCWGNRGICLLNRCPGRMRQIGTCLAPRVKCCR |
| 1000 | EGVRNFVTCRINRGFCVPIRCPGHRRQIGTCLGPQIKCCR |
| 1001 | EGVRNFVTCRINRGFCVPIRCPGHRRQIGTCLGPRIKCCR |
| 1002 | EGVRNHVTCRIYGGFCVPIRCPGRTRQIGTCFGRPVKCCRRW |
| 1003 | EVVRNPQSCRWNMGVCIPISCPGNMRQIGTCFGPRVPCCR |
| 1004 | ERVRNPQSCRWNMGVCIPFLCRVGMRQIGTCFGPRVPCCRR |
| 1005 | EGVRNHVTCRINRGFCVPIRCPGRTRQIGTCFGPRIKCCRSW |
| 1006 | DFASCHTNGGICLPNRCPGHMIQIGICFRPRVLCCRSW |
| 1007 | ILKKWPWWPWPPFFRRK |
| 1008 | ILKKWPWWPWPPRRK |
| 1009 | ILKKWPWWPWRRWWK |
| 1010 | ILKKWPWWPWRWWRR |
| 1011 | ILKKWPWWPWWPWRRK |
| 1012 | FFKKFPFFPFKKK |
| 1013 | FFKKFPFFPFRRK |
| 1014 | FFKKWPWWPWRRK |
| 1015 | ILKKFPLLPFKKK |
| 1016 | ILKKWPWWRWRR |
| 1017 | ILPWKWPPWPPWPWRR |
| 1018 | ILPWKWFFPPWPWRR |
| 1019 | IKWPWYVWL |
| 1020 | ILPWKWPWYVRR |
| 1021 | ILKKWPWWPWKWKK |
| 1022 | ILKKWPWWPWKRR |
| 1023 | TLPCLWPWWPWSI |
| 1024 | IVPWKWTLWPWRR |
| 1025 | ILPWICPWRPSKAN |
| 1026 | ILPWKWPWWPWWKKPWRR |
| 1027 | ILPWKWPWWPWWPWRR |
| 1028 | ILPWKWPWRR |
| 1029 | PWKWPWWPWRR |
| 1030 | ILPWKWPWWPWKKWK |
| 1031 | ILPWKWPWWPWRRWR |
| 1032 | ILPWKWPWWPWRKWR |
| 1033 | ILPWKKWPWWRWRR |
| 1034 | ILKPWKWPWWPWRR |
| 1035 | ILKPWKWPWWPWRRKK |
| 1036 | NQGRHFCGGALIHARFVMTAAHCFQ |
| 1037 | MKTIILILLILGLGIDAKSLEESKADEEKFLRFIGSVIHGIGHLVHHIGVALGDDQ |
| | QDNGKFYGYYAEDNGKHWYDTGDQ |
| 1038 | MKTTILILLILGLGINAKSLEERKSEEEKLFKLLGKIIHHVGNFVHGFSHVFGDD |
| | QQDNGKFYGYYAEDNGKHWYDTGDQ |
| 1039 | MKTTILILLILGLGINAKSLEERKSEEEKAFKLLGRIIHHVGNFVYGFSHVFGDD |
| | QQDNGKFYGHYAEDNGKHWYDTGDQ |
| 1040 | MKTTILILLILGLGINAKSLEERKSEEEKVFHLLGKIIHHVGNFVYGFSHVFGDD |
| | QQDNGKFYGHYAEDNGKHWYDTGDQ |
| 1041 | MKTTILILLILGLGINAKSLEERKSEEEKVFQFLGKIIHHVGNFVHGFSHVFGDD |
| | QQDNGKFYGHYAEDNGKHWYDTGDQ |
| 1042 | RRRFPWWWPFLRRR |
| 1043 | RSGRGECRRQCLRRHEGQPWETQECMRRCRRRGG |
| 1044 | QIGTCFGRPVK |
| 1045 | FTQGVRNSQSCRRNKGICVPIRCPGSMRQIGTCLGAQVKCCRRK |
| 1046 | MGECVRGRCPSGMCCSQFGYCGKGPKYCG |
| 1047 | SRAAGLAARLARLAL |
| 1048 | MAARAAGLAARLAALALRAL |
| 1049 | MAARAAGLAARLAALALRA |
| 1050 | MAARAAGLAARLAALALR |
| 1051 | MASRAAGLARRLARLARRAL |
| 1052 | MASRAAGLARRLARLARRA |
| 1053 | MASRAAGLARRLARLARR |
| 1054 | MVSRAAGLAARLARLALRAL |
| 1055 | MVSRAAGLAARLARLALRA |
| 1056 | MVSRAAGLAARLARLALR |
| 1057 | ASRAAGLAARLARLALR |
| 1058 | MASRAAGLAARLARLALRAL |
| 1059 | MASRAAGLAARLARLALRA |
| 1060 | MASRAAGLAARLARLALR |
| 1061 | HPAFDRK |
| 1062 | HPAYDDK |
| 1063 | HPDYNAT |
| 1064 | HPDYNPD |
| 1065 | HPDYNPK |
| 1066 | YPCYDEY |
| 1067 | HPDYNQR |
| 1068 | HPAYNAK |
| 1069 | YPCYDPA |
| 1070 | HPQYNPR |
| 1071 | HPQYNPK |
| 1072 | GIGKFLHSAKKFKAFVGEIMN |
| 1073 | AAGTTCVTTGWGLTRYTNAN |
| 1074 | PHGTQCLAMGWGRVGAHPPP |
| 1075 | GNGVQCLAMGWGLLGRNRGI |
| 1076 | EAQTRCQVAGWGSQSRSGGR |
| 1077 | KPQDVCYVAGWGRMAPMGKY |
| 1078 | KPGQTCSVAGWGQTAPLGKS |
| 1079 | IIGGRESRPHSRPYMAYLQIQSPAGQSRCGGFLVREDFVLTAAHCWGSNINVTL |
| | GAHNIDRRENTQQHITARRAIRHPQYNQRTIQNDIMLLQLSRRVRRNRNVNPV |
| | ALPRAQEGLRPGTLCTVAGWGRVSMRRGTDTLREVQLRVQRDRQCLRIFGSY |
| | DPRRQICVGDRRERKAAFKGDSGGPLLCNNVAHGIVSYGKSSGVPPEVFTRVS |
| | SFLPWIRTTMR |
| 1080 | WGRVSMRRGT |
| 1081 | CTVAGWGRVSMRRGT |
| 1082 | RPGLTLCTVAGWG |
| 1083 | HPLYNQR |
| 1084 | HPEYNQR |
| 1085 | HPNYNQR |
| 1086 | HPQFNQR |
| 1087 | HPQKNTY |
| 1088 | HPQANQR |
| 1089 | HHQYNQR |
| 1090 | HPQYNPQ |
| 1091 | IIGGV |
| 1092 | IIGGH |
| 1093 | APQYNQR |
| 1094 | GKSSGVPPEVFTRFVSSFLPWIRTTMR |
| 1095 | FKGDSGGPLLCNNVAHGIVSY |
| 1096 | GSYDPRRQICVGDRRERKAA |
| 1097 | DTLREVQLRVQRDRQCLRIF |
| 1098 | RPGTLCTVAGWGRVSMRRGT |
| 1099 | RVRRNRNVNPVALPRAQEGL |
| 1100 | HPQYNQRTIQNDIMLLQLSR |
| 1101 | RRENTQQHITARRAIRHPQY |
| 1102 | TAAHCWGSNINVTLGAHNIQ |
| 1103 | QSPAGQSRCGGFLVREDFVL |
| 1104 | IIGGRESRPHSRPYMAYLQI |
| 1105 | RHPQYNQR |
| 1106 | HPQYNQ |
| 1107 | HAQYNQR |
| 1108 | HPQYNAR |
| 1109 | HPQYNQA |
| 1110 | HPQYAQR |
| 1111 | HPAYNQR |
| 1112 | HPAYNPR |
| 1113 | HPAYNPK |
| 1114 | HPQYNQR |
| 1115 | IVGGR |
| 1116 | IIGGR |
| 1117 | GELKKAWRKVKHAGRRVLDTAKGVGRHYVNNWLNRYR |
| 1118 | RVIEVVQGAYRAIRHIPRRIRQGLERIL |
| 1119 | YHELRDLLLIVTRIVELLGRE |
| 1120 | LLSEVYQILQPILQELSATLQRIREVLR |
| 1121 | FLIRQLIELLTWLFSNCRTLLSEVY |
| 1122 | RVIEVVQGACRAIRHIPRRSRQGLERIL |
| 1123 | RVIEVVQGACRASRHIPRRIRQGLERIL |
| 1124 | RVIEVVQGACRAIRHIPRRIEQGLERIL |
| 1125 | RVIEVVQGACRAIEHIPRRIRQGLERIL |
| 1126 | RVIEVVQGACRAIEHIPRRIEQGLERIL |
| 1127 | RVIRVVQGACRAIRHIPRRIRQGLRRIL |
| 1128 | KIAGYGLKGLAVIIKICIKGLNLIFEIIK |
| 1129 | RIIEFILNLGRICIRIIVALGRLGYGAIR |
| 1130 | RIAGYGLRGLAVIPRRICIRGLNLIFEIIR |
| 1131 | RIAGYGLRGLAVIIRIICRGLNLIFEIIR |
| 1132 | RIAGYGLRGLAVIIRCIIRGLNLIFEIIR |
| 1133 | RLLTWLRRTLLSRVYQILQEIL |
| 1134 | RLLTWLFSNRRTLLSRVYQILQEIL |
| 1135 | RLLTWLFSNCRTLLSRVYQILQPIL |
| 1136 | LLSKVYQILQPILQKLSATLQKIKEVLK |
| 1137 | RLVERIRQLTASLRQLIPQLIQYVRSLL |
| 1138 | LLSRVYQILQPILQRLCATLQRIREVLR |
| 1139 | LLSRVYQILQPILQRLSATLQAIREVL |
| 1140 | RLVRRIRQLTASRQLIPQLIQYV |
| 1141 | RLVERIRQLTASRQLIPQLIQYV |
| 1142 | FLIKQLIKLLTWLFSNCKTLLSKVY |
| 1143 | YVRSLLTRCNSFLWTLLRILQRILF |
| 1144 | FLIRQLIRLLTWLFPNCRTLLSRVY |
| 1145 | LLTRCNSFLWTLLRILQRILF |
| 1146 | FLIRQLIRLLTWLFSNCRTLL |
| 1147 | FLIRQLIRLLTWLFSNCRTLLSEVY |
| 1148 | FLIRQLIRQLLTWQPILQYILQ |
| 1149 | YHKLKLLLIVTKIVELLGKK |
| 1150 | RRGLLEVIRTVILLLRRLRHY |
| 1151 | RRGLLRVIRTVILLLDRLRHY |
| 1152 | RRGLLEVIRCVILLLDRLRHY |
| 1153 | RRGLLEVIRTVILLLRRL |
| 1154 | RRGLLRVIRTVILLLDRL |
| 1155 | RRGLLEVIRCVILLLDRL |
| 1156 | YHRLRDLLLIVTRIVELLGRR |
| 1157 | YHRLRDLLLIVCRIVELLGRR |
| 1158 | YHRLRDLLLIVCRIVELL |
| 1159 | RRGLLEVIRTVILALDRL |
| 1160 | RRGLLEVIRTVILALDRLRHY |
| 1161 | RRGLLEVIRTVILLLDRLRHY |
| 1162 | RRGLLRVIRTVILALDIL |
| 1163 | YHRLRDLALIVTRIVELL |
| 1164 | RRGLLEVIRTVILPRRLLDRL |
| 1165 | YHRLRDLLLIVTRIVELL |
| 1166 | YHRLLRDLLIVTRIVELL |
| 1167 | YHRLRDLLLIVRRIVCLL |
| 1168 | YHRLRDLLLIVTRIVCLL |
| 1169 | YHRLRDLLLIVTRIVRLL |
| 1170 | YHRLRDLLLIVRRIVELL |
| 1171 | YHRLRDLLRIVTRIVELL |
| 1172 | YHRLRRLLLIVTRIVELL |
| 1173 | YHRLLRDLLIVTRIVELLGRR |
| 1174 | YHRLRDLLLIVRRIVCLLGRR |
| 1175 | YHRLRDLLLIVTRIVCLLGRR |
| 1176 | YHRLRDLLLIVTRIVRLLGRR |
| 1177 | YHRLRDLLLIVRRIVELLGRR |
| 1178 | YHRLRDLLRIVTRIVELLGRR |
| 1179 | YHRLRRLLLIVTRIVELLGRR |
| 1180 | LWETLGRVGRWVLAIPRRIRQGLELAL |
| 1181 | DLWETLKKGGRWILAIPRRIKQGLELTL |
| 1182 | RIRRPIALIWRGGRRLTEWL |
| 1183 | WETLPRRIRGGRLWILAI |
| 1184 | WILAIPRRIRGGRLWETL |
| 1185 | LRRGGRWILAIPREIL |
| 1186 | LWETLRRGGRWILAIPREIL |
| 1187 | LRRGGRWILAIPRAIL |
| 1188 | LWETLRRGGRWILAIPRAIL |
| 1189 | LRRGGRWILAIPRRIR |
| 1190 | LWRLLRRGGRWILAIPRRIR |
| 1191 | LWELLRRGGRWILAIPRRIR |
| 1192 | LWETLRRIIRWILAIPRRIR |
| 1193 | LWETLRRGCRWILAIPRRIR |
| 1194 | LWETLRRGGRWILAIPRRIR |
| 1195 | DLWETLRRGCRWILAIPRRIR |
| 1196 | DLWETLRRGGRWILAIPRRIR |
| 1197 | DLWETLRRIIRWILAIPRRIR |
| 1198 | LWRLLRRGGRWILAIPRRIRQGLELTL |
| 1199 | LWELLRRGGRWILAIPRRIRQGLELTL |
| 1200 | LWETLRRGGRWILAIPRRIRRQIELTL |
| 1201 | LWETLRRGGRWILAIPRRIRRGLELTL |
| 1202 | LWETLRRGGRWILAIPRRIRQGLRLTL |
| 1203 | LWRTLRRGGRWILAIPRRIRQGLELTL |
| 1204 | LWETLRRGCRWILAIPRRIRQGLELTL |
| 1205 | LWETLRRGGRWILAIPRRIRQGLELCL |
| 1206 | LWETLRRGGRWILAIPRRIRQGLELTL |
| 1207 | DLWETLRRIIRWILAIPRRIRQGLELCL |
| 1208 | DLWETLRRGCRWILAIPRRIRQGLELTL |
| 1209 | DLWETLRRGGRWILAIPRRIRQGLELCL |
| 1210 | DLWETLRRIIRWILAIPRRIRQGLELTL |
| 1211 | KVIEVVQGACKAIKHIPKKIKQGLEKIL |
| 1212 | RAIRRAIRGAPRAILRAIL |
| 1213 | RAIRRAIRGAPRAIL |
| 1214 | LIRRLGQRIRRPIHRIARCAG |
| 1215 | LIRELGIRIRRPIHRIARCAG |
| 1216 | LIRELGQRIRRPIRRIARCAG |
| 1217 | LIRELGQRIRRPIHRIARCIG |
| 1218 | LIRELGQRIRRPIHRIARCAI |
| 1219 | LIRELGQRIRRPIHRIARCAR |
| 1220 | LIRELGQRIRRPIHRIARCAG |
| 1221 | LIRRLGQRIRRPIHRIARCAGQVV |
| 1222 | LIRELGIRIRRPIHRIARCAGQVV |
| 1223 | LIRELGQRIRRPIRRIARCAGQVV |
| 1224 | LIRELGQRIRRPIHRIARCIGQVV |
| 1225 | LIRELGQRIRRPIHRIARCAGRVV |
| 1226 | LIRELRQRIRRPIHRIARCARQVV |
| 1227 | LIRELGQRIRRPIHRIARCAGQVV |
| 1228 | RIRRPIRRIIRCIGQVVEIVR |
| 1229 | RIRRPIHRIIRCIGQVVRIVR |
| 1230 | RIRRPIRRIARCAGQVVEIVR |
| 1231 | RIRRPIHRIARCIGQVVEIVR |
| 1232 | RIRRPIHRIARCAGRVVEIVR |
| 1233 | RIRRPIHRIARCAGQVVRIVR |
| 1234 | RIRRPIHRIARCAGQVVEIVR |
| 1235 | LIRRLGQRIRRPIHRIARCAGQVVEIVR |
| 1236 | LIRELGIRIRRPIHRIARCAGQVVEIVR |
| 1237 | LIRELGQRIRRPIRRIARCAGQVVEIVR |
| 1238 | LIRELGQRIRRPIHRIARCIGQVVEIVR |
| 1239 | LIRELGQRIRRPIHRIARCAGRVVEIVR |
| 1240 | LIRELGQRIRRPIHRIARCAGQVVRIVR |
| 1241 | LIRELGQRIRRPIHRIARCAGQVVEIVR |
| 1242 | RRIRHIPRAIRVVQGAC |
| 1243 | RVIRVVRGACRAIRHIPRRIR |
| 1244 | RACRAIRHIPRRIR |
| 1245 | VVQRACRAIRHIPRRIR |
| 1246 | GACRAIRRIPRRIRGLERIL |
| 1247 | GACRAIRRIPRRIR |
| 1248 | VVQGACRAIRRIPRRIRGLERIL |
| 1249 | VVQGICRAIRHIPRRIRGLERIL |
| 1250 | VVRGACRAIRHIPRRIRGLERIL |
| 1251 | VVQRACRAIRRIPRRIR |
| 1252 | VVQGICRAIRHIPRRIR |
| 1253 | VVRGACRAIRHIPRRIR |
| 1254 | RVIEVVQGACRAIRRIPRRIRQGLERIL |
| 1255 | RVIEVVQGICRAIRHIPRRIRQGLERIL |
| 1256 | RVIEVVRGACRAIRHIPRRIRQGLERIL |
| 1257 | RVIRVVQGACRAIRHIPRRIRQGLERIL |
| 1258 | RVIEVVQGACRAIRRIPRRIR |
| 1259 | RVIEVVQGICRAIRHIPRRIR |
| 1260 | RVIEVVRGACRAIRHIPRRIR |
| 1261 | RVIRVVQGACRAIRHIPRRIR |
| 1262 | RVIEVVQGACRAIRHIPRRIRQGLRRIL |
| 1263 | RVIEVVQGACRAIRHIPRRIRQILERIL |
| 1264 | RVISVVQGACRAIRRIPRRIRQGLERIL |
| 1265 | RVISVVQGACRAIRRIPRRIR |
| 1266 | GACRAIRHIPRRIR |
| 1267 | VVQGACRAIRHIPRRIR |
| 1268 | RVIEVVQGACRAIRHIPRRIR |
| 1269 | RIAGYGLRGLAVIIRICIRGLNLIFEIIR |
| 1270 | LLSRVYQILQPILQRLSATLQRIREVLR |
| 1271 | FLIRQLIRLLTWLFSNCRTLLSRVY |
| 1272 | DLWETLRRGGRWILAIPRRIRQGLELTL |
| 1273 | RRIYRAIRHIPRRIR |
| 1274 | GAYRAIRHIPRRIR |
| 1275 | KLKKALRWLARHAK |
| 1276 | KWKKALRALARHLK |
| 1277 | IRALQRAVRHPRAIRRIYRGWKKAIR |
| 1278 | IQRVAQKLKKALRALARHWKRAL |
| 1279 | KLKKALRALARHWK |
| 1280 | AIANFFERLMKKLIWALMGEAVQT |
| 1281 | AIAIFKRIAKINFKALMGEAVQT |
| 1282 | AIAKFAKKALKSMLALMGEAVQT |
| 1283 | KLKKALRALARHWKGWLRRIGRRIERVGQH |
| 1284 | GWLRRIGRRIERVGQHKLKKALRALARHWK |
| 1285 | KKIEKAIKHIPKKIKLKKALRALARHWK |
| 1286 | RRIYRAIRHIPRRIRGWLRRIGRRIERVGQH |
| 1287 | QRAVGWLRRIGRRIERVGQHLRALAGPGVTIGIAHAKSQLW |
| 1288 | KLIRKLIRWLRRKIRALQRAVAGPGVTIGIAHAKSQLW |
| 1289 | IRALQRAVRHPRAIRRIYRGWKKAIRAGPGVTIGIAHAKSQLW |
| 1290 | IQRVAQKLKKALRALARHWKRALAGPGVTIGIAHAKSQLW |
| 1291 | QRAVKKIEKAIKHIPKKIKIRALAGPGVTIGIAHAKSQLW |
| 1292 | QRAVRRIYRAIRHIPRRIRIRALAGPGVTIGIAHAKSQLW |
| 1293 | KLKKALRALARHWKAGPGVTIGIAHAKSQLW |
| 1294 | KKIEKAIKHIPKKIKAGPGVTIGIAHAKSQLW |
| 1295 | GGGGSGGGGSGGGGS |
| 1296 | MGKNGSLCCFSLLLLLLLAGLASGHQVL |
| 1297 | MGRIARGSKMSSLIVSLLVVLVSLNLASETTA |
| 1298 | GIGKFLREAGKFGKAFVGEIMKP |
| 1299 | IGEDVYTPGISGDSLR |
| 1300 | AKSRWY |
| 1301 | RQIIVFMRKKNFVTKILKKQR |
| 1302 | RNSLPKVAYATA |
| 1303 | LAKLAVKAIKGAIAGAKSAMG |
| 1304 | KAIQTAQGVVAVAPGAKIIGDRINQGVKEIKKFLKWK |
| 1305 | RPGGQIAIAIGESIRKKASNELKKATKSLWS |
| 1306 | SNMIEGVFAKGFKKASHLFKGIG |
| 1307 | SKMIEGVFAKGFKGASHLFKGIG |
| 1308 | IIGGRESRPHSRPYMAYLQIQSPAGQSRCGGFLVREDFVLTAAHCWGSNINVTL |
| | GAHNIDRRENTQQHITARRAIRHPQYNQRTIQNDIMLLQLSRRVRRNRNVNPV |
| | ALPRAQEGLRPGTLCTVAGWGRVSMRRGTDTLR |
| 1309 | GIGGALLSAGKSALKGLAKGLAEHFAN |
| 1310 | AAPCFCSGKPGRGDLWILRGTCPGGYGYTSNCYKWPNICCYPH |
| 1311 | GIGAAILSAGKSIIKGLANGLAEHF |
| 1312 | ATCDALSFSSKWLTVNHSACAIHCLTKGYKGGRCVNTICNCRN |
| 1313 | VDKPDYRPRPRPPNM |
| 1314 | DDMTMKPTPPPQYPLNLQGGGGGQSGDGFGFAVQGHQKVWTSDNGRHEIGL |
| | NGGYGQHLGGPYGNSEPSWKVGSTYTYRFPNF |
| 1315 | AVDLAKIANIANKVLSSLFGK |
| 1316 | TAGPAIRASVKQCQKTLKATRLFTVSCKGKNGCK |
| 1317 | WKSESLCTPGCVTGALQTCFLQTLTCNCKISK |
| 1318 | KRGSGWIATITDDCPNSVFVCC |
| 1319 | GDVPPGIRNTICLMQQGTCRLFFCHSGEKKRDICSDPWNRCCVSNRDEEGKEK |
| | PKTDGRSGI |
| 1320 | GIGASILSAGKSALKGFAKGLAEHFAN |
| 1321 | GLLCYCRKGHCKRGERVRGTCGIRFLYCCPRR |
| 1322 | KNYGNGVHCTKKGCSVDWGYAWTNIANNSVMNGLTGGNAGWHN |
| 1323 | GKVWDWIKSTAKKLWNSEPVKELKNTALNAAKNFVAEKIGATPS |
| 1324 | GLLSGILNTAGGLLGNLIGSLSNGES |
| 1325 | GLLSGILNSAGGLLGNLIGSLSNGES |
| 1326 | SVLSTITDMAKAAGRAALNAITGLVNQGEQ |
| 1327 | GLMSVLGHAVGNVLGGLFKPKS |
| 1328 | GGLKKLGKKLEGAGKRVFNAAEKALPVVAGAKALG |
| 1329 | GGLKKLGKKLEGVGKRVFKASEKALPVAVGIKALG |
| 1330 | RRFPWWWPFLRRPRLRRQAFPPPNVPGPRFPPPNVPGPRFPPPNFPGPRFPPPNF |
| | PGPRFPPPNFPPPFPPPIFPGPWFPPPPPFRPPPFGPPRFPGRR |
| 1331 | AGWLRKLGKKIERIGQHTRDASIQVLGIAQQAANVAATAR |
| 1332 | GKNGVFKTISHECHLNTWAFLATCCS |
| 1333 | PLSCRRKGGICILIRCPGPMRQIGTCFGRPVKCCR |
| 1334 | GLLDALSGILGL |
| 1335 | GLLGTLGNLLNGLGL |
| 1336 | GIIDIAKKLVGGIRNVLGI |
| 1337 | GSNKGFNFMVDMIQALSN |
| 1338 | GSNKGFNFMVDMINALSN |
| 1339 | GSNKGFNFMVDMIQALSK |
| 1340 | GLFTFIKCAYKLRAPAVAC |
| 1341 | GFFTLIKAANKLINKTVNKEAGKGGLEIMA |
| 1342 | GVLGTVKNLLIGAGKSAAQSVLKTLSCKLFNDC |
| 1343 | VDKPDYRPRPWPRPN |
| 1344 | INNWVRVPPCDQVCSRTNPEKDECCRAHGHAFHATCSGGMQCYRR |
| 1345 | GLLSVLGSVAKHVLPHVVPVIAEHL |
| 1346 | ALGGLLADVVKSKEQPA |
| 1347 | ILGTILGLLKGL |
| 1348 | INWKALLDAAKKVL |
| 1349 | GLLSSLSSVAKHVLPHVVPVIAEHL |
| 1350 | GLWQKIKDKASELVSGIVEGVK |
| 1351 | GLLSSLSSVAKHVLPHVVPVIAEHL |
| 1352 | GLWQKIKNAAGDLASGIVEGIKS |
| 1353 | GLWQKIKSAAGDLASGIVEAIKS |
| 1354 | GLWQKIKSAAGDLASGIVEGIKS |
| 1355 | GLWEKIREKANELVSGIVEGVK |
| 1356 | GLVASIGRALGGLLADVVKSKEQPA |
| 1357 | GLVSSIGKALGGLLADVVKTKEQPA |
| 1358 | GLLSVLGSVVKHVIPHVVPVIAEHL |
| 1359 | GLLSVLGSVAQHVLPHVVPVIAEHL |
| 1360 | GLLGVLGSVAKHVLPHVVPVIAEHL |
| 1361 | GLWSKIKDVAAAAGKAALGAVNEALGEQ |
| 1362 | GLWSTIKQKGKEAAIAAAKAAGQAALGAL |
| 1363 | XXKEIXWIFHDN |
| 1364 | VDKPDYRPRPWPRPNM |
| 1365 | VDKPDYRPRPWPRNMI |
| 1366 | MSGGDGRGHNTGAHSTSGNINGGPTGLGVGGGASDGSGWSSENNPWGGGSG |
| | SGIHWGGGSGHGNGGGNGNSGGGSGTGGNLSAVAAPVAFGFPALSTPGAGG |
| | LAVSISAGALSAAIADIMAALKGPFKFGLWGVALYGVLPSQIAKDDPNMMSKI |
| | VTSLPADDITESPVSSLPLDKATVNVNVRVVDDVKDERQNISVVSGVPMSVPV |
| | VDAKPTERPGVFTASIPGAPVLNISVNNSTPEVQTLSPGVTNNTDKDVRPAGFT |
| | QGGNTRDAVIRFPKDSGHNAVYVSVSDVLSPDQVKQRQDEENRRQQEWDAT |
| | HPVEAAERNYERARAELNQANEDVARNQERQAKAVQVYNSRKSELDAANKT |
| | LADAIAEIKQFNRFAHDPMAGGHRMWQMAGLKAQRAQTDVNNKQAAFDAA |
| | AKEKSDADAALSAAQERRKQKENKEKDAKDKLDKESKRNKPGKATGKGKP |
| | VGDKWLDDAGKDSGAPIPDRIADKLRDKEFKNFDDFRKKFWEEVSKDPDLSK |
| | QFKGSNKTNIQKGKAPFARKKDQVGGRERFELHHDKPISQDGGVYDMNNIRV |
| | TTPKRHIDIHRGK |
| 1367 | DVLKKIGTVALHAGKAALGAVADTISQ |
| 1368 | PDPAKTAPKKKSKKAVT |
| 1369 | PDPAKTAPKKGSKKAVTKXA |
| 1370 | YSSGYTRPLPKPSRPIFIRPIGCDVCYGIPSSTARLCCFRYGDCCHR |
| 1371 | QGCKGPYTRPILRPYVRPVVSYNACTLSCRGITTTQARSCCTRLGRCCHVAKG |
| | YS |
| 1372 | QGYKGPYTRPILRPYVRPVVSYNACTLSCRGITTTQARSCSTRLGRCCHVAKG |
| | YS |
| 1373 | RWKIFKKIEKVGQNIRDGIVKAGPAVAVVGQAATI |
| 1374 | GWLKKLGKRIERIGQHTRDATIQGLGIAQQAANVAATARG |
| 1375 | GWLKKLGKRIERIGQHTRDATIQGLGIAQQAANVAATAR |
| 1376 | GWLKKIGKKIERVGQHTRDATIQTIGVAQQAANVAATLK |
| 1377 | VFIDILDKMENAIHKAAQAGIGIAKPIEKMILPK |
| 1378 | RWKIFKKIERVGQNVRDGIIKAGPAIQVLGTAKAL |
| 1379 | RWKFFKKIERVGQNVRDGLIKAGPAIQVLGAAKAL |
| 1380 | RWKVFKKIEKVGRNIRDGVIKAGPAIAVVGQAKAL |
| 1381 | RWKVFKKIEKVGRHIRDGVIKAGPAITVVGQATAL |
| 1382 | PWNIFKEIERAVARTRDAVISAGPAVRTVAAATSVAS |
| 1383 | QRFIHPTYRPPPQPRRPVIMRA |
| 1384 | GKIPIGAIKKAGKAIGKGLRAVNIASTAHDVYTFFKPKKRH |
| 1385 | SGFVLKGYTKTSQ |
| 1386 | AGFVLKGYTKTSQ |
| 1387 | GFLSTVKNLATNVAGTVIDTIKCKVTGGC |
| 1388 | GGLKKLGKKLEGVGKRVFKASEKALPVLTGYKAIG |
| 1389 | GGLKKLGKKLEGVGKRVFKASEKALPVLTGYKAIG |
| 1390 | MVTLVLLVFLLLNVVEDEAASFPFSCPTLSGVCRKLCLPTEMFFGPLGCGKGF |
| | LCCVSHF |
| 1391 | KWCFRVCYRGICYRRCR |
| 1392 | GWLKKIGKKIERVGQNTRDATVKGLEVAQQAANVAATVR |
| 1393 | GWLKKLGKRIERIGQHTRDATIQGLGIAQQAANVAATAR |
| 1394 | GWLKKLGKRIERIGQHTRDATIQGLGIAQQAANVAATAR |
| 1395 | GWLKKLGKRIERIGQHTRDATIQGLGIAQQAANVAATAR |
| 1396 | GWLKKLGKRIERIGQHTRDATIQGLGIAQQAANVAATAR |
| 1397 | AGWLRKLGKKIERIGQHTRDASIQVLGIAQQAANVAATAR |
| 1398 | GWLKKIGKKIERVGQHTRDATIQGLGVAQQAANVAATAR |
| 1399 | GNFFKDLEKMGQRVRDAVISAAPAVDTLAKAKALGQ |
| 1400 | VFVALILAIAIGQSEAGWLKKIGKKIERVGQHTRDATIQGLGIAQQAANVAAT |
| | AR |
| 1401 | QSEAGWLKKIGKKIERVGQHTRDATIQGLGVAQQAPNVAATAR |
| 1402 | GWLKKIGKKIERVGQHTRDATIQGLGIAQQAANVAATAR |
| 1403 | GWLKKIGKKIERIGQHTRDATIQGVGIAQQAANVAATAR |
| 1404 | GWLKKIGKKIERIGQHTRDATIQGLGIAQQAANVAATAR |
| 1405 | MRTLAILAAILLFALLAQAKSLQETADDAATQEQPGEDDQDLAVSFEENGLS |
| 1406 | CPPCPSCPSCPWCPMCPRCPS |
| 1407 | VRNSQSCRRNKGICVPIRCPGSMRQIGTCLGAQVKCCRRK |
| 1408 | IIGPVLGLVGKPLESLLE |
| 1409 | DPVTCLKNGAICHPVFCPRRYKQIGTCGLPGTKCCK |
| 1410 | DTLACRQSHGSCSFVACRAPSVDIGTCRGGKLKCCK |
| 1411 | MKWTAAFLVLVIVVLMAQPGECFLGLIFHGLVHAGKLIHGLI |
| 1412 | SRRSCHRNKGVCALTRCPRNMRQIGTCFGPPVKCCR |
| 1413 | NPVSCARNKGICVPSRCPGNMRQIGTCLGPPVKCCR |
| 1414 | SNMIEGVFAKGFKKASHLFKGIG |
| 1415 | MKAVFVLLVVGLCIMMMDVATAGFGCPNNYACHQHCKSIRGYCGGYCASW |
| | FRLRCTCYRCGGRRDDVEDIFDIYDNVAVERF |
| 1416 | GDVPLGIRNTICRMQQGICRLFFCHSGEKKRDICSDPWNRCCVSNTDEEGKEK |
| | PEMDGRSGI |
| 1417 | DLLPPRTPPYQEPASDLKVVDFRRSEGFCQEYCNYMETQVGYCPKKKDACCL |
| | H |
| 1418 | VHISHQEARGPSFKICVGFLGPRWARGCSTGN |
| 1419 | DLLPPRTPPYQVHISHQEARGPSFKICVGFLGPRWARGCSTGN |
| 1420 | GIGGALLSAGKAALKGLAKGFAEHF |
| 1421 | QVYKGGYTRPVPRPPPFVRPLPGGPIGPYNGCPVSCRGISFSQARSCCSRLGRC |
| | CHVGKGYS |
| 1422 | QVYKGGYTRPIPRPPFVRPVPGGPIGPYNGCPVSCRGISFSQARS CCSRLGRCC |
| | HVGKGYS |
| 1423 | GFLDKLKKGASDFANALVNSIKGT |
| 1424 | GLWEKIKEKANELVSGIVEGVK |
| 1425 | GLWEKIKEKASELVSGIVEGVK |
| 1426 | FFHHIFRGIVHVGKSIHKLVTG |
| 1427 | MSGGDGRGHNTGAHSTSGNINGGPTGLGVGGGASDGSGWSSENNPWGGGSG |
| | SGIHWGGGSGHGNGGGNGNSGGGSGTGGNLSAVAAPVAFGFPALSTPGAGG |
| | LAVSISAGALSAAIADIMAALKGPFKFGLWGVALYGVLPSQIAKDDPNMMSKI |
| | VTSLPADDITESPVSSLPLDKATVNVNVRVVDDVKDERQNISVVSGVPMSVPV |
| | VDAKPTERPGVFTASIPGAPVLNISVNNSTPAVQTLSPGVTNNTDKDVRPAGFT |
| | QGGNTRDAVIRFPKDSGHNAVYVSVSDVLSPDQVKQRQDEENRRQQEWDAT |
| | HPVEAAERNYERARAELNQANEDVARNQERQAKAVQVYNSRKSELDAANKT |
| | LADAIAEIKQFNRFAHDPMAGGHRMWQMAGLKAQRAQTDVNNKQAAFDAA |
| | AKEKSDADAALSSAMESRKKKEDKKRSAENNLNDEKNKPRKGFKDYGHDYH |
| | PAPKTENIKGLGDLKPGIPKTPKQNGGGKRKRWTGDKGRKIYEWDSQHGELE |
| | GYRASDGQHLGSFDPKTGNQLKGPDPKRNIKKYL |
| 1428 | VNHALCAAHCIARRYRGGYCNSKAVCVCR |
| 1429 | ATCDLASGFGVGSSLCAAHCIARRYRGGYCNSKAVCVCRN |
| 1430 | WNHTLCAAHCIARRYRGGYCNSKAVCVCR |
| 1431 | SQWVTPNDSLCAAHCIARRYRGGYCNGKRVCVCR |
| 1432 | SQWVTPNDSLCAAHCLVKGYRGGYCKNKICHCR |
| 1433 | GNGVLKTISHECNMNTWQFLFTCC |
| 1434 | FLPVIAGLAAKVLPKLFCAITKKC |
| 1435 | GKVWDWIKSTAKKLWNSEPVKELKNTALNAAKNLVAEKIGATPSE |
| 1436 | GKVWDWIKKTAKDVLNSDVAKQLKNKALNAAKNFVAEKIGATPS |
| 1437 | GILDTLKNLAKTAGKGILKSLVNTASCKLSGQC |
| 1438 | GLFGLAKGSVAKPHVVPVISQLV |
| 1439 | SVLGKSVAKHLPHVVPVIAEKT |
| 1440 | GLLSVLGSLKLIVPHVVPLIAEHL |
| 1441 | GLFGILGSVAKHVLPHVVPVIAEHS |
| 1442 | DSIQCFQKNNTCHTNQCPYFQDEIGTCYDRRGKCCQ |
| 1443 | ADTLACRQSHGSCSFVACRAPSVDIGTCRGGLKKCCKW |
| 1444 | NNEAQCEQAGGICSKDHCFHLHTRAFGHCQRGVPCRT |
| 1445 | GIGGALLSAGKSALKGLAKGLAEHFAN |
| 1446 | ILGPVLSLVGNALGGLLKNE |
| 1447 | ALRSAVRTVARVGRAVLPHVAIADPYVRTPYVHNNPDWSLWRRKRWNQQPT |
| | SQADMLEDALEAQAIEALMQEQ |
| 1448 | ALRGALRAVARVGKAILPHVAIANPYVRTPYVHNNPDWSLWRSRRRSGNQQP |
| | TSQAEILEDALEAQAIEALMQEQ |
| 1449 | LKCVNLQANGIKMTQECAKEDTKCLTLRSLKKTLKFCASGRTCTTMKIMSLP |
| | GEQITCCEGNMCNA |
| 1450 | LLGPVLGLVSNALGGLLKNI |
| 1451 | GLLSVFKGVLKGVGKNVAGSLLDQLKCKISGGC |
| 1452 | RLPPGFTPWRIAPAIV |
| 1453 | FLPMLAKLLSGFLGK |
| 1454 | GLFSVVKGVLKGVGKNVAGSLLDQLKCKISGGC |
| 1455 | ILGPVLGLVGSALGGLIKKI |
| 1456 | ILGPVLSLVGNALGGLIKKI |
| 1457 | KIKWFKTMKSLAKFLAKEQMKKHLGE |
| 1458 | CYREGGECLQRCIGLFHKIKCCK |
| 1459 | FLPKTLRKFFCRIRGGRCAVLNCLGKEEQIGRCSNSGRKCCRKKK |
| 1460 | DTIACIENKDTCRLKNCPRLHNVVGTCYEGKGKCCH |
| 1461 | DLKHLILKAQLTRCYKFGGFCHYNICPGNSRFMSNCHPENLRCCKNIKQF |
| 1462 | DCYCRIPACIAGERRYGTCIYQGRLWAFCC |
| 1463 | NPVTCLRSGAICHPGFCPRRYKHIGVCGVSAIKCCK |
| 1464 | NPVTCIRSGAICHPGFCPGRYKHIGVCGVPLIKCCK |
| 1465 | NPVTCLRSGAICHPGFCPRRYKHIGICGVSAIKCCK |
| 1466 | DTLACRQSHGSCSFVACRAPSVDIGTCRGGKLKCCK |
| 1467 | TQCRIRGGFCRVGSCRFPHIAIGKCATFISCC |
| 1468 | DEEKRENEDEENQEDDEQSEMRRGLRSKIKEAAKTAGKMALGFVNDMAGEQ |
| 1469 | EEEKRENEDEENQEDDEQSEMRRGLWSKIKEAAKTAGKMAMGFVNDMVGE |
| | Q |
| 1470 | EEEKRENEDEEEQEDDEQSEEKRALWKTLLKGAGKVFGHVAKQFLGSQGQPE |
| | S |
| 1471 | EEEKREGENEKEQEDDNQSEEKRGLVSDLLSTVTGLLGNLGGGGLKKI |
| 1472 | DEEKRENEDEENQEDDEQSEMRRGLRSKIWLWVLLMIWQESNKFKKM |
| 1473 | RDVICLMQHGTCRLFFCHSGEKKSEICSDPWNRCC |
| 1474 | LQDAALGWGRRCPRCPPCPNCRRCPRCPTCPSCNCNPK |
| 1475 | LQDAALGWGRRCPRCPPCPNCRRCPRCPTCPRCNCNPK |
| 1476 | LQDAALGWSRRCPRCPPCPNCRRCPRCPTCPSCNCNPK |
| 1477 | DCRFCCGCCTDVSGCGVCCRF |
| 1478 | FFFFDEKCSRINGRCTASCLKNEELVALCWKNLKCCVTVQSCGRSKGNQSDE |
| | GSGHMGTRG |
| 1479 | DLKHLILKAQLARCYKFGGFCYNSMCPPHTKFIGNCHPDHLHCCINMKELEGS |
| | T |
| 1480 | MRLVVCLVFLASFALVCQGQVYKGGYTRPVPRPPFVRPLPGGPIGPYNGCPVS |
| | CRGISFSQARSCCSRLGRCCHVGKG |
| 1481 | SLDKRACNFQSCWATCQAQHSIYFRRAFCDRSQCKCVFVRG |
| 1482 | VDCRRSEGFCQEYCNYMETQVGYCSKKKDACC |
| 1483 | AVGSLKSIGYEAELDHCHTNGGYCVRAICPPSARRPGSCFPEKNPCCKYMK |
| 1484 | PRITIDRVVLARESWRFTVTGLGFATLTGQGDRFRRVQRWQHAHGLPRHLFG |
| | WTPMEERPFSLDLTSPASVDVLAGALRRT |
| 1485 | KVTEQLKRCWGEYIRGYCRKICRISEIREVLCENGRYCCLNIVELEARRKITKPP |
| | PPE |
| 1486 | LALGHMQPGRSEFKRCWKGQGACRTYCTRQETYLHMCPDASLCCLPYGSRP |
| | L |
| 1487 | LSGRVLFPLSCIGSSGFCFPFRCPHNREEIGRCFFPIQ |
| 1488 | QKYYCRVRGGRCAVLSCLPKEEQIGKCSTRGRKCCR |
| 1489 | NSVTCSKNGGFCISPKCPPGMKQIGTCGLPGSKCCR |
| 1490 | MNNLHRELAPISEAAWAQIEEEASRTLKRYLAARRVVDVPEAKGFGFSAVGT |
| | GHVERIDAPGSDIRAVRRNVLPLVELRVPFTLARDAIDDVERGAGDSDWQPLK |
| | DAAKKIAFAEDRAVFDGYAAAGILGLREGTSNPKLALPSSASDYPAAIAAALN |
| | QLRLAGVNGPYAVVLGAGVYTALSGGDDEGYPVFRHIESLIDGKIVWAPAIEG |
| | GFVLSTRGGDFELDIGQDFSIGYSSHSADSVELYLQESFTFQLLTTEA |
| 1491 | MNNLHRELAPITSEAWAAIEEEAGRTFKRHIAGRRVVDVAGPHGVDFSAVGL |
| | GRTTGIAAPDEGVQARQRVVAPLVELRVPFTLSREELDNVERGAKDTDLDAV |
| | KEAARRIAFAEDRAIFEGYPAAGITGIRAAGSNAPITVPDDARLVPEAITQALTA |
| | LRLAGVDGPYSVLLSAELYTEVSETSDHGYPIRTHIERLIPDGEIIWAPAIDGAF |
| | VLTTRGGDYELTLGQDVSIGYLSHDADTVRLYFQQTMQFLVHTAEA |
| 1492 | MDLLKRELAPILPAAWDLIDHEATRVLKLHLAGRKVVDFRGPFGWEVAAVNT |
| | GRLRAIERKEGPAVSAGVRLVRPLVEFRAPIRLELAELDAVGRGAQEPNIEDV |
| | VRAAEHAAREEDGAIFNGLAAAGIEGILEVAPHKPVVIPAPEAWPRAVAEARE |
| | VLRAAGVDGPYALALGPKAYDELAAAAEDGYPLRKHIEGQLIDGPIVWAPAL |
| | EGGVLLSTRGGDFELTVGEDLSIGYDGHDRQVVELFLTESFTF |
| 1493 | MNNLHRELAPISSAAWEQIEEEVARTFKRSVAGRRVVDVEGPAGPELSAVGT |
| | GHLLDVAAPRELVNARLREVRTIVELTVPFELSRDAIDSVERGARDADWQPAK |
| | EAAQRLAFAEDNAIFDGYPAAGIVGIREGTSNRRLTLPADVGAYPDAISDALE |
| | ALRLAGVDGPYSVVLGSDAYTALSEARDQGYPVLGHIKRIVSGEIIWAPAISGG |
| | CVLSTRGGDYELHLGEDVSIGYTSHTDKGVRLYLRETFTFLMLTSEA |
| 1494 | MNNLHRELAPISSAAWEQIEEEVARTFKRSVAGRRVVDVEGPAGPELSAVGT |
| | GHLLDVAAPRELVNARLREVRTIVELTVPFELSRDAIDSVERGARDADWQPAK |
| | EAAQRLAFAEDNAIFDGYPAAGIVGIREGTSNRRLTLPADVGAYPDAISDALE |
| | ALRLAGVDGPYSVVLGSDAYTALSEARDQGYPVLGHIKRIVSGEIIWAPAISGG |
| | CVLSTRGGDYELHLGEDVSIGYTSHTDKGVRLYLRETFTFLMLTSEA |
| 1495 | MNDLMRDLAPISAKAWAEIETEARGTLTVTLAARKVVDFKGPLGWDASSVSL |
| | GRTEALAEEPKAAGSAAVVTVRKRAVQPLIELCVPFTLKRAELEAIARGASDA |
| | DLDPVIEAARAIAIAEDRAVFHGFAAGGITGIGEASAEHALDLPADLADFPGVL |
| | VRALAVLRDRGVDGPYALVLGRTVYQQLMETTTPGGYPVLQHVRRLFEGPLI |
| | WAPGVDGAMLISQRGGDFELTVGRDFSIGYHDHDAQSVHLYLQESMTFRCLG |
| | PEA |
| 1496 | PQDEWAELREAARQAADSIRVFRRYIPTTRVGRGVEYVPVEREGVRDAVKLV |
| | EISAKFKISQAALDYAKRTGQPLDAGDALRAAAELALEEDRLVAHTLLNLSNA |
| | LKMAATSWDEPGKAVAEVSKAVAELIKAGAPGPYILFVDPARFAKLVSVYEK |
| | TGVMELTRIKAIVKDVVPTPVVPPSAALLISASPQTLDLVIGADTEVEYLGPED |
| | GKHLFRLWETIAVRV |
| 1497 | MNNLHRELAPIASSAWAQIEEEVARTFKRSVAGRRVVDVEGPAGPGLSAVGT |
| | GHLRDVTAPREQVSARLREVRNVVELTVPFELSRDAIDSVERGARDADWQPA |
| | KDAAQRLAFAEDGAIFDGYLAADIVGIREGTSNRKLILPTDVSAYPDAISDALE |
| | ALRLAGVDGPYTVVLGSDAYTALSEARDQGYPVLGHIKRIVSGEIVWAPAISG |
| | GCVLSTRGGDYELHLGEDVSIGYTSHTDKVVRLYLRETFTFLMLTSEA |
| 1498 | RSDLPVNRTLNIIHRAGVKYSLMEDELLLSKHPLSIIERGRKEKASDWDIPGSIA |
| | NDVIRGIQILETNGYTDPVTIISPELYTRLFRVYDKSGTYEIKLVKHATEIIVSPLI |
| | KGLAVVSKKGFYVMENTPAKVEFLGREGINSDYIIWGKIAPYLIDTNA |
| 1499 | MDNLHRKLAPISDAAWAQIEDEAARTLKRYLGARRVVDVHGPEGFGLSAVG |
| | TGHLRPATALAEGVESHRREVNPLLELRVPFTLTRAAIDDVARGSNDSDWQPL |
| | KDAARKIALAEDRLVFLGHGDAGIRGILPETSNPIVALPANVADYPEAVASAV |
| | SELRLAGVNGPYALILGTTAFTAANGGAEDGYPVLKHLERLVDVPVVWSQAL |
| | EGGAVVTTRGGDFDLWLGQDISIGYLSHDAASVTLYLQESLTFQMQTSEA |
| 1500 | KRSFTEYTQVIETVSKNKVFLEQLLLANPKLYDVMQKYNAGLLKKKRVKKLF |
| | ESIYKYYKRSYLRS |
| 1501 | MNNLHRELAPISSSAWEQIEEEVARTFKRSVAGRRVVDVDGPEGPELSAVGTG |
| | HLVEVAAPREQVNARLREVRTIVELTVPLLLSRDAIDSVERGARDADWQPAK |
| | DAAQRLAFAEDGAIFDGYAAASIVGIREGTSNNKLTLPADVSAYPDAISDALE |
| | ALRLAGVDGPYSVVLGSDAYTALSEARDQGYPVLGHIKRIVSGEIIWAPAISGG |
| | CVLSTRGGDYELHLGEDVSIGYTSHTDKVVRLYLRETFTFLMLTSEA |
| 1502 | MDILRRENAQFPASIWSAIEKEAGLVFGKHLTGRKVVDFKGGLGIGFSSLPTGR |
| | VISSKEKLGEASVGVRMNTPVIELKIPFSFPESEVEAILREANAFDISSIEKAAKK |
| | VCVAENELVFYGLKKEGIEGLIPSIPHKPIKAKGDEILPAVAEGIKELVNSEIEGP |
| | YALLIQPQYFGKLFGVAGNSGYPLTLKLAELLQGNNIIVAPALKSGALLVSLRG |
| | GDYELYSGMDIGVGYSEKKSTNHELFFFETLTFRINTPEA |
| 1503 | NIIKWDQQAIPFYETKVQDNAIIQSDKQVPYPLSIINTLFKVMPDLPKEETQPVF |
| | MKAYLTHSRKEDLLIYREHPLSILQRSKKMNRSDWNIPGNIVNDIVRAYEQVL |
| | SSGYSDVNLIIPPYVHALLYRVVDRTGTMEIELLRHLGNIYVSPNVDTIVVISKQ |
| | VLYVYEKKSTTLENLGRDGVYEVYMLSSELAPYVTDPE |
| 1504 | MNNLHRELAPISSAAWEQIEEEVARTFKRSVAGRRVVDVEGPKGPELSAVGT |
| | GHLRDVAAPREHVDARLREVRTIVELTVPFELDRAAIDSVERGARDADWQAA |
| | KEAAQRLAFAEDSAIFDGYPAAGIVGIREGTSNRKLTLPSDVGAYPDAISDALE |
| | ALRLAGVDGPYSVLLGADAYTALSEARDQGYPVIEHIKRIVSGEIIWAPAISGG |
| | CVLSTRGGDYELHLGEDVSIGYASHTDKVVRLYLRETLTFLMLTSEA |
| 1505 | MNNLHRELAPISRAAWSQIEDEVARTFRRSVAGRRVVDVKGPGGTELSGVGT |
| | GHQTAIAAPQQGVVAKLSEVKSLVELTVPFELQREAIDSVVRGAKDADWQPA |
| | KEAAKQLAYAEDRAIFDGYQAAGIGGIREGSSNPSLALPADVSDYPNAISNAL |
| | EQLRLAGVDGPYSVLLGADAYTALGEARDQGYPVIEHIKRIVNGDIIWAPALA |
| | GGSVLSTRGGDFELHLGEDLSIGYTSHTDTVVRLYLRETLTFLMLTSEA |
| 1506 | MNNLYRDLAPISAAAWAQIEEEVARTFKRSVAGRRVVDVKDPGGFGLAAVG |
| | TGHLRGIAAPQKGVDAKLREVKALVELTVPFELQRDEIDAVERGANDADWQP |
| | AKDAATELAYAEDRAIFDGYKAAGIVGIREGSSNSRLELPTDAADYPAAVGRA |
| | LEQLRLAGVDGPYSVLLGADAYTALSEGSDDGYPTIDHIKRIVSGDIIWAPALN |
| | GGCVLSTRGGDFELHLGQDLSIGYQSHTDKVVRLYLRETLTFLMLTSEA |
| 1507 | MNNLYRDLAPISAAAWAQIEEEVARTFKRSVAGRRVVDVKDPGGFGLAAVG |
| | TGHLRGIAAPQKGVDAKLREVKALVELTVPFELQRDEIDAVERGANDADWQP |
| | AKDAATELAYAEDRAIFDGYKAAGIVGIREGSSNSRLELPTDAADYPAAVGRA |
| | LEQLRLAGVDGPYSVLLGADAYTALSEGSDDGYPTIDHIKRIVSGDIIWAPALN |
| | GGCVLSTRGGDFELHLGQDLSIGYQSHTDKVVRLYLRETLTFLMLTSEA |
| 1508 | NNVFQNKEKNYYEAFYTEEKFKKALKVTTPEAYKSLVDLNIQKDSLNRARYG |
| | YIQRATVKTSPLSYFGKTTYYSLNKKDSEETLQLNNVVKYLILTAAMNDVEV |
| | MNLLRIKINPVFKKINN |
| 1509 | IPLIWKDFTLDRRLYEAMRRKNTNVDASAALEAAYTVSSAEEMMILRGITRNG |
| | TTFEKNGLYEGAGQDYSTPKAIGTYGGIQDAVTDVYEMMDDSDVPTDSLRW |
| | NLSMSPNIYNKVNKSRSANDVKEMKDLLELLGTPNNPGNVFKSNTLPSVSTTG |
| 1510 | NSVTCSKNGGFCISPKCLPGSKQIGTCSLPGSKCCK |
| 1511 | RVGDLPPAIRQELEEFDRYINKQHLVATTLQADYGKHDQLINTIPKDINYLHNK |
| | LMSTKQALKFDSGQLVHLKELNNEITDDISKIMQLILQLSTPGTRLSSSFQLNEF |
| | FVKKIKKYYEILRQYEGVVAELDSILGGLERSCTEGFGNLFNIVEVIKSQYHLF |
| | MELCETMAQLHNEVNKLSK |
| 1512 | AIHRALISKRMEGHCEAECLTFEVKIGGCRAELAPFCCKNRKKH |
| 1513 | FFDEKCNKLKGTCKNNCGKNEELIALCQKSLKCCRTIQPCGSIID |
| 1514 | YYGNGLYCNKEKCWVDWNQAKGEIGKIIVNGWV |
| 1515 | QKYYCRVRGGRCAVLSCLPKEEQIGKCSTRGRKCCR |
| 1516 | NPVTCLRSGAICHPGFCPRRYKHIGTCGLSVIKCCK |
| 1517 | DHYNCVRSGGQCLYSACPIYTRIQGTCYHGKAKCCK |
| 1518 | DHYNCVSSGGQCLYSACPIFTKIQGTCYGGKAKCCK |
| 1519 | NPQSCRWNMGVCIPISFLVNMRQIGTCFGPRV |
| 1520 | REYRFHNQLATTEKPEILPRIVSDGIVWARRRWRIRPTDVPRPETGERDVEYLL |
| | RLEGWRTQLGLPAEIYVAQVTPTAMGLRRKKPQWVHFEHPYSLWAAFTHLD |
| | PH |
| 1521 | NPLSCRLNRGICVPIRCPGNLRQIGTCFTPSVKCCR |
| 1522 | MKVLLAITLVAILGVASGTQFSLCQAPSERRHELVNCVKTHLNEQASQKLSEV |
| | KQRLNCEDLDCVFTKICELSSDTHQEHANTFLPDDVKTDVRAALTQCRPSN |
| 1523 | DSYICARKGGTCNLSPCPLYNRVEGTCYRGKAKCCI |
| 1524 | DSYICARKGGTCNLSPCPLYNRIEGTCYRGKAKCCI |
| 1525 | DSYICARKGGTCNLSPCPLYNRIEGTCYRGKAKCCI |
| 1526 | DSYICARKGGTCNLSPCPLYNRVEGTCYRGKAKCCI |
| 1527 | MRPMSIACAVAVIIACVCALQSAALPSEVRLDPEVRLEEPEDSEAARSIDQGVA |
| | AALAKETSPEVLFRTKRQSHLSLCRYCCNCCKNKGCGFCCRF |
| 1528 | MNNLHRELAPIASSAWAQIEEEVARTFKRSVAGRRVVDVEGPAGPGLSAVGT |
| | GHLRDVTAPREQVSARLREVRNVVELTVPFELSRDAIDSVERGARDADWQPA |
| | KDAAQRLAFAEDGAIFDGYLAADIVGIREGTSNRKLTLPTDVSAYPDAISDALE |
| | ALRLAGVDGPYTVVLGSDAYTALSEARDQGYPVLGHIKRIVSGEIVWAPAISG |
| | GCVLSTRGGDYELHLGEDVSIGYTSHTDKVVRLYLRETFTFLMLTSEA |
| 1529 | ARTFKRSVAGRRVVDVEGPGGTELSGVGTGHQTAIAAPQQGVVARLAEVKRL |
| | VEFTVPFELQREAIDSVLRGANDADWQPAKDAAKELAYAEDRAIFDGYQAAG |
| | IGGIREGSSNAPLALPADIGDYPHAIGNALEELRLAGVDGPYSVLLGADAYTAL |
| | SEARDQGYPVIEHIKRIVNGDIIWAPALTGGSVLSTRGGDFELHLGEDLSIGYLS |
| | HTDSVVRLYLRETLTFLMLTSEA |
| 1530 | MNNLHRELAPISSEAWSQIEEEVARTFKRSVAGRRVVDVKGPGGVDLSGVGT |
| | GHQSTIAAPHHGVIAKLSEVKALVQLTVPFELSRDAIDAVERGANDSDWQAA |
| | KDAAKELAYAEDRAIFDGYKAAGIVGIREGSSNTSLALPADVADYPNAIGGAL |
| | QQLRLAGVDGPYSVLLGADAYTALGEASDQGYPVIEHIKRIVNGEIIWAPALE |
| | GGSVLSMRGGDYELHLGQDVSIGYQSHTDSTVRLYLRETLTFLMLTSEA |
| 1531 | NPISCARNRGVCIPIGCLPGMKQIGTCGLPGTKCCR |
| 1532 | QIVNCKKNEGFCQKYCNFMETQVGYCSKKKEACC |
| 1533 | NLHRNLAPVTEVAWQQIGEEAARTFKRHVAGRRVVDVAGPFGYSYSAHNLG |
| | RVTPIKTSDSRIRAQQRQVNPLVELRFPFTLSRAEVDDVARGSLDSDWQPVKD |
| | AAKAVAFAEDQSIFQGFDEAGIRGLGPSSDNPVLSLPEDPLLIPDAVASALSAL |
| | RLAGVEGPYSVVLDADAYTAVSETRDEGHPVFHHLRDLVAGDIIWAPAISGG |
| | YVLSTRGGDNQLTLGTDLSIGYDSHTATDVTLYLEETFTFASLTAEA |
| 1534 | QKYYCRVRGGRCAVLSCLPKEEQIGKCSTRGRKCCR |
| 1535 | NHRSCHRIKGVCAPDRCPRNMRQIGTCFGPPVKCCR |
| 1536 | MFTLKKSLLLLFFLGTISLSLCEEERNAEEERRDYPEERDVEVEKRIIPLPLGYF |
| | AKKT |
| 1537 | FTMKKSLLLLELLGTINFSLC |
| 1538 | DHYICAKKGGTCNFSPCPLFNRIEGTCYSGKAKCCI |
| 1539 | PSVVDQIAKVEDILKRLNLIKRERIQVLKDLKEKILILNKKSIANYEQQLFQQEL |
| | EKYRGFQNRLVQATHKQAALMRELTVAFNGLLQDKRVRAEQSKYESFQRQR |
| | GAVIGRYKRAYQEFLDLEAGLQSAKTWYKEMKETVESLEKNVETFV |
| 1540 | QKYYCRVRGGRCAVLSCLPKEEQIGKCSTRGRKCCR |
| 1541 | IRNPVTCIRSGAICYPRSCPGSYKQIGVCGVSVIKCCKKP |
| 1542 | PDFMIAASDADAVVRGEFTPVLGELHLGVNSLDYAYFARLHPHRDDLLREVD |
| | LDFPRPRLLVMAPMEAGANLVPRTQRALVRPQDHLVALTSRVPFPTRGRPLN |
| | GADLTVAEQPDGWEIRVPGGERFDLMEIFAQPLKTALMARVSFFRDEHLPRIS |
| | FGRLVVVREQWRIAADELAFAAVRDTRDRYVHARRWWRRRDLPTRVFVKSP |
| | LERKPFHVDADSPALVELLCAAVRR |
| 1543 | MNNLHRELAPIASAAWEQIEEEVARTFKRSVAGRRVVDVEGPKGPALSAVGT |
| | GHLRDVDAPREQVSARLREVRAIVELTVPFFLSRDAIDSVERGARDADWQPA |
| | KDAAQRLAFAEDHAIFDGYAAAGIIGIREGSSNRRLTLPDDVGAYPDAISDALE |
| | ALRLAGVDGPYSVLLGADAYTALSEARDQGYPVIDHIKRIVSGEIIWAPAISGG |
| | CVLSTRGGDYELHLGEDVSIGYTSHTDKVVRLYLRETFTFLMLTSEA |
| 1544 | MNNLHRELAPISSAAWEQIEEEVARTFKRSVAGRRVVDVEGPAGPELSAVGT |
| | GHLLDVAAPRELVNARLREVRTIVELTVPFELSRDAIDSVERGARDADWQPAK |
| | EAAQRLAFAEDNAIFDGYPAAGIVGIREGTSNRRLTLPADVGAYPDAISDALE |
| | ALRLAGVDGPYSVVLGSDAYTALSEARDQGYPVLGHIKRIVSGEIIWAPAISGG |
| | CVLSTRGGDYELHLGEDVSIGYTSHTDKGVRLYLRETFTFLMLTSEA |
| 1545 | NNVFQNKEKNYYEAFYTEEKFKKALKVTTPEAYKSLVDLNIQKDSLNRARYG |
| | YIQRATVKTSPLSYFGKTTYYSLNKKDSEETLQLNNVVKYLILTAAMNDVEV |
| | MNLLRIKINPVFKKINN |
| 1546 | QKYYCRVRGGRCAVLTCLPKEEQIGKCSTRGRKCCR |
| 1547 | RDVICLTQHGTCRLFFCHFGERKAEICSDPWNRCC |
| 1548 | DQYICARKGGTCNFSPCPLFTRIDGTCYRGKAKCC |
| 1549 | NPQSCHRNKGICVPIRCPGNMRQIGTCLGPPVKCCR |
| 1550 | NPVSCVRNKAICVPIRSPANMKQIGSCVGRAVKCCR |
| 1551 | GLLSGILGAGKNIVCGLSGLLKLESEII |
| 1552 | GLWDTIKQAGKKFFLNVLDKIRCKVAGGCRT |
| 1553 | VLSYKEAVLRAIDGINQRSSDANLYRLLDLDPRPTMDGDPDTPKPVSFTVKET |
| | VCPRTTQQSPEDCD |
| 1554 | ALSYREAVLRAVDRINERSSEANLYRLLELDPPPKDVEDRGARKPTSFTVKET |
| | VCPRTSPQPPEQCD |
| 1555 | GFMDTAKNVAKNVAVTLLDNLKCKITKAC |
| 1556 | GLLDTFKNLALNAAKSAGVSVLNSLSCKLFKTC |
| 1557 | NSQSCRRNKGICVPIRCPGSMRQIGTCLGAQVKCCR |
| 1558 | VLSYKEAVLRAIDGINQRSSDANLYRLLDLDPRPTMDGDPDTPKPVSFTVKET |
| | VCPRTTQQSPEDCD |
| 1559 | RRWWFR |
| 1560 | RRWFWR |
| 1561 | MKCLQSVLVLVLLLAMVSAQNTNTTNTRIGGFAGGSGLLPGPAIGGGIGIPGG |
| | VLLPGSFQGGISGGIIHQYGLDCSGNSLSPQTGNCRYYLRNPVNRRYYCTRNQ |
| | KPAYKCPLLRPDCPDTRSGPPVECYTDNDCGPLDKCCCDACLDHYVCKPAA |
| 1562 | MLQQSDALHSALREVPLGVGDIPYNDFHVRGPPPVYTNGKKLDGIYQYGHIET |
| | NDNTAQLGGKYRYGEILESEGSIRDLRNSGYRSAENAYGGHRGLGRYRAAPV |
| | GRLHRRELQPGEIPPGVATGAVGPGGLLGTGGMLAADGILAGQGGLLGGGGL |
| | LGDGGLLGGGGVLGVLGEGGILSTVQGITGLRIVELTLPRVSVRLLPGVGVYL |
| | SLYTRVAINGKSLIGFLDIAVEVNITAKVRLTMDRTGYPRLVIERCDTLLGGIK |
| | VKLLRGLLPNLVDNLVNRVLADVLPDLLCPIVDVVLGLVNDQLGLVDSLIPLG |
| | ILGSVQYTFSSLPLVTGEFLELDLNTLVGEAGGGLIDYPLGWPAVSPKPMPELP |
| | PMGDNTKSQLAMSANFLGSVLTLLQKQHALDLDITNGMFEELPPLTTATLGA |
| | LIPKVFQQYPESCPLIIRIQVLNPPSVMLQKDKALVKVLATAEVMVSQPKDLET |
| | TICLIDVDTEFLASFSTEGDKLMIDAKLEKTSLNLRTSNVGNFDIGLMEVLVEKI |
| | FDLAFMPAMNAVLGSGVPLPKILNIDFSNADIDVLEDLLVLSA |
| 1563 | FIGAILPAIAGLVGGLINR |
| 1564 | FIGAILPAIAGLVHGLINR |
| 1565 | MNNLHRELAPVSASAWQQIEEEVARTFKRSVAGRRVVDVEGPAGPALSAVGT |
| | GHLCDVAAPRELVSARLREVRTIVELTVPFELSRDAIDSVERGARDADWQPAK |
| | DAAQRLAFAEDGAIFDGYAAAGIVGIREGTSNRKLALPADVSAYPDAISDALE |
| | ALRLAGVDGPYSVVLGSDAYTALSEARDQGYPVLGHIKRIVSGEIIWAPAISGG |
| | CVLSTRGGDYELHLGEDVSIGYTSHTDKVVRLYLRETLTFLMLTGEA |
| 1566 | MNFTKLFIMVAIAVLLIAGIQPVEAAPRMEIGKRREKLGRNVFKAAKKALPVI |
| | AGYKALG |
| 1567 | MKVASVCILLAVLLCSAAVADATVYAYASTCARCKSIGAKYCGYGTLRTKGV |
| | SCDGQTMIRSCADCKARFGRCVDSYITECFL |
| 1568 | AFEPHEERALQDERQTKGHRLKRQFSLNFGATHEDGYGTDVNAEALANLWK |
| | SASGNTKLEGSASYMQHFGGVGGDGKARISGNLLFSHNY |
| 1569 | NPQSCRWNMGVCIPISCPGNMRQIGTCFGPRVPCCR |
| 1570 | FLSLALAALPKFLCLVFKKC |
| 1571 | RIVDCKRSEGFCQEYCNYLETQVGYCSKKKDACC |
| 1572 | PQSCHRNKGVCVPIRCPRSMRQIGTCLGAPVKCCR |
| 1573 | KRSFTEYTQVIETVSKNKVFLEQLLLANPKLYDVMQKYNAGLLKKKRVKKLF |
| | ESIYKYYKRSYLRSTPFGLFSETSIGVFSKSSQYKLMGKTTKGIRLDTQWLIRLV |
| | HKMEVDFSKKLSFTRNNANYKFGDRVFQVYT |
| 1574 | GFGVGDSACAAHCIARRNRGGYCNAKTVCVC |
| 1575 | MSETEAEASVIGHELFHKYTGRDDMIDKPGLLKMLQDNFPNFLAACDKKGTD |
| | YLANVFEKKDKNRDKKIDFSEFLSLLGDIATDYHKQSHGAPACSEGDQ |
| 1576 | RWKFFKKIEKVGQNIRDGIIKAGPAVAVVGQAAAIS |
| 1577 | PDFKLPGMKYPIPATTPPFVPKRSRFPIYA |
| 1578 | MNFKKILFFVFACLVFTVTAAPEPRWKFFKKIEKVGQNIRDGIIKAGPAVAVV |
| | GQAAAISGK |
| 1579 | MKTFSVAVAVAVVLTFICLQESSAVSFTEVQELEEPMSNGSPVAAYEEMSEES |
| | WKMPYASRRWRCRFCCRCCPRMRGCGLCCQRR |
| 1580 | LQDAALGWGRRCPRCPPCPRCSWCPRCPTCPRCNCNPK |
| 1581 | LQDAALGWGRRCPRCPPCPRCSWCPRCPTCPGCNCNPK |
| 1582 | LQDAAVGWGRRCPQCPRCPSCPSCPRCPRCPRCKCNPK |
| 1583 | LQDAAVGWGRRCPQCPRCPSCPSCPRCPRCPRCKCNPK |
| 1584 | LQDAAVGWGRRCPQCPRCPSCPSCPRCPRCPRCKCNPK |
| 1585 | SPLSCRGNRGVCLPIRCPGRLRQIGTCFGPRVPCCR |
| 1586 | DDSIQCFQKNNTCHTNQCPYFQDEIGTCYDKRGKCCQKRLLHIRVPRKKKV |
| 1587 | CLASPSVFRRLTDPPGDARGRRRLAASLHRYLMRAVGRATPNGLWAGI |
| 1588 | KQIASKITIYQGKELQLFRKLVELKLLRQCITIPNNRGIITSIIQFLEEYEVGKEIIP |
| | LLEELHAALHSFEKSSSFERINDWNEIKRILSLLQKGDKKVGSEIIYEDVIFKDV |
| | RKDTITPKIRKSFLEGLADFILLFDVNVRVQYEIAQLFYEKYGKSTEKLSNSNLL |
| | NEVFFREIHQFYPYYQNQKYRYKEAKAKEIQQLDELRDQFLKEFESLILNVDQ |
| | SVEVIDIELLIEKYTSLIPEYIKKDSNISYTLFLQETTDENIVLNNVYDGQEKFISR |
| | FKDFFMPHYETKEYSNYIERVLNEDNCYEVDELFGFNGGIHERKSHNIVNLDV |
| | GYQRFNHKDAKQVRDFKVRYNTERKKIEFLDDNYKICNLVYKSSLVPMFLPGI |
| | LSVMLYLFQSGRLNFDITSLVKEENYVPRITFGNVVLSRKKWKVIMEDLKDIL |
| | ESKLE |
| 1589 | HPDIVDYFMKRHNWHFKFFHYEEDDKIKGAYFICNDQNIGILTRRTFPLSSDEI |
| | LIPMAPDLRCFLPDRTNRLSALHQPQIRNAIWKLTRKKQNCLVKEAFSSKFEKT |
| | RRNEYQRFLKKGGSVKSVADCSSDELTHIFIELFRSRFGNTSSCYPADNLANFF |
| | SQLHHLLFGHILYIEGIPCAFDIVLKSESQMNVYFDVSNGAIKNECRPLSPGSIL |
| | MWLN |
| 1590 | HPDVVSYFMIHHDWKFDFFHYEKDGDIKGSYFLCNGKQIGIMARRSYPLSSDE |
| | VLIPFSPHARCFFPDKTNKLSIINKQNIINATWKIARKKQNCIIKESFSPKFEKTR |
| | RNEIQRFIRNGGEIKCISQLSDKEISSSYISLFHSRFGGTLPCYEYDNLLMFISHLR |
| | ELMFGHVLFWDNKPCAIDIVLKSESSCNVYYDVPNGAVLNDENCMKLSPGSV |
| | LMWLN |
| 1591 | HPDIVDYFMKRHNWHFKFFHYKEDDKIKGAYFICNDQNIGILTRRTFPLSSDEI |
| | LIPMAPDLRCFLPDRTNRLSALHQPQIRNAIWKLTRKKQNCLVKETFSSKFEKR |
| | RRNEYQQFLKKGGSVKSVADCSSDELTHIFIELFQSRFGNTLSCYPADNLATFF |
| | SQLHHLLFGHILYIEGIPCAFDIVLKSESQMNVYFDVSNGAIKNEFRPLSPGSIL |
| | MWLN |
| 1592 | KNDAKSIIISEEDFKDVDFTNANLPHSFAIKFNVLNAETEKIQLDAIAGATANLL |
| | IGRFGHGNAAIAEIINEITEHEELQANDSILAEIVHLPESRIGNILSRPEMRNYEM |
| | AYLAKSNKENQFQIKISDLYVSVRNGNIILRSKALNKQIIP |
| 1593 | DPVTCLKSGAICHPVFCPRRYKQIGTCGLPGTKCCK |
| 1594 | IINGSDCDMHTQPWQAALLLRPNQLYCGAVLVHPQWLLTAAHCRKKVFRVR |
| | LGHYSLSPVYESGQQMFQGVKSIPHPGYSHPGHSNDLMLIKLNRRIRPTKDVR |
| | PINVSSHCPSAGTKCLVSGWGTTKSPQVHFPKVLQCLNISVLSQKRCEDAYPR |
| | QIDDTMFCAGDKAGRDSCQGDSGGPVVCNGSLQGLVSWGDYPCARPNRPGV |
| | YTNLCKFTKWIQETIQANS |
| 1595 | MNNLHRELAPISAAAWAQIEEEVARTFKRSVAGRRVVDVEEPGGVELSGVGT |
| | GHLHTIAAPRERVGAKLREVKALVEFTVPFLLRRDAIDAVERGARDADWQPA |
| | KDAAQRLAFVEDSAIFDGYPAAGIVGIREATSNRKIALPSDVGAYPGAIGDAVE |
| | ALRLAGVDGPYSVLLGADAYTALAEAREHGYPVLDHIKRIVSGEIVWAPALS |
| | GGCVLSTRGGDFALHLGEDVSIGYRSHNDEVVHLYLRETFTFLMLTSEA |
| 1596 | AIHRALISKRMEGHCEAECLTFEVKIGGCRAELAPFCCKNRKKH |
| 1597 | GLDFSQPFPSGEFAVCESCKLGRGKCRKECLENEKPDGNCRLNFLCCRQRI |
| 1598 | FIGSALKVLAGVLPSIVSWVKQ |
| 1599 | MLRVLMMSLLVVAALGHISPPRPEGCNYYCKKPEGPNKGSNYCCGPEYIPLK |
| | REEKHAGNCPPPLKECTRFPRPPQVCPHDGHCPYNQKCCFDTCLDIHTCKPAH |
| | FYIN |
| 1600 | MRVCVMVLALVVVTMARSPPFRPLSCPRPKVDIPGCVNTCQAKDKPGFFYCC |
| | DSKGLNAGTCPKVHLQPYERNVLCDRTQFNYPNHLNCKDDEDCQVFLKCCY |
| | LPDNHQLICRNSEDI |
| 1601 | MKVLAVSLAFLLIAGLISTSLAQNEEGGEKELVRVRRGGYYCPFFQDKCHRHC |
| | RSFGRKAGYCGGFLKKTCICVMK |
| 1602 | IEGRFKCRRWQWRMKKLGAPSITCVRRAF |
| 1603 | MFKCRRWQWRMKKLGAPSITCVRRAF |
| 1604 | GKIPVKAIKKAGTAIGKGLRAINIASTAHDVYSFFKPKHKKKH |
| 1605 | MKVFFLFAVLFCLVRRNSVHISHQEARGP |
| 1606 | PHQTGQLTDLRAQDTAGAEAGLQPTLQLRRLRRRDTHFPICIFCCGCCKTPKC |
| | GLCCIT |
| 1607 | MKFFALFSFFVLCVALATAGHLGRPYIGGGGGFNRGGGFHRGGGFHRGGGFH |
| | SGGGFHRGGGFHSGGSFGYRG |
| 1608 | MSTPKWNLSISRAVICVIALFASMICAAAHFVGGIHTNAGYVGWYHPDYYNH |
| | DVIGVGNYHPGYGWVAPVYATPTYIIGNTGYNCQTVQQCDSEGNCIQSQNCD |
| 1609 | SLWLLLLGLVLPSASAQALSYREAVLRAVDRINDGSSEANLYRLLELDPPPKD |
| | VEDRGARKPASFRVKETVCPRTSQQPLEQCDFKENGLV |
| 1610 | AMSLVSCSTAAPAKIPIKAIKTVGKAVGKGLRAINIASTANDVFNFLKPKKRKH |
| 1611 | AMSLVSCSTAAPAKIPIKAIKTVGKAVGKGLRAINIASTANDVFNFLKPKKRKH |
| 1612 | MEGLFNAIKDTVTAAINNDGAKLGTSIVSIVENGVGLLGKLFGF |
| 1613 | MTGLAEAIANTVQAAQQHDSVKLGTSIVDIVANGVGLLGKLFGF |
| 1614 | MLQGRQFRSCQSYLRQRGNVLEMATGNPQSQTVEECCESLKDIERKQQQCGC |
| | EAIKHAMRQMQGGQSEEVYRKARMLPRTCGLRSQQCQFNVIFV |
| 1615 | PHQTGQLTDLRAQDTAGAEAGLQPTLQLRRLRRRDTHFPICIFCCGCCKTPKC |
| | GFCCKT |
| 1616 | MNFSRALFYVFAVFLVCASVMAAPEPRWKIFKKIEKVGQNIRDGIIKAGPAVA |
| | VVGQAATIAHGK |
| 1617 | PMFKCWRWQWRWKKLGAM |
| 1618 | MKVLAVSLAFLLIAGLISTSLAENDEGGEKELVRVRRGGYYCPFRQDKCHRHC |
| | RSFGRKAGYCGGFLKKTCICV |
| 1619 | MTGLAEAIANTVQAAQQHDSVKLGTSIVDIVANGVGLLGKLFGF |
| 1620 | SKWFTPNHAACAAHCILLGNRGGHCVGTVCHCR |
| 1621 | RRWQWRGIGKFLHSAKKF |
| 1622 | MDKKAANGGKEKGPLEACWDEWSRCTGWSSAGTGVLWKSCDDQCKKLGK |
| | SGGECVLTPSTCPFTRTDKAYQCQCKK |
| 1623 | AKIPIKAIKTVGKAVGKGLRAINIASTANDVFNFLEPKKRKH |
| 1624 | MKALLILGLLLFSVAVQGKVFERCELARSLKRFGMDNFRGISLAN |
| 1625 | MKALLILGLLLFSVAVQGKVFERCELARSLKRFGMDNFRGITLAN |
| 1626 | GCVWPDGKAITTHKLQTTMQETKALIMGYFKSIATGGAMMAKPQEQLTPVIY |
| | PAV |
| 1627 | GCVWPDGKAITTHKLQTTMLETKALIMGYFKSIATGGAMMAKPQEQLTPVIY |
| | PAV |
| 1628 | GCVWPDGKAITTHKLQTTMLETKALIMGYFKSIATGGAMMATQDGAVTPVIY |
| | PAV |
| 1629 | MRLLWLLVAMVVTVLAAATPTAAWQRPLTRPRPFSRPRPYRPNYG |
| 1630 | MFTLKKSLLLLFFLGTINLSLCEEERNADEERRDDPEERAVEVEKRILPILSLIG |
| | GLLGK |
| 1631 | NWVKQAPGKGLKWMGWIRTNTGEPTYVDDFKGRFAFSLETSASTAFLQINNL |
| | KNEDTATYFCAITTATSDYYAMDYWGQGTSVTVSS |
| 1632 | MEIKYLLTVFLVLLIVSDHCQAFLFSLIPSAISGLISAFKGKRRRDLNAQIDQFK |
| | NFRKRDAELEELLSKLPIY |
| 1633 | MEIKYLLTVFLVLLIVSDHCQAFLFSLIPSAISGLISAFKGRRKRDLNGQIDHFK |
| | NFRKRDAELEELLSKLPIY |
| 1634 | DKLIGSCVWGAVNYTSDCNGECLLRGYKGGHCGSFANVNCWCET |
| 1635 | XTYNGKCYKKDNICKYKAQSGKTAICKCYVKKCPRDGAKCEFDSYKGKCYC |
| 1636 | RGGRLCYCRGWICFCVGR |

Antimicrobial peptides may be classified by their activity (i.e., the organism in which the AMP functions as a defense mechanism). For example, antiviral AMPs have activity against viruses, antifungal AMPs have activity against fungi. The following remaining AMP classes are recognized: anticancer/tumor AMPs; anti-protist AMPs; antiparasitic AMPs; insecticidal AMPs; spermicidal AMPs; anti-HIV-1 AMPs and chemotactic AMPs. For purposes of this disclosure, insecticidal AMPs will be a focus, and all other classes of AMPs will be described, generally, as non-insecticidal AMPs.

The AMPs for use within the invention include natural or synthetic, peptides, or protein analogs, peptide or protein mimetics, and chemically modified derivatives or salts of active peptides or proteins. The AMPs may be mutants that are readily obtainable by partial substitution, addition, or deletion of amino acids within a naturally occurring or native (e.g., wild-type, naturally occurring mutant, or allelic variant) peptide or protein amino acid sequence. Additionally, biologically active fragments of native peptides or proteins are included. Such mutant derivatives and fragments substantially retain the desired activity of the native peptide or proteins. In the case of peptides or proteins having carbohydrate chains, biologically active variants marked by alterations in these carbohydrate species are also included within the invention.

It is understood by one of ordinary skill in the art that the nucleotide sequence that encodes for the amino acid sequence of any of the AMPs identified herein may be deduced from the amino acid sequence. For purposes of transgenic algae, the deduced nucleotide sequence may be modified to reflect codon bias depending on the algae species used.

Any one or combination of the AMPs of the present invention may be selected or combined to yield effective agents for controlling, inhibiting, reducing and/or preventing rotifer growth within the methods and compositions of the invention.

B. Transgenic Algae

Methods for the transformation of various types of algae are known to those skilled in the art. See, for example, Radakovits et al., Eukaryotic Cell, 9, 486-501 (2010), which is incorporated herein by reference. The transformation of the chloroplast genome was the earliest method and is well documented in the literature (Kindle et al., Proc Natl Acad Sci USA, 88, p. 1721-1725 (1991)). A variety of methods have been used to transfer DNA into microalgal cells, including, but not limited to, agitation in the presence of glass beads or silicon carbide whiskers, electroporation, biolistic microparticle bombardment, and Agrobacterium tumefaciens-mediated gene transfer. A preferred method of transformation for the present invention is biolistic microparticle bombardment, carried out with a device referred to as a “gene gun.”

Different regions of the algae may be targeted for transformation in different embodiments of the invention. Target regions include the nuclear genome, the mitochondrial genome, and the chloroplast genome. The preferred target region can vary depending on the gene being expressed. For example, if an algae has been modified to express a lethal gene that is obtained from a bacterium, it may be preferable to express the lethal gene in the chloroplast or mitochondrion, as these organelles evolved from bacteria and retain many similarities. This can be achieved using a chloroplast expression vector that employs 2 intergenic regions of the chloroplast genome that flank and drive the site-specific integration of a transgene cassette (5′ untranslated region, or 5′ UTR followed by the coding sequence of the protein to be expressed which can drive the biological function desired, followed by a 3′ UTR). The 5′ UTR contains a cis acting site that allows for docking of the RNA polymerase, which drives transcription of the transgene. The 3′ UTR contains sequence that allows for the correct termination of the transcription by RNA polymerase. However, in other cases, expression can be achieved with a gene cassette that employs a eukaryotic promoter sequence upstream of the protein coding sequence and a eukaryotic termination sequence downstream of the protein coding sequence. Suitable algae promoters include, but are not limited to, an endogenous algal promoter or hybrid promoter systems that are capable of driving expression of a transcript in algae.

Genetically modified algae can be transformed to include an expression cassette. An expression cassette is made up of one or more genes and the sequences controlling their expression. The three main components of a nuclear expression cassette are a promoter sequence, an open reading frame expressing the gene, and a 3′ untranslated region, which may contain a polyadenylation signal. The cassette is part of vector DNA used for transformation. The promoter is operably linked to the gene expressed represented by the open reading frame.

The following examples are provided to illustrate certain particular features and/or embodiments. These examples should not be construed to limit the disclosure to the particular features or embodiments described.

### EXAMPLES

### Example 1

### Synthesis of Antimicrobial Peptides

This example provides a list of exemplary AMPs that were synthesized and assessed for their ability to control, inhibit, reduce and/or prevent rotifer growth.

The AMPs of this example were commercially synthesized by GENSCRIPT™. Briefly, solid phase peptide synthesis was employed using Fmoc as a protecting group. Piperidine was used to remove the Fmoc protecting group. Peptides were synthesized from C-terminal to N-terminal, and dicyclohexylcarbodiimide (DCC) was used as the activating agent. Finally, upon completion of synthesizing the individual peptides, a TFA wash was employed to remove the peptide from the column.

In general, the exemplary AMPs provided below in Table 2 vary in length from 13 to 56 amino acids (i.e., “Total # A.A.” column), and originate from a diverse set of organisms including arthropods (e.g., insects), amphibians, fish and mammals (“Origin” column). Further, the column identified as “Activity” in Table 2 provides the known organism(s) for which the activity of the AMP is harmful to (i.e., control, inhibit, reduce and/or prevent growth). The “G+” indicates that the AMP has activity against Gram-positive bacteria, and the “G−” indicates that the AMP has activity against Gram-negative bacteria. As the “Activity” column indicates, as single AMP may have broad activity spectrum against multiple organisms.

TABLE 2

| | | | Total | |
|---|---|---|---|---|
| Peptide Name | Amino Acid Sequence | Origin | #A.A. | Activity |
| Ponericin G1 | GWKDWAKKAGGWLKKKGPGMA | Pachycondyla | 30 | G+; G−; Fungi; |
| | KAALKAAMQ (SEQ ID NO: 232) | goeldii (Ant) | | Insects |
| Ponericin G3 | GWKDWLNKGKEWLKKKGPGIMK | Pachycondyla | 30 | G+; G−; Fungi; |
| | AALKAATQ (SEQ ID NO: 234) | goeldii (Ant) | | Insects |
| Ponericin G4 | DFKDWMKTAGEWLKKKGPGILK | Pachycondyla | 29 | G+; G−; Fungi; |
| | AAMAAAT (SEQ ID NO: 235) | goeldii (Ant) | | Insects |
| Ponericin G6 | GLVDVLGKVGGLIKKLLP (SEQ ID | Pachycondyla | 18 | G+; G−; |
| | NO: 1637) | goeldii (Ant) | | Insects |
| Ponericin L2 | LLKELWTKIKGAGKAVLGKIKGLL | Pachycondyla | 24 | G+; G−; Virus; |
| | (SEQ ID NO: 240) | goeldii (Ant) | | Fungi; Insects, |
| | | | | HIV |
| Ponericin W1 | WLGSALKIGAKLLPSVVGLFKKK | Pachycondyla | 25 | G+; G−; Fungi; |
| | KQ (SEQ ID NO: 241) | goeldii (Ant) | | Insects, |
| | | | | Mammalian |
| | | | | cells |
| Ponericin W3 | GIWGTLAKIGIKAVPRVISMLKKK | Pachycondyla | 26 | G+; G−; Fungi; |
| | KQ (SEQ ID NO: 243) | goeldii (Ant) | | Insects, |
| | | | | Mammalian |
| | | | | cells |
| Ponericin W4 | GIWGTALKWGVKLLPKLVGMAQ | Pachycondyla | 26 | G+; G−; Fungi; |
| | TKKQ (SEQ ID NO: 244) | goeldii (Ant) | | Insects, |
| | | | | Mammalian |
| | | | | cells |
| Ponericin W5 | FWGALIKGAAKLIPSVVGLFKKKQ | Pachycondyla | 24 | G+; G−; Fungi; |
| | (SEQ ID NO: 245) | goeldii (Ant) | | Insects,; |
| | | | | Mammalian |
| | | | | cells |
| Ponericin W6 | FIGTALGIASAIPAIVKLFK (SEQ ID | Pachycondyla | 20 | G+; Insects, |
| | NO: 246) | goeldii (Ant) | | Mammalian |
| | | | | cells |
| Im-1 | FSFKRLKGFAKKLWNSKLARKIRT | Scorpion | 56 | G+; G−; |
| | KGLKYVKNFAKDMLSEGEEAPPA | venom | | Insects |
| | AEPPVEAPQ (SEQ ID NO: 1638) | | | |
| Cupiennin 1D | GFGSLFKFLAKKVAKTVAKQAAK | Cupiennius | 35 | G+; G−; |
| | QGAKYVANKHME (SEQ ID NO: | salei (Spider) | | Insects |
| | 1639) | | | |
| Lycotoxin I | IWLTALKFLGKHAAKHLAKQQLS | Wolf spider | 25 | G+; G−; Fungi; |
| | KL (SEQ ID NO: 1640) | | | Insects |
| Melittin | GIGAVLKVLTTGLPALISWIKRKR | Honeybee | 26 | G+; G−; Virus; |
| | QQ | venom | | Fungi; |
| | (SEQ ID NO: 1641) | | | Parasites |
| Piscidin 1 | FFHHIFRGIVHVGKTIHRLVTG | Striped Bass | 22 | G+; G−; Virus; |
| | (SEQ ID NO: 802) | | | Fungi |
| Piscidin 2 | FFHHIFRGIVHVGKTIHKLVTG | Striped Bass | 22 | Virus; Fungi; |
| | (SEQ ID NO: 1642) | | | Parasites |
| Piscidin 3 | FIHHIFRGIVHAGRSIGRFLTG (SEQ | Striped Bass | 22 | G+; G−; Virus; |
| | ID NO:803) | | | Fungi; |
| W16-CA(1-8)-MA(1-12) | KWKLFKKIGIGKFLHWAKKF (SEQ | Hybrid AMP | 20 | Virus |
| Hybrid CecropinA(1-8)- | ID NO: 1643) | | | |
| Magainin2(1-12) | | | | |
| Temporin A | FLPLIGRVLSGIL (SEQ ID NO: 32) | European | 13 | G+; Virus |
| | | common frog | | |
| Temporin-F | FLPLIGKVLSGIL (SEQ ID NO: 36) | European | 13 | G+; G- |
| | | common frog | | |
| Temporin-G | FFPVIGRILNGIL (SEQ ID NO: | European | 13 | G+; G- |
| | 1644) | common frog | | |
| Temporin-L | FVQWFSKFLGRIL (SEQ ID NO: | European | 13 | G+; G−; Fungi |
| | 248) | common frog | | |
| MsrA3 | MASRHMFLPLIGRVLSGIL (SEQ ID | Hybrid AMP | 19 | G−; Fungi |
| | NO: 1645) | | | |
| Cecropin A | KWKLFKKIEKVGQNIRDGIIKAGP | Hybrid AMP | 37 | G+; G−; Virus; |
| | AVAVVGQATQIAK (SEQ ID NO: | | | Parasites |
| | 62) | | | |
| Cecropin B | KWKVFKKIEKMGRNIRNGIVKAG | Giant Silk | 35 | G+; G−; Virus |
| | PAIAVLGEAKAL (SEQ ID NO: 64) | moth | | |
| Magainin 2 | GIGKFLHSAKKFGKAFVGEIMNS | African | 23 | G+; G−; Virus; |
| | (SEQ ID NO: 122) | clawed frog | | Fungi; |
| | | | | Parasites |
| Tachyplesin I | KWCFRVCYRGICYRRCR (SEQ ID | Asian | 17 | G+; G−; Virus |
| | NO: 144) | horseshoe | | |
| | | crab | | |
| Lactoferricin B | FKCRRWQWRMKKLGAPSITCVRR | Cattle | 25 | G+; G−; Virus; |
| | AF | | | Fungi; |
| | (SEQ ID NO: 1646) | | | |
| Dermaseptin-S1 | ALWKTMLKKLGTMALHAGKAAL | Leaf frog | 34 | G+; G−; Virus; |
| | GAAADTISQGTQ (SEQ ID NO: | | | Fungi; |
| | 1647) | | | Parasites |

### Example 2

### Minimal Inhibitory Concentration (MIC) of Antimicrobial Peptides on Algae

This example provides the minimal inhibitory concentration (MIC) of antimicrobial peptides (AMPs) for algae. The significance of determining the MIC of AMPs for algae relates to the need of having a biocontrol agent (i.e., AMP) for rotifers that does not cause harm to algae. Therefore, the tolerance of algae to the AMPs listed in Table 2 of Example 1 was measured.

Briefly, the algae viability assay used herein measured the “health” of the algae cultures by looking at the color of the algae. A change in color from green algae to brown algae indicates that the algae are negatively impacted and likely no longer viable. A visual assay was used to determine the MIC for the individual AMPs on the algae. In each case, a light microscope with 20× magnification was used to observe algae color.

The effect of insecticidal and non-insecticidal AMPs on three different algae species was measured. The three algae species were Auxenochlorella protothecoides, Chlorella sorokiniana and Chlamydomonas reinhardtii.

Algae cultures were initiated in 96-well plates at an OD 750 of approximately 0.1. Individual algae cultures were incubated with a select AMP at concentrations of 7.8 μg/mL, 15.6 μg/mL, 31.2 μg/mL, 62.5 μg/mL, 0.125 mg/mL, 0.25 mg/mL, 0.5 mg/mL and 1 mg/mL to determine the MIC for individual AMPs against the three different algae species for 5-6 days at room temperature on a continuous lit shaker. The antibiotics hygromycin and paromycin served as positive controls for inhibiting and/or reducing the growth rate of algae. Algae cultured in water or media served as a negative control (i.e., no effect on growth). The algae cultures were monitored by preparing microscopy slides with a small sample taken from the individual wells. The algae slides were then visualized under a 20× magnification microscope for algae viability as measured by algae color.

A summary of the MIC, provided in molar concentration, for each insecticidal and non-insecticidal AMP incubated with the three different algae species is provided below in Table 3 (insecticidal AMPs) and Table 4 (non-insecticidal AMPs). The “ND” indicates that the AMP killed all the algae.

TABLE 3

| | Minimal Inhibitory Concentration (MIC) of | | | | | |
|---|---|---|---|---|---|---|
| AMP | Insecticidal AMPs for Three Different Algae Species | | | | | |
| (SEQ ID | Chlorella | | Chlorella | | Chlamydomonas | |
| NO: #) | protothecoides | | sorokiana | | reinhardtii | |
| Cupiennin 1D | 16.5 | μM | 65.9 | μM | 32.9 | μM |
| (1639) | | | | | | |
| Im-1 | 9.9 | μM | 19.7 | μM | 9.9 | μM |
| (1638) | | | | | | |
| Lycotoxin-1 | 44 | μM | 88 | μM | 22 | μM |
| (1640) | | | | | | |
| Ponericin G1 | 78 | μM | 155.8 | μM | 19.5 | μM |
| (232) | | | | | | |
| Ponericin G3 | 37 | μM | 37 | μM | 9.2 | μM |
| (234) | | | | | | |
| Ponericin G4 | 158 | μM | 79 | μM | 19.8 | μM |
| (235) | | | | | | |
| Ponericin G6 | 274.9 | μM | 274.9 | μM | 17.2 | μM |
| (1637) | | | | | | |
| Ponericin L2 | 48.5 | μM | 97 | μM | 12.1 | μM |
| (240) | | | | | | |
| Ponericin W1 | 23.1 | μM | 46.1 | μM | 11.5 | μM |
| (241) | | | | | | |
| Ponericin W3 | 21.8 | μM | 87.3 | μM | 5.5 | μM |
| (243) | | | | | | |
| Ponericin W4 | 43.8 | μM | 87.6 | μM | 11 | μM |
| (244) | | | | | | |
| Ponericin W5 | 12 | μM | 24 | μM | 12 | μM |
| (245) | | | | | | |

| | | | | | |
|---|---|---|---|---|---|
| Ponericin W6 | No Affect | 492.5 | μM | 61.6 | μM |
| (246) | | | | | |

The data in Table 3 indicates that the insecticidal AMPs (13 AMPs) had an MIC for the three algae species in range of about 5.5 μM to about 493 μM. A higher concentration (or MIC) indicates that the algae species is more tolerant of the AMP.

TABLE 4

| | Minimal Inhibitory Concentration (MIC) of Non- | | | | | |
|---|---|---|---|---|---|---|
| AMP | Insecticidal AMPs for Three Different Algae Species | | | | | |
| (SEQ ID | Chlorella | | Chlorella | | Chlamydomonas | |
| NO: #) | protothecoides | | sorokiana | | reinhardtii | |
| Melittin | 11 | μM | 11 | μM | ND (kills) | |
| (1641) | | | | | | |
| Piscidin 1 | 12.2 | μM | 24.3 | μM | 12.2 | μM |
| (802) | | | | | | |
| Piscidin 2 | 24.6 | μM | 24.6 | μM | 12.3 | μM |
| (1642) | | | | | | |
| Piscidin 3 | 200.7 | μM | 100.3 | μM | 50.2 | μM |
| (803) | | | | | | |
| W16-CA(1- | ND (kills) | | 25 | μM | 12.5 | μM |
| 8)-MA(1- | | | | | | |
| 12) (1643) | | | | | | |
| Temporin A | 715.4 | μM | 715.4 | μM | 89.4 | μM |
| (32) | | | | | | |
| Temporin F | 365 | μM | 730.7 | μM | 91.3 | μM |
| (36) | | | | | | |
| Temporin G | 171.4 | μM | 342.8 | μM | 85.7 | μM |
| (1644) | | | | | | |
| Temporin L | 76.2 | μM | 38.1 | μM | 19 | μM |
| (248) | | | | | | |
| MsrA3 | 59.2 | μM | NT | | 29.6 | μM |
| (1645) | | | | | | |
| Cecropin A | 124.9 | μM | 124.9 | μM | 15.6 | μM |
| (62) | | | | | | |
| Cecropin B | 65.2 | μM | 130.4 | μM | 16.3 | μM |
| (64) | | | | | | |
| Magainin 2 | 101.3 | μM | 50.7 | μM | 6.3 | μM |
| (122) | | | | | | |

| | | | | | |
|---|---|---|---|---|---|
| Tachyplesin | 6.9 | μM | ND (kills) | 13.8 | μM |
| I (144) | | | | | |

| | | | | |
|---|---|---|---|---|
| Lactoferricin | ND (kills) | ND (kills) | ~10 | μM |
| B (1646) | | | | |

| | | | | | |
|---|---|---|---|---|---|
| Dermaseptin- | 18.1 | μM | 36.9 | μM | ND (kills) |
| S1 (1647) | | | | | |

The data in Table 4 indicates that the insecticidal AMPs (16 AMPs) had an MIC for the three algae species in range of about 6 μM to about 731 μM. A higher concentration (or MIC) indicates that the algae species is more tolerant of the AMP.

### Example 3

### Effect of Antimicrobial Peptides (AMPs) on Rotifer Motility

This example demonstrates the effect of antimicrobial peptides (AMPs) on rotifer motility and viability.

Briefly, the rotifer motility assay used herein in the presence of a biocontrol agent (e.g., AMP) may be used as a measure of relative rotifer viability and competency. Rotifer diet, of which algae is considered to be an important food source, is one of the key environmental factors that impact the growth and multiplication of rotifers. In effect, the inability of a rotifer to be mobile (i.e., inability to swim toward a food source and/or to have mobile cilia that help trap food) prevents the rotifer from ingesting sufficient nutrients to further grow and reproduce. Thus, any approach that reduces and/or inhibits rotifer motility has a significant impact on an individual rotifer and therefore rotifer populations. With respect to algae cultures, reducing and/or inhibiting rotifer motility prevents and/or reduces any negative impact rotifers have on algae cultures (e.g., open pond systems for algae biomass and biofuel production). In other words, reducing and/or inhibiting rotifer motility reduces and/or prevents rotifers (e.g., infestations) from ingesting and consequently damaging algae cultures use in biofuel production. In general, antimicrobial peptides (AMPs) were shown to have a negative impact on rotifer motility and viability, and therefore a negative impact on limiting rotifers proliferation and population growth.

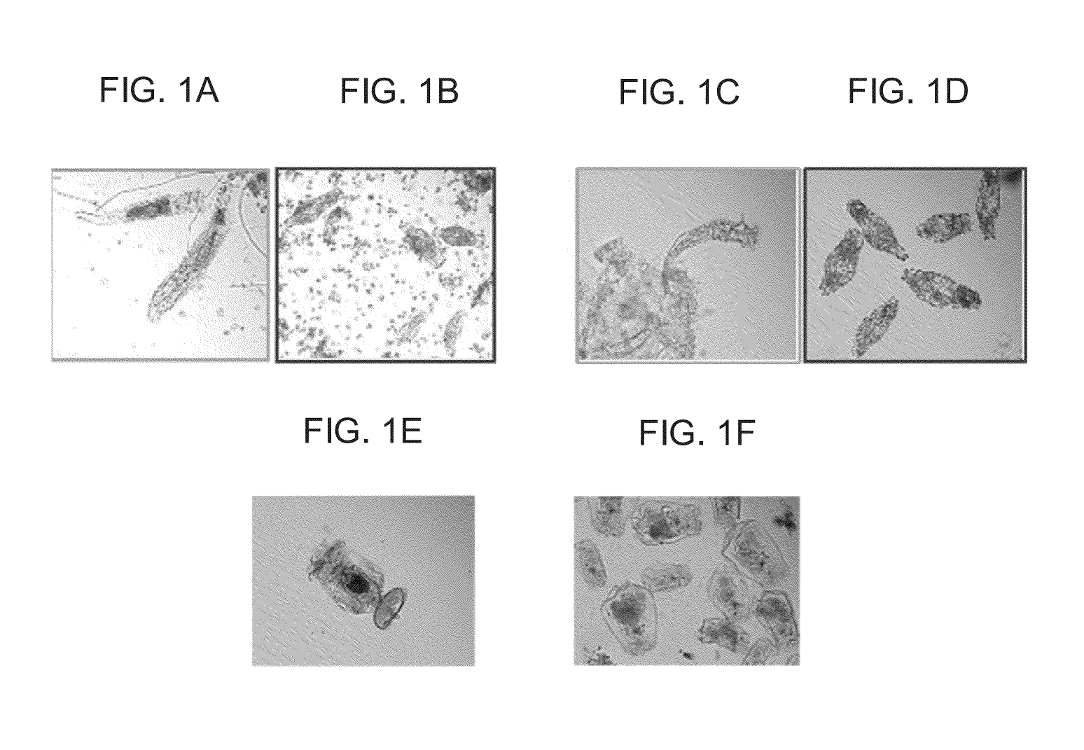

The effect of the insecticidal and non-insecticidal AMPs of Table 2 (Example 1) on three different rotifer species was measured. The three rotifer species were Adineta vaga and Philodina acuticornis (class Bdelloid rotifers), and Brachionus (Monogononta class). A visual motility assay was used to determine the impact of the individual AMPs on rotifer viability. In each case, a light microscope with 20× magnification was used to observe rotifer motility (activity). FIG. 1 shows a side-by-side comparison of AMP treated and AMP untreated Adineta vaga, Philodina acuticornis and Brachionus rotifers. FIGS. 1A, 1C and 1E show a 20× magnification of Adineta vaga, Philodina acuticornis and Brachionus (untreated), respectively. FIGS. 1B, 1D and 1F show a 20× magnification of Adineta vaga, Philodina acuticornis and Brachionus (AMP treated), respectively. The rotifers in FIGS. 1B, 1D and 1F had limited to no mobility, the morphology of the rotifers treated with AMPs compared to the untreated rotifers (FIGS. 1A, 1C and 1E) indicates that the rotifers are unhealthy and/or dead.

Rotifer cultures were initiated in 12-well or 24-well plates at a density of approximately 100-200 rotifers/mL. The 12-well plates contained a volume of 1 mL per well, and the 24-well plates contained a volume of about 0.25 mL to about 0.35 mL per well. Individual rotifer cultures (individual wells) were incubated with a select AMP at a concentration of 0.5 mg/mL (or a range of about 78 μM to about 365 μM) for 18, 21 and 24 hours at room temperature. The rotifer cultures were monitored by preparing microscopy slides with a small sample taken from the individual wells. The slides were then visualized under a 20× magnification microscope for rotifer motility. The range of visual motility was assessed as follows: a non-motile rotifer (no movement observed) was scored as “+++” (high negative impact of AMP on rotifer motility); a rotifer with limited motility (compared to rotifers not treated with an AMP) was scored as “++” (medium negative impact of AMP on rotifer motility); a rotifer with motility slightly below that of a non-treated AMP rotifer was scored as “+” (low negative impact of AMP on rotifer motility); and a rotifer having motility comparable to a rotifer not treated with an AMP was scored as “no kill” (“NK”) (no negative impact of AMP on rotifer motility). The scoring system was based on observing a subset of the rotifer population from each well. The impact on the subset of rotifers observed served as a representative of the impact on the entire rotifer population for that particular AMP treatment.

A summary of the motility assay (or “Kill Assay”) for each insecticidal and non-insecticidal AMP incubated with the three different rotifer species for the 24 hour time point is provided below in Table 5 (insecticidal AMPs) and Table 6 (non-insecticidal AMPs). The 18 and 21 hour time points gave similar results to the 24 hour time point.

TABLE 5

| | | | “Kill” Efficiency of Insecticidal AMPs | | |
|---|---|---|---|---|---|
| AMP | Molar | | for Three Different Rotifer Species | | |
| (SEQ ID | Concentration | | (24 hr time point) | | |
| NO: #) | at 0.5 mg/mL | | Philodina | Adineta vaga | Brachionus |
| Cupiennin 1D | 131.7 | μM | +++ | +++ | +++/++ |
| (1639) | | | | | |
| Im-1 | 78.8 | μM | +++ | +++ | +++ |
| (1638) | | | | | |
| Lycotoxin-1 | 175.8 | μM | +++ | +++ | +++ |
| (1640) | | | | | |
| Ponericin G1 | 155.75 | μM | +++ | +++ | +++ |
| (232) | | | | | |
| Ponericin G3 | 147.8 | μM | +++ | +++ | +++ |
| (234) | | | | | |
| Ponericin G4 | 158 | μM | +++/++ | +++/++ | +++/++ |
| (235) | | | | | |
| Ponericin G6 | 274.85 | μM | +++/++ | +++/++ | +++ |
| (1637) | | | | | |
| Ponericin L2 | 193.95 | μM | +++ | +++ | +++/++ |
| (240) | | | | | |
| Ponericin W1 | 184.5 | μM | +++ | +++ | +++ |
| (241) | | | | | |
| Ponericin W3 | 174.55 | μM | +++ | +++ | +++ |
| (243) | | | | | |
| Ponericin W4 | 175.3 | μM | +++ | +++ | +++ |
| (244) | | | | | |
| Ponericin W5 | 192.15 | μM | +++ | +++ | +++ |
| (245) | | | | | |
| Ponericin W6 | 246.25 | μM | ++ | ++ | +++ |
| (246) | | | | | |

The data in Table 5 indicates that the insecticidal AMPs (13 AMPs) had a medium (“++”) to high (“+++”) negative impact on the motility, and therefore viability, of all three rotifer species. Twelve of the 13 AMPs had a high negative impact on all three rotifer species.

TABLE 6

| | | | “Kill” Efficiency of Non-Insecticidal | | |
|---|---|---|---|---|---|
| AMP | Molar | | AMPs at 0.5 mg/mL for Three Different | | |
| (SEQ ID | Concentration | | Rotifer Species (24 hr time point) | | |
| NO: #) | at 0.5 mg/mL | | Philodina | Adineta vaga | Brachionus |
| Melittin | 175.6 | μM | +++ | +++ | +++/++ |
| (1641) | | | | | |
| Piscidin 1 | 194.4 | μM | +++ | +++ | +++ |
| (802) | | | | | |
| Piscidin 2 | 196.5 | μM | +++ | +++ | +++ |
| (1642) | | | | | |
| Piscidin 3 | 200.65 | μM | +++ | +++ | +++ |
| (803) | | | | | |
| W16-CA(1- | 199.7 | μM | +++ | +++ | + |
| 8)-MA(1- | | | | | |
| 12) (1643) | | | | | |
| Temporin A | 357.72 | μM | NK | + | ++ |
| (32) | | | | | |
| Temporin F | 365 | μM | NK | NK | +/++ |
| (36) | | | | | |
| Temporin G | 342.75 | μM | NK | NK | + |
| (1644) | | | | | |
| Temporin L | 304.7 | μM | +++ | +++ | +++ |
| (248) | | | | | |
| MsrA3 | 236.8 | μM | +++ | +++ | + |
| (1645) | | | | | |
| Cecropin A | 124.85 | μM | ++ | +++ | ++/+++ |
| (62) | | | | | |
| Cecropin B | 130.35 | μM | +++/++ | +++ | ++/+++ |
| (64) | | | | | |
| Magainin 2 | 202.7 | μM | +++ | +++ | + |
| (122) | | | | | |
| Tachyplesin | 220.4 | μM | +++ | +++/++ | NK |
| I (144) | | | | | |
| Lactoferricin | 160 | μM | +++ | +++ | +++ |
| B (1646) | | | | | |
| Dermaseptin- | 144.7 | μM | +++ | +++ | +++ |
| S1 (1647) | | | | | |

The data in Table 6 indicates that the non-insecticidal AMPs (16 AMPs) had greater range of impact on the motility, and therefore viability, of the three rotifer species when compared to the insecticidal AMPs of Table 5. The impact of the non-insecticidal AMPs on rotifers ranged from “no kill” (“NK”), or no negative impact on motility (viability), to high (“+++”) negative impact on motility (viability) for all three rotifer species. In the cases where a single rotifer species was not impacted negatively by the presence of an AMP, one or more of the other rotifer species were negatively impacted (see for example Temporin-F in Table 6). Thirteen of the 16 AMPs had at least a high negative impact (“+++”) on motility (viability) in at least one rotifer species.

In summary, these data indicate that the introduction of an AMP (insecticidal or non-insecticidal) has a negative impact on the motility, and therefore viability, of one or more rotifer species. Moreover, in comparing the AMP concentrations of Tables 3 and 4 (algae viability/tolerance of the AMP) with the AMP concentrations of Tables 5 and 6 (rotifer motility), there are overlapping concentrations of AMP indicating where the AMP has a negative impact on the motility, and therefore viability of a rotifer, yet algae are tolerant to the AMP, and remain viable. By way of example, the AMPs Ponericin W6, Temporin A and Temporin F, are highly tolerated by algae, but have a high negative impact on rotifer motility, and therefore viability.

These data indicate that AMPs may be useful in removing and/or preventing rotifer infestations in algae cultivations by reducing and/or inhibiting rotifer motility, and therefore controlling, inhibiting, reducing and/or preventing rotifer growth.

### Example 4

### Expression Vector for Transgenic Algae Expressing an AMP

This example provides an exemplary expression vector that can be used to engineer transgenic algae to express an antimicrobial peptide (AMP).

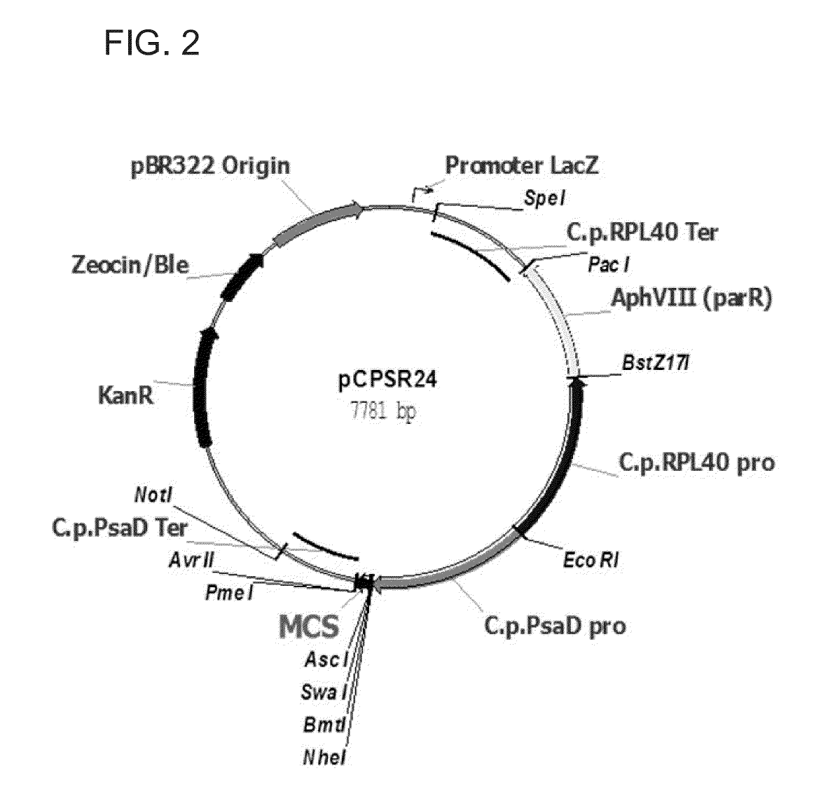

An exemplary expression vector (pCPSR24) is shown in FIG. 2. Each antimicrobial peptide encoding sequence is codon-optimized for the algae species in which the expression vector is introduced. Further, an additional start codon (ATG encoding the amino acid methionine) is introduced into the AMP nucleotide sequence. The AMP nucleotide sequence is cloned into the vector multiple cloning site (MCS) via the NheI and AvrII restriction enzyme sites. The AMP nucleotide sequence is operably linked to a promoter (e.g., LacZ), which will drive the expression of the AMP in the algae.

The following nucleotide sequences encoding an AMP are cloned into the pCPSR24 vector via the NheI and AvrII restrictions sites:

M-Ponericin G4 (codon optimized for C. proto-
thecoides)
(SEQ ID NO: 1648)
GCTAGCATGGACTTCAAGGACTGGATGAAGACCGCCGGCGAGTGGCTGAA
GAAGAAGGGCCCCGGCATCCTGAAGGCCGCCATGGCCGCCGCCACCTGAC
CTAGG
M-Ponericin W3 (codon optimized for C. proto-
thecoides)
(SEQ ID NO: 1649)
GCTAGCATGGGCATCTGGGGCACCCTGGCCAAGATCGGCATCAAGGCCGT
GCCCCGCGTGATCAGCATGCTGAAGAAGAAGAAGCAGTGACCTAGG
M-Ponericin W6 (codon optimized for C. proto-
thecoides)
(SEQ ID NO: 1650)
GCTAGCATGTTCATCGGCACCGCCCTGGGCATCGCCAGCGCCATCCCCGC
CATCGTGAAGCTGTTCAAGTGACCTAGG
M-Ponericin G6 (codon optimized for C. proto-
thecoides)
(SEQ ID NO: 1651)
GCTAGCATGGGCCTGGTGGACGTGCTGGGCAAGGTGGGCGGCCTGATCAA
GAAGCTGCTGCCCTGACCTAGG

The expression vector is transformed into the algae, which then express the AMP. The algae expressing the AMP have a defense to rotifers, whereby the AMP inhibits, reduces and/or prevents rotifer growth, thus preventing rotifer infestation from damaging the algae.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A method for inhibiting the growth or reducing the growth rate of one or more rotifers, comprising contacting the one or more rotifers with an isolated antimicrobial peptide (AMP), wherein the growth or growth rate of the one or more rotifers is inhibited by the AMP compared to the growth of the one or more rotifers absent the AMP.

2. The method of claim 1, wherein the AMP is from about 5 to about 200 amino acids in length.

3. The method of claim 1, wherein the AMP is an insecticidal AMP.

4. The method of claim 1, wherein the AMP is a non-insecticidal AMP.

5. The method of claim 1, wherein the concentration of the AMP is about 0.5 μM to about 500 μM.

6. The method of claim 1, wherein the concentration of the AMP is about 75 μM to about 370 μM.

7. The method of claim 1, wherein the AMP comprises the amino acid sequence of any one of SEQ ID NOs: 1-1647.

8. The method of claim 1, wherein the AMP comprises the amino acid sequence of any one of SEQ ID NOs: 32, 36, 62, 64, 122, 232, 235, 246, 803 and 1637.

9. A method for inhibiting or preventing a rotifer infestation of an algae culture, comprising contacting an algae culture with an isolated antimicrobial peptide (AMP), wherein the concentration of the AMP in the algae culture is sufficient to inhibit the growth of and/or reduce the rate of growth of a rotifer in the algae culture.

10. The method of claim 9, wherein the AMP does not substantially inhibit the growth of the algae.

11. The method of claim 9, wherein the AMP is from about 5 to about 200 amino acids in length.

12. The method of claim 9, wherein the AMP is an insecticidal AMP.

13. The method of claim 9, wherein the AMP is a non-insecticidal AMP.

14. The method of claim 9, wherein the concentration of the AMP in the algae culture is about 0.5 μM to about 500 μM.

15. The method of claim 9, wherein the concentration of the AMP in the algae culture is about 75 μM to about 370 μM.

16. The method of claim 9, wherein the AMP comprises the amino acid sequence of any one of SEQ ID NOs: 1-1647.

17. The method of claim 9, wherein the AMP comprises the amino acid sequence of any one of SEQ ID NOs: 32, 36, 62, 64, 122, 232, 235, 246, 803 and 1637.

18. A transgenic algae comprising an expression vector, wherein the expression vector comprises a heterologous promoter operatively linked to a nucleotide sequence encoding an antimicrobial peptide (AMP).

19. The transgenic algae of claim 18, wherein the nucleotide sequence encoding the AMP is codon-optimized for expression in algae.

20. The transgenic algae of claim 18, wherein the AMP does not substantially inhibit the growth of the algae.

21. The transgenic algae of claim 18, wherein the AMP is from about 5 to about 200 amino acids in length.

22. The transgenic algae of claim 18, wherein the AMP is an insecticidal AMP.

23. The transgenic algae of claim 18, wherein the AMP is a non-insecticidal AMP.

24. The transgenic algae of claim 18, wherein the AMP comprises the amino acid sequence of any one of SEQ ID NOs: 1-1647.

25. The transgenic algae of claim 18, wherein the AMP comprises the amino acid sequence of any one of SEQ ID NOs: 32, 36, 62, 64, 122, 144, 232, 234, 235, 240, 241, 243-246, 248, 802, 803 and 1638-1647.

26. The transgenic algae of claim 18, wherein the AMP comprises the amino acid sequence of any one of SEQ ID NOs: 32, 36, 62, 64, 122, 232, 235, 246, 803 and 1637.

27. The transgenic algae of claim 19, wherein the nucleotide sequence encoding the AMP comprises any one of SEQ ID NOs: 1648-1651.

28. An expression vector comprising a promoter operatively linked to a nucleotide sequence encoding an antimicrobial peptide (AMP), wherein the nucleotide sequence is codon-optimized for expression in algae.

29. The expression vector of claim 28, wherein the nucleotide sequence encoding the AMP comprises any one of SEQ ID NOs: 1648-1651.
